(19) United States
(12) Patent Application Publication
(10) Pub. No.: US 2026/0099080 A1
(43) Pub. Date: Apr. 9, 2026

(54) LENS DRIVING DEVICE, CAMERA DEVICE, AND OPTICAL DEVICE

(71) Applicant: LG INNOTEK CO., LTD., Seoul (KR)

(72) Inventors: Tae Hoon KWON, Seoul (KR); Yun Ho NOH, Seoul (KR); Byung Wook SON, Seoul (KR)

(21) Appl. No.: 19/111,860

(22) PCT Filed: Jul. 3, 2023
(86) PCT No.: PCT/KR2023/009334

§ 371 Date: Mar. 14, 2025

(30) Foreign Application Priority Data
Sep. 15, 2022 (KR) 10-2022-0116712
Sep. 27, 2022 (KR) 10-2022-0122771

(51) Int. Cl. G03B 5/00; G03B 13/36; H04N 23/54; H04N 23/55; H04N 23/63

(52) U.S. Cl. CPC G03B 5/00; G03B 13/36; H04N 23/54; H04N 23/55; H04N 23/63; G03B 2205/0069

(57) ABSTRACT

A first embodiment of the present invention relates to a lens driving device comprising: a base; a housing being disposed on the base; a bobbin being disposed inside the housing; a first ball being disposed between the side surface of the housing and the base; a second ball being disposed between the upper side of the bobbin and the housing; a first elastic member being coupled to a portion of the upper side of the bobbin; a second elastic member being coupled to the lower side of the housing; and a wire connecting the first elastic member and the second elastic member.

### TECHNICAL FIELD

The present embodiment relates to a lens driving device, a camera device, and an optical apparatus.

### BACKGROUND ART

A camera device is a device that photographs a picture or video of a subject and is installed in an optical apparatus such as a smartphone, a drone, a vehicle, and the like.

An auto focus function that automatically adjusts a focus according to a distance to a subject is applied to the camera device. In addition, hand shake correction function is applied to prevent a phenomenon in which focus is shaking due to a user's hand shake.

The auto focus function and hand shake correction function may be performed through electromagnetic interaction between a magnet and a coil.

However, in a conventional lens driving device, when disposing a magnet and a coil for performing an auto focus function, a magnet that does not require electrical connection is disposed in a moving part and a coil is disposed in a fixed part. In this case, there is a problem in that current consumption for performing the auto focus function increases because a magnet having a larger weight than a coil is disposed in the moving part.

In particular, in recent years, the lens diameter has increased according to the high-pixel image sensors, and accordingly, the weight of the lens is also increased, thereby increasing problems.

In addition, in the conventional lens driving device, the height of the camera device in an optical axis direction increases as a guide structure for OIS-x-axis driving and a guide structure for OIS-y-axis driving are disposed as separate layers.

Meanwhile, the auto focus function is performed as a lens moves in an optical axis direction against the image sensor, and the movement of the lens in the optical axis direction may be guided by a ball. At this time, an attractive force between the magnet and the yoke may be used to hold the ball between the fixed part and the moving part.

However, in this case, there is a problem in that a centering force exists in the optical axis direction.

Furthermore, there may be a possibility for the moving part to be tilted by the contact point of the ball.

(Patent Literature) KR 10-2015-0118005 A

### DETAILED DESCRIPTION OF THE INVENTION

### Technical Subject

A first embodiment of the present invention is intended to provide a lens driving device in which current consumption for performing an autofocus function is reduced by disposing a coil that is lighter than a magnet in a moving part.

In addition, it is intended to provide a lens driving device having a minimized height in an optical axis direction by integrally forming a guide structure for OIS-x-axis driving and a guide structure for OIS-y-axis driving.

A second embodiment of the present invention is intended to provide a lens driving device that pressurizes the ball through an elastic member

In addition, a second embodiment of the present invention is intended to provide a lens driving device that pressurizes the ball through an elastic member so that there is no centering force being generated in an optical axis direction when the ball is pressurized through the yoke and the magnet.

In addition, a second embodiment of the present invention is intended to provide a lens driving device in which rotation and tilt of a moving part are prevented by disposing a ball guide structure in diagonally.

### Technical Solution

A lens driving device according to a first embodiment of the present invention may comprise” a base; a housing being disposed on the base; a bobbin being disposed inside the housing; a first ball being disposed between the side surface of the housing and the base; a second ball being disposed between the housing and an upper side of the bobbin; a first elastic member being coupled to a portion of the upper side of the bobbin; a second elastic member being coupled to a lower side of the housing; and a wire connecting the first elastic member and the second elastic member.

The base may comprise a first guide for guiding the first ball to move.

The side surface of the housing may comprise a second guide for guiding the first ball to move.

The first guide and the second guide may comprise grooves.

The housing may comprise a first housing comprising an upper plate having a metal member and a second housing being disposed on the first housing and having a protrusion guiding the second ball.

A lens driving device according to a first embodiment of the present invention comprises: a fixed part; a first moving part being disposed inside the fixed part; a second moving part being disposed inside the first moving part; a first driving part for moving the first moving part in an optical axis direction; and a second driving part for moving the second moving part in a direction perpendicular to the optical axis direction, wherein the first driving part comprises a first driving unit being disposed in the first moving part and a second driving unit being disposed in the fixed part, and wherein the second driving part may comprise a third driving unit being disposed in the second moving part and a fourth driving unit being disposed in the first moving part.

The fourth driving unit may comprise a coil.

The coil may move together with the first moving part.

The first driving unit may comprise a first magnet, and the second driving unit may comprise a first coil.

The second driving part may comprise a fifth driving unit being disposed in the second moving part and spaced apart from the third driving unit, and a sixth driving unit being disposed in the first moving part and spaced apart from the fourth driving unit.

When viewed from above, the first driving unit, the second driving unit, the fifth driving unit, and the sixth driving unit may be overlapped with one another in one direction.

The third driving unit and the fourth driving unit move the second moving part in a first direction perpendicular to the optical axis direction, and the fifth driving unit and the sixth driving unit may move the second moving part in a second direction perpendicular to the optical axis direction and the first direction.

It comprises: a first substrate being disposed in the fixed part; and a second substrate being disposed in the first moving part, wherein the coil is disposed in the second substrate, and wherein the first substrate may comprise an outer side portion being disposed in the fixed part and a connecting portion being extended from the outer side portion and coupled to the second substrate.

A lens driving device according to a first embodiment of the present invention may comprise: a fixed part; a first moving part being disposed inside the fixed part; a second moving part being disposed inside the first moving part; a first support member being disposed between the fixed part and the first moving part and guiding the first moving part to move in an optical axis direction; a second support member being disposed between the first moving part and the second moving part and guiding the second moving part to move in a direction perpendicular to the optical axis direction; and a third support member having one side coupled to the first moving part and the other side coupled to the second moving part.

The first moving part comprises a first elastic member, the second moving part may comprise a second elastic member, and the third support member may be coupled to the first elastic member and the second elastic member.

The third support member may comprise a wire.

It comprises: a first driving part that moves the first moving part; and a second driving part that moves the second moving part, wherein the first driving part comprises a first coil and a first magnet, wherein the second driving part comprises a second coil and a second magnet, and wherein the first coil and the second coil may be disposed in the first moving part.

The first magnet is disposed in the fixed part, and the second magnet may be disposed in the second moving part.

A camera device according to a first embodiment of the present invention may comprise: a printed circuit board; an image sensor being disposed on the printed circuit board; the lens driving device being disposed on the printed circuit board; and a lens being coupled to the lens driving device.

An optical apparatus according to a first embodiment of the present invention may comprise: a main body; the camera device being disposed on the main body; and a display disposed on the main body and outputting at least one of a video and an image captured by the camera device.

The lens driving device according to the second embodiment of the present invention may comprise: a fixed part; a moving part being disposed inside the fixed part; a coil and a magnet for moving the moving part in an optical axis direction; a ball being disposed between the fixed part and the moving part; a plate member being in contact with the ball; and an elastic member that pressurizes the plate member toward the ball.

The plate member is disposed between the ball and the fixed part, and the elastic member is disposed between the plate member and the fixed part to push the plate member against the fixed part.

The fixed part comprises a pillar part and an outer wall portion; and the ball may comprise a first ball being disposed between the moving part and the pillar part of the fixed part, and a second ball being disposed between the moving part and the outer wall portion of the fixed part. The plate member is disposed between the first ball and the pillar part of the fixed part, and the elastic member may be disposed between the plate member and the pillar part of the fixed part.

The first ball comprises a plurality of first balls being disposed in an optical axis direction; the plurality of first balls comprise a first uppermost ball being disposed highest and a first lowermost ball being disposed lowest; and the height of a point at which the elastic member pressurizes the plate member may be disposed between the height of the first uppermost ball and the height of the first lowermost ball.

The second ball comprises a plurality of second balls disposed in the optical axis direction, and the plurality of second balls may comprise a second uppermost ball being disposed highest and a second lowermost ball being disposed lowest.

The height of a point where the elastic member pressurizes the plate member may be lower than the height of a ball being disposed lower among the first uppermost ball and the second uppermost ball.

The height of a point at which the elastic member pressurizes the plate member may be higher than the height of a ball being disposed higher among the first lowermost ball and the second lowermost ball.

The plurality of first balls may comprise a ball being disposed between the first uppermost ball and the first lowermost ball having a smaller diameter than the first uppermost ball.

The elastic member comprises: a first bent part; a second bent part; and a third bent part being disposed between the first bent part and the second bent part, wherein the first bent part and the second bent part of the elastic member are disposed in the fixed part, and wherein the third bent part of the elastic member may be disposed in the plate member.

The fixed part comprises a first corner region and a second corner region being disposed in a diagonal direction with respect to an optical axis, and the ball may be disposed in the first corner region and the second corner region of the fixed part.

The moving part comprises a first groove and a second groove at an opposite side of the first groove, wherein the fixed part comprises a first groove being formed in the pillar part and a second groove being formed to face the first groove in the outer wall portion, wherein the elastic member is disposed in the first groove of the fixed part, wherein the first ball is disposed in the first groove of the moving part, and wherein the second ball may be disposed between the second groove of the fixed part and the second groove of the moving part.

The plate member may be disposed between the elastic member and the first ball.

The lens driving device comprises an inner side portion being disposed on an opposite side of the first groove of the pillar part of the fixed part, and an outer side portion being disposed on an opposite side of the second groove of the outer wall portion of the fixed part. And, it may comprise a reinforcing member comprising a connecting portion connecting the inner side portion and the outer side portion.

The lens driving device may comprise a cover being coupled to the moving part and being overlapped with the first ball and the second ball in an optical axis direction.

The lens driving device comprises a first substrate being disposed in the moving part, the magnet may be disposed in the fixed part, and the coil may be disposed on the first substrate.

The lens driving device comprises: an outer side portion being disposed in the fixed part; a coupling portion being coupled to the first substrate; and a second substrate comprising a connecting portion connecting the outer side portion and the coupling portion, wherein at least a portion of the connecting portion of the second substrate may move together with the first substrate.

The lens driving device comprises a substrate being disposed in the fixed part, the magnet is disposed in the moving part, and the coil may be disposed on the substrate.

A camera device according to a second embodiment of the present invention may comprise: a printed circuit board; an image sensor being disposed in the printed circuit board; a lens driving device being disposed on the printed circuit board; and a lens being coupled to the lens driving device.

An optical apparatus according to a second embodiment of the present invention may comprise: a main body; a camera device being disposed in the main body; and a display being disposed in the main body and outputting any one or more of a video and an image photographed by the camera device.

### Advantageous Effects

Through the first embodiment of the present invention, current consumption for performing the auto focus function can be reduced as the coil, which is lighter in weight than the magnet, is disposed in the moving part.

In addition, since the guide structure for OIS-x-axis driving and the guide structure for OIS-y-axis driving are integrally formed, the height of the lens driving device in an optical axis direction can be minimized.

Through this, the height at which the camera device is protruded from the smartphone can be minimized.

Through the second embodiment of the present invention, it is possible to replace the ball pressurizing structure through the attraction force between the yoke and the magnet.

Through this, since the centering force in an optical axis direction being generated when the ball is pressurized through the yoke and magnet disappears, that is, since there is no force to return to the centering position, even it is minute, the consumption of current consumed in AF driving can be reduced and the accuracy of AF driving can be enhanced.

In addition, in a second embodiment of the present invention, since the ball guide structure is disposed diagonally, rotation and tilt of the moving part can be prevented.

In addition, in a second embodiment of the present invention, current consumption for performing the auto focus function can be reduced as the coil, which is lighter in weight than the magnet, is disposed in the moving part.

Furthermore, in a modified embodiment, a lens driving device having a simplified configuration and structure can be provided in comparison with the second embodiment of the present invention. Through this, manufacturing cost can be reduced.

### BRIEF DESCRIPTION OF DRAWINGS

FIG. 1 is a conceptual diagram of a lens driving device according to a first embodiment of the present invention.

FIG. 2 is a perspective view of a lens driving device according to a first embodiment of the present invention.

FIG. 3 is a cross-sectional view viewed from A-A in FIG. 2.

FIG. 4 is a cross-sectional view viewed from B-B in FIG. 2.

FIG. 5 is a cross-sectional view viewed from C-C in FIG. 2.

FIG. 6 is a cross-sectional view viewed from D-D in FIG. 2.

FIG. 7 is a cross-sectional view of a lens driving device according to a first embodiment of the present invention cut in a direction perpendicular to an optical axis and viewed from above.

FIG. 8 is an exploded perspective view of a lens driving device according to a first embodiment of the present invention.

FIG. 9 is an exploded perspective view of a lens driving device according to a first embodiment of the present invention viewed from a direction different from that of FIG. 8.

FIG. 10 is an exploded perspective view of a holder member and a pre-pressurizing member of an AF carrier according to a first embodiment of the present invention.

FIG. 11 is an exploded perspective view of a holder member and a pre-pressurizing member of the AF carrier viewed from a direction different from that of FIG. 10.

FIGS. 12(a) and 12(b) are perspective views of an OIS moving part viewed from different directions.

FIG. 13 is a perspective view of a state in which a cover is omitted from a lens driving device according to a first embodiment of the present invention.

FIG. 14 is a perspective view of a state in which a cover of a lens driving device viewed from a direction different from that of FIG. 13 is omitted.

FIG. 15 is a perspective view illustrating a fixed part and related components of a lens driving device according to a first embodiment of the present invention.

FIG. 16 is a perspective view illustrating a moving part and related components of a lens driving device according to a first embodiment of the present invention.

FIG. 17 is a bottom perspective view of a moving part and related components of a lens driving device viewed from a direction different from that of FIG. 16.

FIG. 18 is a perspective view illustrating an AF moving part and related components of a lens driving device according to a first embodiment of the present invention.

FIG. 19 is a perspective view illustrating an AF moving part and related components of a lens driving device viewed from a direction different from that of FIG. 18.

FIG. 20 is a bottom view illustrating an AF moving part and related components of a lens driving device according to a first embodiment of the present invention.

FIG. 21 is a perspective view illustrating an OIS moving part and related components of a lens driving device according to a first embodiment of the present invention.

FIG. 22 is a plan view illustrating an OIS moving part and related components of a lens driving device according to a first embodiment of the present invention.

FIG. 23 is a perspective view illustrating a substrate and a coil of a lens driving device according to a first embodiment of the present invention.

FIG. 24 is a perspective view illustrating a substrate and a coil of a lens driving device viewed from a direction different from that of FIG. 23.

FIG. 25 is a perspective view illustrating a coil and a magnet of a lens driving device according to a first embodiment of the present invention.

FIG. 26 is a side view illustrating a coil and a substrate of a lens driving device according to a first embodiment of the present invention.

FIG. 27 is a side view illustrating an OIS moving part pressurized through a pre-pressurizing member of a lens driving device according to a first embodiment of the present invention.

FIG. 28 is a perspective view illustrating an upper elastic member, a lower elastic member, and a wire of the lens driving device according to the first embodiment of the present invention.

FIGS. 29 to 31 are views for explaining autofocus driving of a lens driving device according to a first embodiment of the present invention. FIG. 29 is a cross-sectional view of a moving part in an initial state in which no current is applied to an AF coil. FIG. 30 is a cross-sectional view illustrating a state in which a moving part moves upward in an optical axis direction when a forward current is applied to an AF coil. FIG. 31 is a cross-sectional view illustrating a moving part moving downward in an optical axis direction when a reverse current is applied to an AF coil.

FIGS. 32 to 34 are views for explaining hand shake compensation driving of a lens driving device according to a first embodiment of the present invention. FIG. 32 is a cross-sectional view illustrating the appearance of an OIS moving part in an initial state in which no current is applied to an OIS-x coil and an OIS-y coil. FIG. 33 is a cross-sectional view illustrating a state in which an OIS moving part moves in an x-axis direction perpendicular to an optical axis as current is applied to an OIS-x coil. FIG. 34 is a cross-sectional view illustrating a state in which a current is applied to an OIS-y coil so that an OIS moving part moves in a y-axis direction perpendicular to both the optical axis and the x-axis.

FIG. 35 is an exploded perspective view of a camera device according to a first embodiment of the present invention.

FIG. 36 is a perspective view of an optical apparatus according to a first embodiment of the present invention.

FIG. 37 is a perspective view of an optical apparatus according to a modified embodiment.

FIG. 38 is a perspective view of a lens driving device according to a second embodiment of the present invention.

FIG. 39 is a sectional view seen from A-A in FIG. 38.

FIG. 40 is a sectional view seen from B-B in FIG. 38.

FIG. 41 is a sectional view seen from C-C in FIG. 38.

FIG. 42 is a cross-sectional view seen from D-D in FIG. 38.

FIG. 43 is an exploded perspective view of a lens driving device according to a second embodiment of the present invention.

FIG. 44 is an exploded perspective view of FIG. 43 viewed from another direction.

FIG. 45 is a perspective view of a state in which a cover is omitted from a lens driving device according to a second embodiment of the present invention.

FIG. 46 is a perspective view of FIG. 45 viewed from another direction.

FIG. 47 is a perspective view illustrating a fixed part and related components of a lens driving device according to a second embodiment of the present invention.

FIG. 48 is a perspective view of FIG. 47 viewed from another direction.

FIG. 49 is a perspective view illustrating a moving part and related components of a lens driving device according to a second embodiment of the present invention.

FIG. 50 is a perspective view of FIG. 49 viewed from another direction.

FIG. 51 is a cross-sectional perspective view illustrating a driving part and related components of a lens driving device according to a second embodiment of the present invention.

FIG. 52 is a plan view of a state in which a cover is omitted from a lens driving device according to a second embodiment of the present invention.

FIG. 53 is an enlarged plan view of a part of FIG. 52 in a state where the cover is omitted.

FIG. 54 is a cross-sectional perspective view illustrating a ball and related components of a lens driving device according to a second embodiment of the present invention.

FIG. 55 is a perspective view illustrating a ball and related components of a lens driving device according to a second embodiment of the present invention.

FIG. 56 is a perspective view illustrating a ball accommodating structure of a base of a lens driving device according to a second embodiment of the present invention.

FIG. 57 is a perspective view illustrating a state in which the ball, plate member, elastic member, and reinforcing member are disposed in FIG. 56.

FIG. 58 is a perspective view of FIG. 57 viewed from another direction;

FIG. 59 is a perspective view illustrating a moving part and a ball of a lens driving device according to a second embodiment of the present invention.

FIG. 60 is a perspective view of FIG. 59 viewed from another direction;

FIG. 61(a) is a view comparing the heights of the ball and the pressurizing point in a state in which the moving part moves upward, and FIG. 61(b) is a diagram comparing the heights of the ball and the pressurizing point in a state in which the moving part moves downward.

FIG. 62 is a perspective view of a lens driving device according to a modified embodiment.

FIG. 63 is a sectional view seen from A-A in FIG. 62;

FIG. 64 is a sectional view seen from B-B in FIG. 62;

FIG. 65 is an exploded perspective view of a lens driving device according to a modified embodiment.

FIG. 66 is an exploded perspective view of FIG. 65 viewed from another direction;

FIG. 67 is a plan view and a partially enlarged view of a state in which a cover is omitted from a lens driving device according to a modified embodiment.

FIGS. 68 to 70 are views for explaining autofocus driving of a lens driving device according to a second embodiment of the present invention. FIG. 68 is a cross-sectional view of a moving part in an initial state in which no current is applied to the AF coil. FIG. 69 is a cross-sectional view illustrating a state in which a moving part moves upward in an optical axis direction when a forward current is applied to an AF coil. FIG. 70 is a cross-sectional view illustrating a moving part moving downward in an optical axis direction when a reverse current is applied to the AF coil.

FIGS. 71 to 73 are diagrams for explaining autofocus driving of a lens driving device according to a second embodiment of the present invention. FIG. 71 is a cross-sectional view illustrating the state of the moving part in an initial state in which no current is applied to the AF coil. FIG. 72 is a cross-sectional view illustrating a state in which a moving part moves upward in an optical axis direction when a forward current is applied to an AF coil. FIG. 73 is a cross-sectional view illustrating a moving part being moved downward in an optical axis direction when a reverse current is applied to the AF coil.

FIG. 74 is an exploded perspective view of a camera device according to a second embodiment of the present invention.

FIG. 75 is a perspective view of an optical apparatus according to a second embodiment of the present invention.

FIG. 76 is a perspective view of an optical apparatus according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’ due that another component between that other components.

In addition, when described as being formed or arranged in “on (above)” or “below (under)” of each component, “on (above)” or “below (under)” means that it comprises not only the case where the two components are directly in contact with, but also the case where one or more other components are formed or arranged between the two components. In addition, when expressed as “on (above)” or “below (under)”, the meaning of not only an upward direction but also a downward direction with respect to one component may be comprised.

An ‘optical axis (see OA of FIG. 29) direction’ used below is defined as an optical axis direction of a lens and/or an image sensor being coupled to a lens driving device.

The ‘vertical direction’ used below may be a direction parallel to or the same direction as an optical axis direction. A vertical direction may correspond to a ‘z-axis direction’. A ‘horizontal direction’ used below may be a direction perpendicular to a vertical direction. That is, a horizontal direction may be a direction perpendicular to an optical axis. Accordingly, a horizontal direction may comprise an ‘x-axis direction’ and a ‘y-axis direction’.

The ‘auto focus (AF) function’ used below is defined as a function that adjusts the distance to an image sensor by moving a lens in an optical axis direction according to the distance of a subject so that a clear image of the subject can be obtained on the image sensor, thereby automatically focusing on the subject. In addition, ‘closed-loop auto focus (CLAF) control’ is defined as real-time feedback control of the position of a lens by detecting the distance between an image sensor and a lens to enhance the accuracy of focus control.

An ‘optical image stabilization (OIS) function’ used below is defined as a function that moves or tilts a lens in a direction perpendicular to an optical axis to offset the hand shake in order to prevent an image or a video from shaking due to a user's hand shake. In addition, ‘closed-loop auto focus (CLAF) control’ is defined as a real-time feedback control of lens position by detecting the position of the lens relative to an image sensor to enhance the accuracy of image stabilization.

Hereinafter, any one of the “AF moving part 200” and the “OIS moving part 300” may be referred to as a “first moving part” and the other may be referred to as a “second moving part”.

Hereinafter, any one of the “AF driving part” and the “OIS driving part” may be referred to as a “first driving part” and the other may be referred to as a “second driving part”.

Hereinafter, any one of the “AF driving part”, the “OIS-x driving part” and the “OIS-y driving part” is referred to as a “first driving part”, the other may be referred to as a “second driving part”, and the other may be referred to as a “third driving part”.

Hereinafter, one of the “AF magnet”, the “OIS-x magnet” and the “OIS-y magnet” is referred to as a “first magnet”, the other is referred to as a “second magnet”, and the other may be referred to as a “third magnet”.

Hereinafter, one of the “AF coil 420”, the “OIS-x coil 520” and the “OIS-y coil 620” is referred to as a “first coil”, the other is referred to as a “second coil”, and the other may be referred to as a “third coil”.

Hereinafter, one among the “AF magnet 410”, the “OIS-x magnet 510”, the “OIS-y magnet 610”, the “AF coil 420”, the “OIS-x coil 520” and the “OIS-y coil 620” is referred to as “first driving unit”, the other is referred to as a “second driving unit”, the other is referred to as a “third driving unit”, the other is referred to as a “fourth driving unit”, the other is referred to as a “fifth driving unit”, and the other may be referred to as a “sixth driving unit”.

Hereinafter, any one of the “outer substrate 710” and the “inner substrate 720” may be referred to as a “first substrate” and the other may be referred to as a “second substrate”.

Hereinafter, any one of the “AF guide ball 810” and the “OIS guide ball 820” may be referred to as a “first ball” and the other may be referred to as a “second ball”.

Hereinafter, any one of the “holder member 220” and the “pre-pressurizing member 230” is referred to as a “first member” and the other may be referred to as a “second member”. In addition, hereinafter, any one of the “holder member 220” and the “pre-pressurizing member 230” may be referred to as a “first housing” and the other may be referred to as a “second housing”.

Hereinafter, any one of the “upper elastic member 830” and the “lower elastic member 840” is referred to as a “first elastic member” and the other may be referred to as a “second elastic member”.

Hereinafter, one among the “upper elastic member 830”, the “lower elastic member 840”, and the “wire 850” is referred to as a “first support member”, the other is referred to as a “second support member”, and the other may be referred to as a “thirdsupport member”.

Hereinafter, one among the “AF sensor 430”, the “OIS-x sensor 530”, and the “OIS-y sensor 630” is referred to as a “first sensor”, the other is referred to as a “secondsensor”, and the other may be referred to as a “third sensor”.

Hereinafter, one among the “AF yoke 440”, the “OIS-x yoke 540”, and the “OIS-y yoke 640” is referred to as a “first yoke”, the other is referred to as a “secondyoke”, and the other may be referred to as a “thirdyoke”.

Hereinafter, one of the “inner groove 1111-1” and the “outer groove 1112-1” is referred to as a “first groove”, and the other may be referred to as a “second groove”.

Hereinafter, one of the “inner groove 1211” and the “outer groove 1212” is referred to as a “first groove”, and the other may be referred to as a “second groove”.

Hereinafter, one of the “inner ball 1410” and the “outer ball 1420” is referred to as a “first ball”, and the other may be referred to as a “second ball”.

Hereinafter, one of the “uppermost inner ball 1411” and the “uppermost outer ball 1421” is referred to as a “first uppermost ball”, and the other may be referred to as a “second uppermost ball”. Hereinafter, one of the “lowermost inner ball 1412” and the “lowermost outer ball 1422” is referred to as a “first lowermost ball”, and the other may be referred to as a “second lowermost ball”.

Hereinafter, one among the “upper bent part 1521”, the “lower bent part 1522”, and the “connection bent part 1523” is referred to as a “first bent part”, the other is referred to as a “second bent part”, and the other may be referred to as a “thirdbent part”.

Hereinafter, any one of the “inner substrate 1610” and the “outer substrate 1620” may be referred to as a “first substrate” and the other may be referred to as a “second substrate”.

Hereinafter, a configuration of a lens driving device according to a first embodiment of the present invention will be described with reference to the drawings.

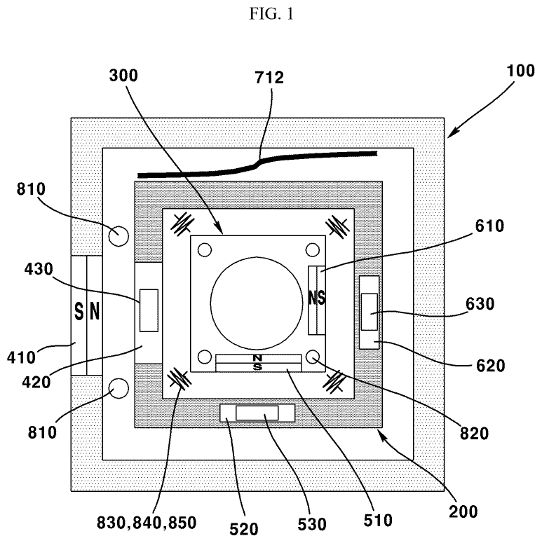

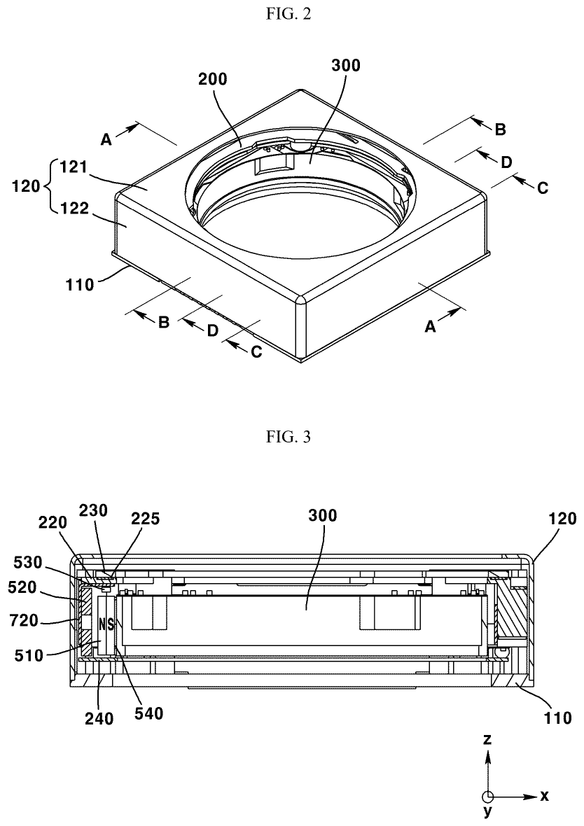

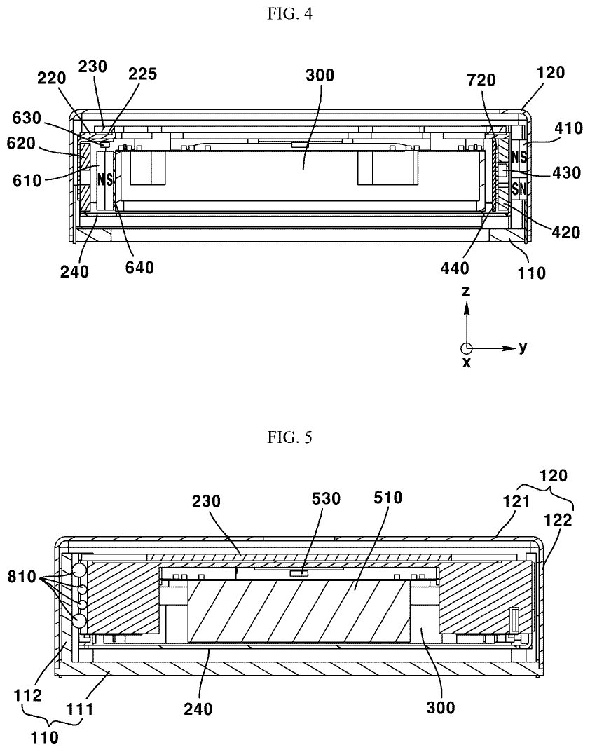

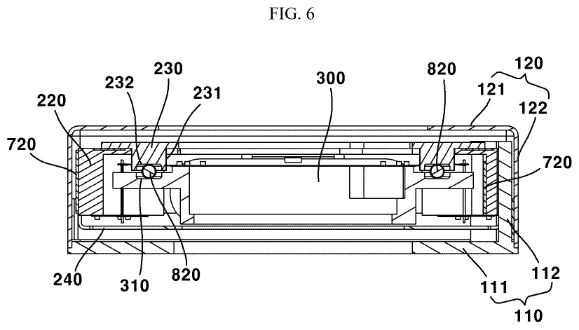

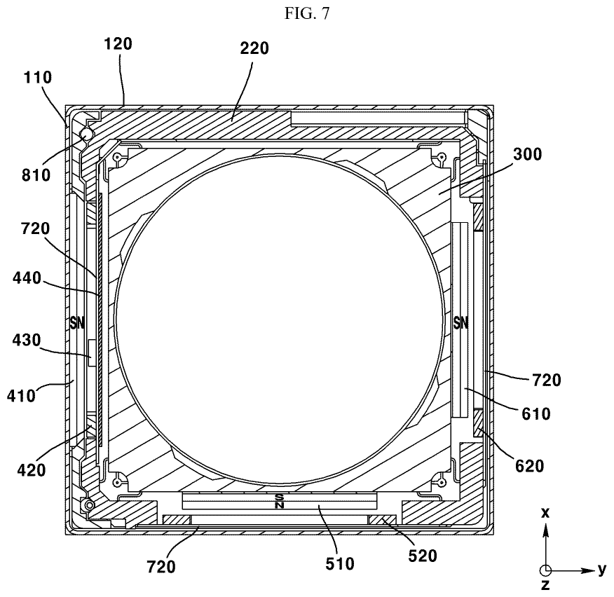

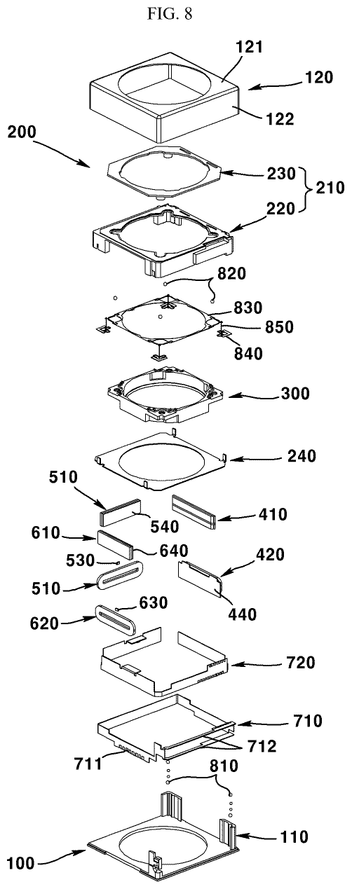

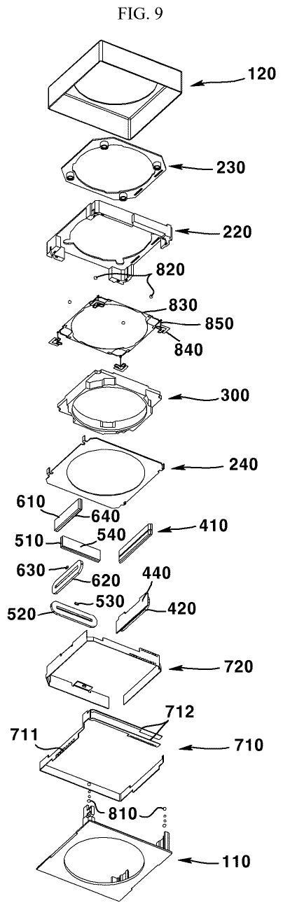

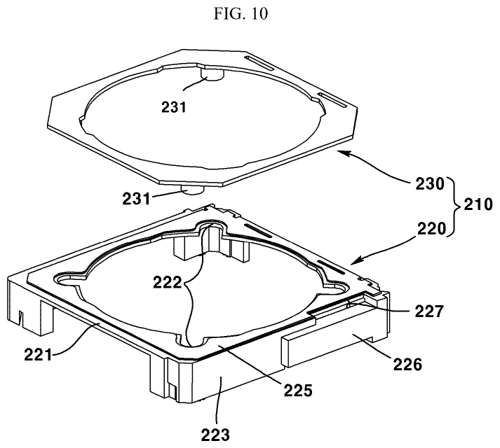

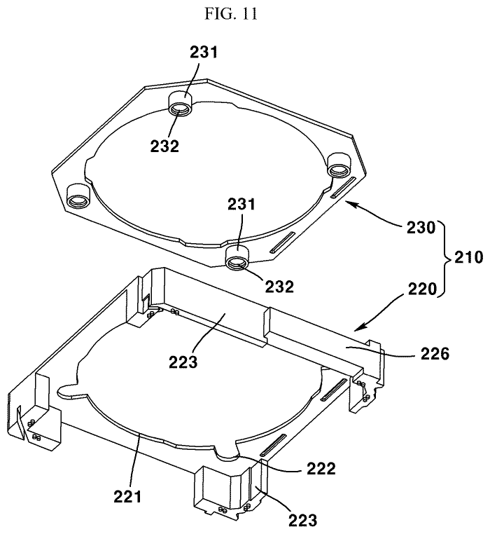

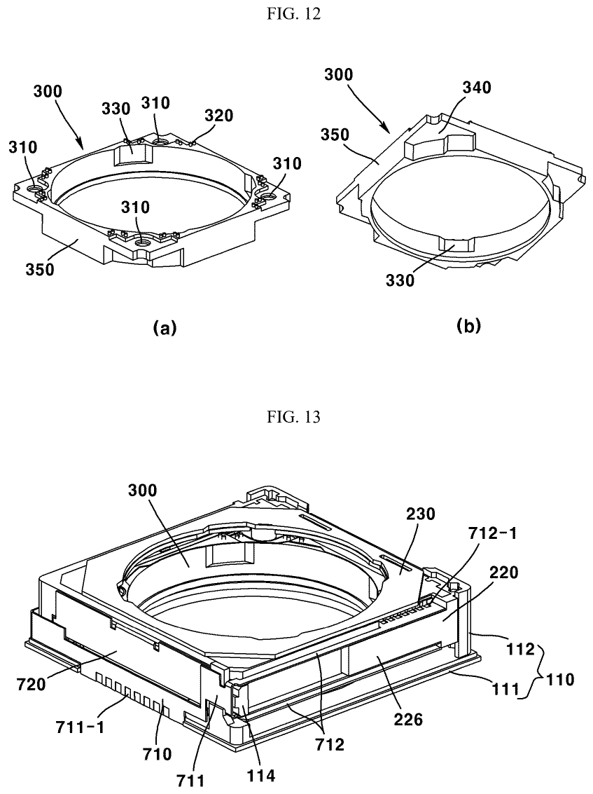

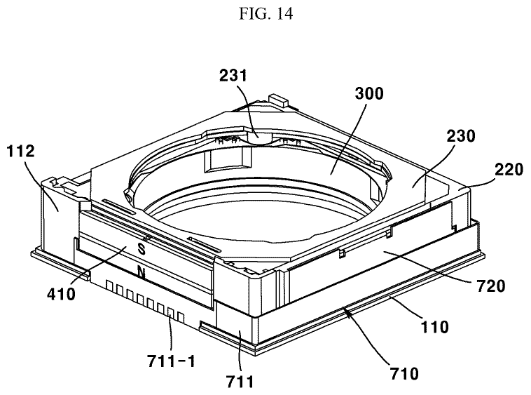

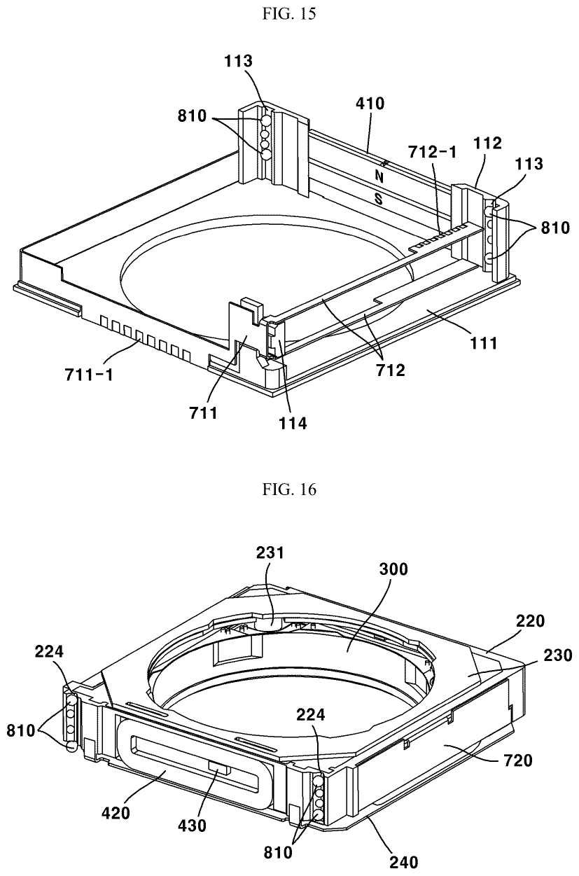

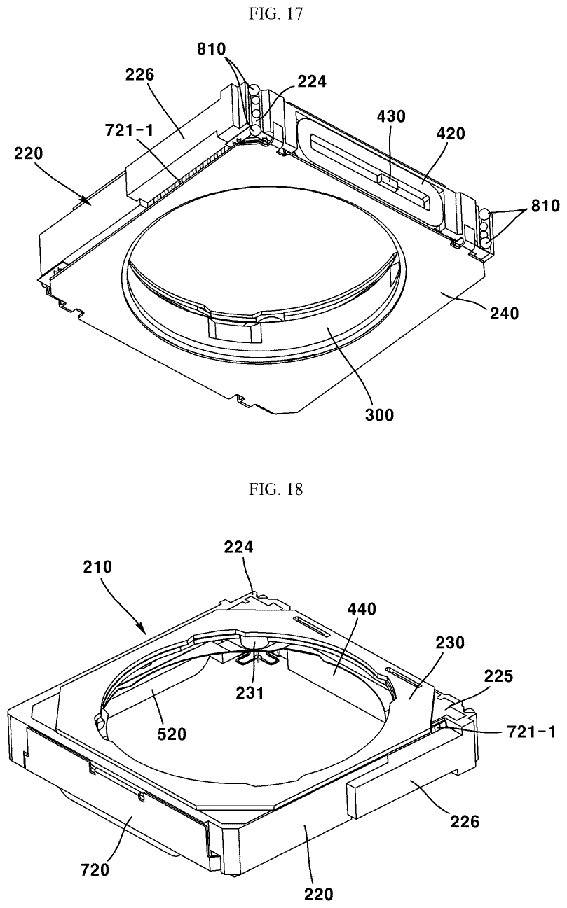

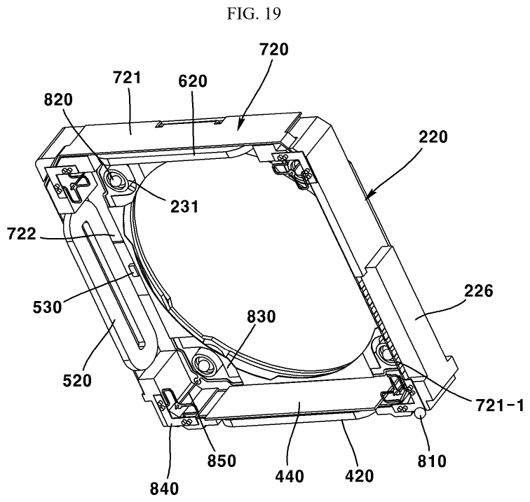

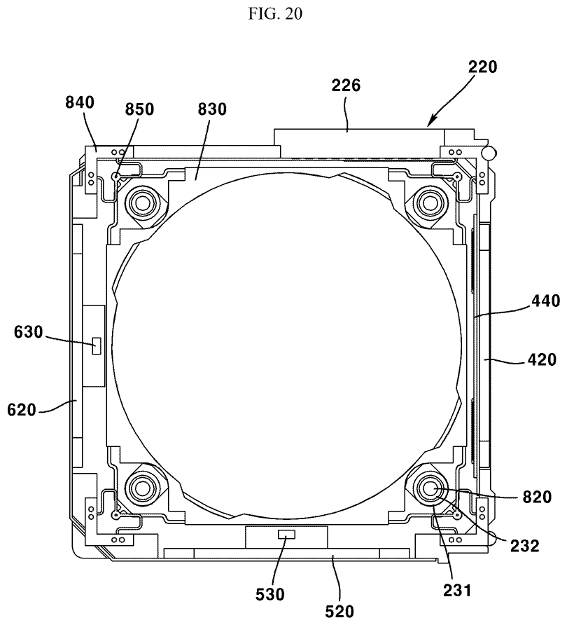

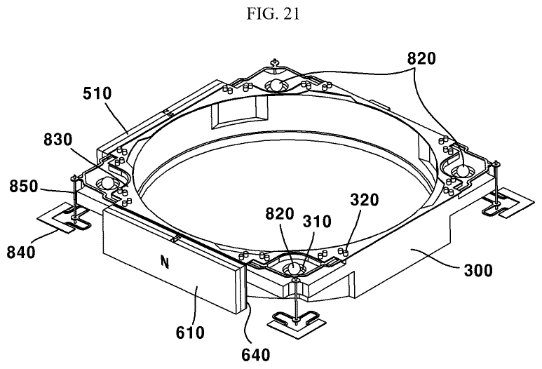

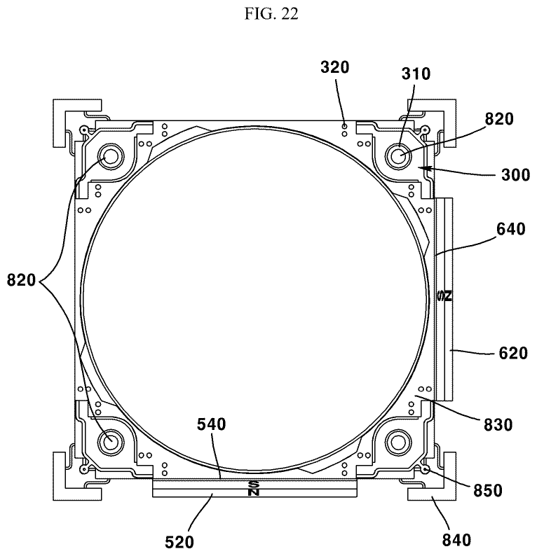

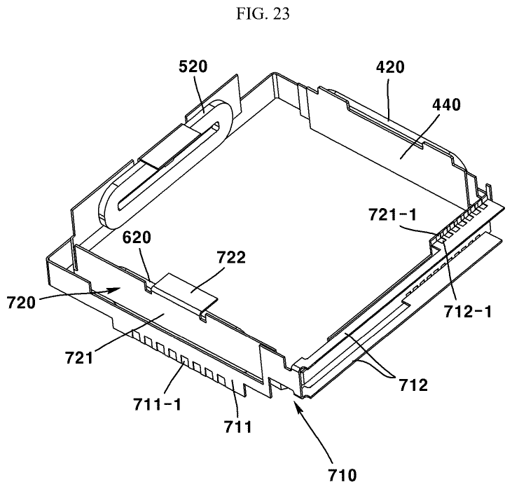

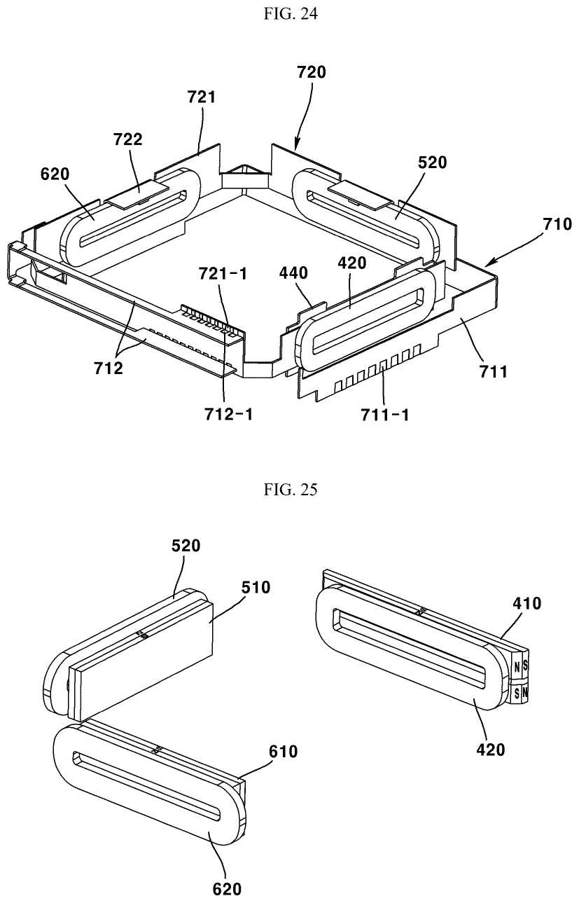

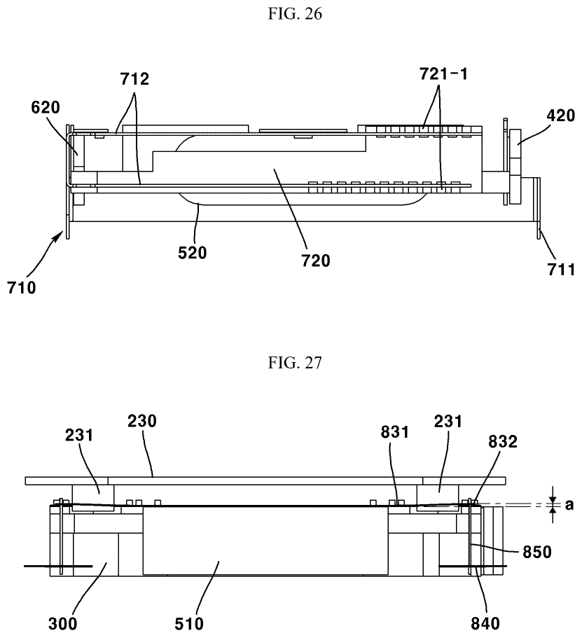

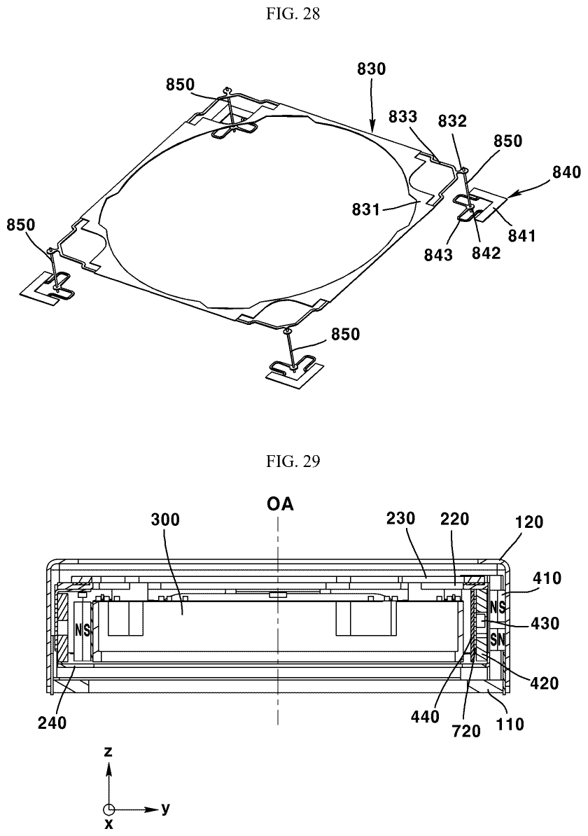

FIG. 1 is a conceptual diagram of a lens driving device according to a first embodiment of the present invention; FIG. 2 is a perspective view of a lens driving device according to a first embodiment of the present invention; FIG. 3 is a cross-sectional view viewed from A-A in FIG. 2; FIG. 4 is a cross-sectional view viewed from B-B in FIG. 2; FIG. 5 is a cross-sectional view viewed from C-C in FIG. 2; FIG. 6 is a cross-sectional view viewed from D-D in FIG. 2; FIG. 7 is a cross-sectional view of a lens driving device according to a first embodiment of the present invention cut in a direction perpendicular to an optical axis and viewed from above; FIG. 8 is an exploded perspective view of a lens driving device according to a first embodiment of the present invention; FIG. 9 is an exploded perspective view of a lens driving device according to a first embodiment of the present invention viewed from a direction different from that of FIG. 8; FIG. 10 is an exploded perspective view of a holder member and a pre-pressurizing member of an AF carrier according to a first embodiment of the present invention; FIG. 11 is an exploded perspective view of a holder member and a pre-pressurizing member of the AF carrier viewed from a direction different from that of FIG. 10; FIGS. 12(a) and 12(b) are perspective views of an OIS moving part viewed from different directions; FIG. 13 is a perspective view of a state in which a cover is omitted from a lens driving device according to a first embodiment of the present invention; FIG. 14 is a perspective view of a state in which a cover of a lens driving device viewed from a direction different from that of FIG. 13 is omitted; FIG. 15 is a perspective view illustrating a fixed part and related components of a lens driving device according to a first embodiment of the present invention; FIG. 16 is a perspective view illustrating a moving part and related components of a lens driving device according to a first embodiment of the present invention; FIG. 17 is a bottom perspective view of a moving part and related components of a lens driving device viewed from a direction different from that of FIG. 16; FIG. 18 is a perspective view illustrating an AF moving part and related components of a lens driving device according to a first embodiment of the present invention; FIG. 19 is a perspective view illustrating an AF moving part and related components of a lens driving device viewed from a direction different from that of FIG. 18; FIG. 20 is a bottom view illustrating an AF moving part and related components of a lens driving device according to a first embodiment of the present invention; FIG. 21 is a perspective view illustrating an OIS moving part and related components of a lens driving device according to a first embodiment of the present invention; FIG. 22 is a plan view illustrating an OIS moving part and related components of a lens driving device according to a first embodiment of the present invention; FIG. 23 is a perspective view illustrating a substrate and a coil of a lens driving device according to a first embodiment of the present invention; FIG. 24 is a perspective view illustrating a substrate and a coil of a lens driving device viewed from a direction different from that of FIG. 23; FIG. 25 is a perspective view illustrating a coil and a magnet of a lens driving device according to a first embodiment of the present invention; FIG. 26 is a side view illustrating a coil and a substrate of a lens driving device according to a first embodiment of the present invention; FIG. 27 is a side view illustrating an OIS moving part pressurized through a pre-pressurizing member of a lens driving device according to a first embodiment of the present invention; and FIG. 28 is a perspective view illustrating an upper elastic member, a lower elastic member, and a wire of the lens driving device according to the first embodiment of the present invention.

The lens driving device 10 may be a voice coil motor (VCM). The lens driving device 10 may be a lens driving motor. The lens driving device 10 may be a lens driving actuator. The lens driving device 10 may comprise an AF module. The lens driving device 10 may comprise an OIS module.

The lens driving device 10 may comprise a fixed part 100. The fixed part 100 may be a relatively fixed part when the moving part moves. The moving part may move against the fixed part 100.

The lens driving device 10 may comprise a base 110. The fixed part 100 may comprise a base 110. The base 110 may be disposed below the AF carrier 210. The base 110 may be disposed below the OIS carrier 300. The base 110 may be coupled with cover 120. The AF carrier 210 and the OIS carrier 300 may be disposed on the base 110. The AF carrier 210 and the OIS carrier 300 may be disposed on a lower plate portion 111 of the base 110. The AF carrier 210 and the OIS carrier 300 may be disposed inside the base 110. The AF carrier 210 and the OIS carrier 300 may be disposed inside the side wall part 112 of the base 112.

The base 110 may comprise a lower plate portion 111. The base 110 may comprise a side wall part 112. The side wall part 112 may be a ‘side part’. The side wall part 112 may be a ‘side plate’. The side wall part 112 may be a ‘side wall’. The side wall part 112 of the base 110 may be extended from an upper surface of the lower plate part 111.

The side wall part 112 of the base 110 may comprise a plurality of side walls. The side wall part 112 of the base 110 may comprise four side walls. The side wall part 112 of the base 110 may comprise first to fourth side walls. The side wall part 112 of the base 110 may comprise a first side wall and a second side wall being disposed opposite to each other, and a third side wall and a fourth side wall being disposed opposite to each other. At this time, the AF magnet 410 may be disposed on the first side plate of the base 110. The OIS-x magnet 510 may be disposed at a position corresponding to the third side plate of the base 110. The OIS-y magnet 610 may be disposed at a position corresponding to the second side plate of the base 110.

The base 110 may comprise a groove 113. The groove 113 may be an ‘AF guide ball accommodating groove’. An AF guide ball 810 may be disposed in the groove 113. The groove 113 may be directly in contact with the AF guide ball 810. The groove 113 may be disposed in an optical axis direction. The groove 113 may comprise a plurality of grooves. The groove 113 may comprise two grooves. The two grooves may be disposed parallel to each other. The groove 113 may comprise a first groove being in contact with the AF guide ball 810 at two points and a second groove being in contact with the AF guide ball 810 at one point. As a modified embodiment, both the first groove and the second groove may be in contact with the AF guide ball 810 at two points. The base 110 may comprise a first guide for guiding the AF guide ball 810 to move. The first guide may comprise a groove 113.

The base 110 may comprise a protruded part 114. The protruded part 114 may be protruded to the outer side. The connecting portion 712 of the outer substrate 710 may be disposed on an upper side and a lower side of the protruded part 114. A groove may be formed in the protruded part 114 so as not to interfere even when the connecting portion 712 of the outer substrate 710 moves.

The base 110 may comprise a step. The step may be formed at a lower end portion of an outer side surface of the base 110. The step may be protruded from an outer side surface of the base 110. The side plate 122 of the cover 120 may be disposed in the step of the base 110.

The lens driving device 10 may comprise a cover 120. The fixed part 100 may comprise a cover 120. The cover 120 may be disposed on the base 110. The cover 120 may be disposed on the base 110. The cover 120 may be coupled to the base 110. The cover 120 may be fixed to the base 110. The cover 120 may accommodate the AF carrier 210 therein. The cover 120 may accommodate the OIS carrier 300 therein. The cover 120 may be a shield member. The cover 120 may be a shield can.

The cover 120 may comprise an upper plate 121. The upper plate 121 may be disposed on a moving part. The upward movement of the moving part may be limited by contacting of the moving part with the upper plate 121. The upper plate 121 may comprise a hole through which light passes.

The cover 120 may comprise a side plate 122. The side plate 122 may be extended from the upper plate 121. The side plate 122 may be disposed on the base 110. The side plate 122 may be disposed on a step portion being protruded from a lower end portion of an outer side surface of the base 110. The side plate 122 may comprise a plurality of side plates. The side plate 122 may comprise four side plates. The side plate 122 may comprise a first side plate and a second side plate being disposed opposite to each other, and a third side plate and a fourth side plate being disposed opposite to each other.

The lens driving device 10 may comprise a moving part. The moving part may be disposed in the fixed part 100. The moving part may be disposed inside the fixed part 100. The moving part may be disposed on the fixed part 100. The moving part may be movably disposed in the fixed part 100. The moving part may move based on the fixed part 100 by the driving part. The moving part can move during AF driving. The moving part can move during OIS driving. A lens may be coupled to the moving part.

The lens driving device 10 may comprise an AF moving part 200. The AF moving part 200 may be disposed in the fixed part 100. The AF moving part 200 may be disposed inside the fixed part 100. The AF moving part 200 may be disposed on the fixed part 100. The AF moving part 200 may be disposed between the fixed part 100 and the OIS moving part 300. The AF moving part 200 may be movably disposed in the fixed part 100. The AF moving part 200 may move in an optical axis direction against the fixed part 100 by the AF driving part 400. The AF moving part 200 may move during AF driving.

The lens driving device 10 may comprise an AF carrier 210. The AF moving part 200 may comprise an AF carrier 210. The AF carrier 210 may be an ‘AF holder’. The AF carrier 210 may be a ‘housing’. The AF carrier 210 may be disposed inside the base 110. AF carrier 210 may be disposed on the base 110. The AF carrier 210 may be disposed inside the cover 120. The AF carrier 210 may be disposed between the base 110 and the OIS carrier 300. The AF carrier 210 may be movably disposed in an optical axis direction.

The AF carrier 210 may comprise a frame, a first upper plate, and a second upper plate. At this time, the frame may be a body part. The frame may be the holder member 220. The first upper plate may be a metal member 225. The second upper plate may be a pre-pressurizing member 230. The AF carrier 210 may be a housing. The housing may comprise a first housing and a second housing. At this time, the first housing may comprise the holder member 220 and the second housing may comprise the pre-pressurizing member 230. The OIS carrier 300 may be a bobbin. The OIS guide ball 820 may be disposed between the housing and the bobbin. The AF guide ball 810 may be disposed between a side surface of the housing and the cover 120. The AF guide ball 810 may be disposed between a side surface of the housing and a base or pillar of the base.

The lens driving device 10 may comprise a holder member 220. The AF carrier 210 may comprise a holder member 220. The holder member 220 may be formed separately from the pre-pressurizing member 230. A lower elastic member 840 may be coupled to the holder member 220. The AF carrier 210 may comprise an upper plate 221. The upper plate 221 may be disposed on the OIS carrier 300. The upper plate 221 may be disposed between the OIS carrier 300 and the upper plate 121 of the cover 120. The upper plate 221 may be disposed on the OIS moving part.

The AF carrier 210 may comprise a groove 222. The holder member 220 may comprise a groove 222. The upper plate 221 of the holder member 220 may comprise a groove 222. The groove 222 may be formed in the upper plate 221 of the holder member 220. The groove 222 may open inwardly. A pre-pressurizing member 230 may be inserted into the groove 222. A protruded part 231 of the pre-pressurizing member 230 may be inserted into the groove 222. The groove 222 may be formed as a hole. The groove 222 may be replaced with a hole. That is, as a modified embodiment, the AF carrier 210 may comprise a hole into which the protruded part 231 of the pre-pressurizing member 230 is inserted.

The AF carrier 210 may comprise a side wall 223. The sidewall 223 may be extended downward from an upper plate 221. An inner substrate 720 may be disposed on a side wall 223. An AF coil 420 may be disposed on the side wall 223. An OIS-x coil 520 may be disposed on a side wall 223. An OIS-y coil 620 may be disposed on a side wall 223. The side wall 223 may comprise a groove that avoids the coil. The side wall 223 may comprise a plurality of side walls. The side wall 223 may comprise four side walls. The side wall 223 may comprise a first sidewall and a second sidewall being disposed opposite to each other, and a third sidewall and a fourth sidewall being disposed opposite to each other.

The AF carrier 210 may comprise a groove 224. The holder member 220 may comprise a groove 224. The groove 224 may be an ‘AF guide ball accommodating groove’. An AF guide ball 810 may be disposed in the groove 224. The groove 224 may be directly in contact with the AF guide ball 810. The groove 224 may be disposed in an optical axis direction. The groove 224 may comprise a plurality of grooves. The grooves 224 may comprise two grooves. The two grooves may be disposed parallel to each other. The groove 224 may comprise a first groove being in contact with the AF guide ball 810 at two points and a second groove being in contact with the AF guide ball 810 at one point. As a modified embodiment, both the first groove and the second groove may be in contact with the AF guide ball 810 at two points. The side surface of the AF carrier 210 may comprise a second guide for guiding the AF guide ball 810 to move. The second guide may comprise a groove 224.

The AF carrier 210 may comprise a metal member 225. The holder member 220 may comprise a metal member 225. The metal member 225 may be insert-injected into the holder member 220. At least a portion of the metal member 225 may be disposed on an upper surface of the holder member 220. The metal member 225 may be disposed to reinforce the strength of the holder member 220.

The AF carrier 210 may comprise a protruded part 226. The holder member 220 may comprise a protruded part 226. The protruded part 226 may be formed on an outer side surface of the AF carrier 210. The protruded part 226 may be protruded outward from the AF carrier 210. A connecting portion 712 may be disposed on an upper surface and a lower surface of the protruded part 226.

The AF carrier 210 may comprise a hole 227. The hole 227 may be disposed adjacent to an upper surface of the protruded part 226.

The lens driving device 10 may comprise a pre-pressurizing member 230. The AF carrier 210 may comprise a pre-pressurizing member 230. The pre-pressurizing member 230 may be coupled to an upper surface of the holder member 220. The pre-pressurizing member 230 may be coupled with the holder member 220. The pre-pressurizing member 230 may be inserted and coupled to the holder member 220 from above. The pre-pressurizing member 230 may apply pressure to the OIS guide ball 820. The pre-pressurizing member 230 may be in contact with the OIS guide ball 820. The pre-pressurizing member 230 may be directly in contact with the OIS guide ball 820. The pre-pressurizing member 230 may pressurize to the OIS guide ball 820 by being coupled to the holder member 220.

The AF carrier 210 may comprise a protruded part 231. The pre-pressurizing member 230 may comprise a protruded part 231. The protruded part 231 may be coupled to the groove 222 of the holder member 220. The protruded part 231 of the pre-pressurizing member 230 may be inserted into a groove 222 of the holder member 220 from above. The protruded part 231 of the pre-pressurizing member 230 may be disposed in a groove 222 of the holder member 220. At least a part of the protruded part 231 of the pre-pressurizing member 230 may be disposed in a groove 222 of the holder member 220. The OIS guide ball 820 may be disposed on a lower end portion of the protruded part 231 of the pre-pressurizing member 230. The protruded part 231 may comprise a plurality of protrusions. The protruded part 231 may comprise four protrusions.

The AF carrier 210 may comprise a groove 232. The pre-pressurizing member 230 may comprise a groove 232. The groove 232 may be an ‘OIS guide ball accommodating groove’. The groove 232 may be formed in the protruded part 231. The groove 232 may be formed on a lower surface of the protruded part 231. The groove 232 may be formed at an end portion of the protruded part 231. The groove 232 may be concavely formed on a lower surface of the protruded part 231. An OIS guide ball 820 may be disposed in the groove 232. The groove 232 may be directly in contact with the plate member 825.

The lens driving device 10 may comprise a cover 240. The AF moving part 200 may comprise a cover 240. The cover 240 may be coupled with the AF carrier 210. The cover 240 may be coupled to a lower surface of the AF carrier 210. The cover 240 may be coupled to the AF carrier 210 at a lower side. The cover 240 may comprise a hook. The hook of the cover 240 may be coupled to the AF carrier 210. The hook of the cover 240 is protruded upward and may be coupled to a side surface of the AF carrier 210.

Hereinafter, any one of the ‘groove 222’, ‘groove 224’ and ‘groove 232’ of the AF carrier 210 is referred to as a ‘first groove’, the other is referred to as a ‘second groove’, and yet the other can be referred to as the ‘third groove’.

The lens driving device 10 may comprise an OIS moving part. The OIS moving part may be disposed in the fixed part 100. The OIS moving part may be disposed inside the fixed part 100. The OIS moving part may be disposed on the fixed part 100. The OIS moving part may be disposed inside the AF moving part 200. The OIS moving part may be movably disposed. The OIS moving part may move in a direction perpendicular to the optical axis against the fixed part 100 and the AF moving part 200 by the OIS driving part. The OIS moving part may move during OIS driving. The lens driving device 10 may comprise an OIS carrier 300. The OIS moving part may comprise an OIS carrier 300. The OIS carrier 300 may be an ‘OIS holder’. The OIS carrier 300 may be a ‘bobbin’. The OIS carrier 300 may be disposed inside the AF carrier 210. The OIS carrier 300 may be disposed inside the base 110. The OIS carrier 300 may be disposed on the base 110. The OIS carrier 300 may be disposed inside the cover 120. The OIS carrier 300 may be movably disposed in a direction perpendicular to the optical axis.

The OIS carrier 300 may comprise an outer side surface. The OIS carrier 300 may comprise a plurality of side surfaces. The OIS carrier 300 may comprise a first side surface and a second side surface being disposed opposite to each other, and a third side surface and a fourth side surface being disposed opposite to each other. The AF coil 420 may be disposed between a first side surface of the OIS carrier 300 and the AF magnet 410. The OIS-x magnet 510 may be disposed on a third side surface of the OIS carrier 300. The OIS-y magnet 610 may be disposed on a second side surface of the OIS carrier 300.

The OIS carrier 300 may comprise a groove. The groove may be an ‘upper elastic member interference prevention groove’. A groove may be formed on an upper surface of the OIS carrier 300. The groove may be concavely formed on an upper surface of the OIS carrier 300. The groove may be disposed at a position corresponding to the upper elastic member 830 to prevent interference between the OIS carrier 300 and the upper elastic member 830.

The OIS carrier 300 may comprise a groove 310. The groove 310 may be an ‘OIS guide ball accommodating groove’. An OIS guide ball 820 may be disposed in the groove 310. The groove 310 may be directly in contact with the OIS guide ball 820. The groove 310 may be disposed in a direction perpendicular to the optical axis. The groove 310 may be recessed in an optical axis direction. The groove 310 may comprise a plurality of grooves. The groove 310 may comprise four grooves. The groove 310 may be in contact with the OIS guide ball 820 at one point. Or, the groove 310 may be in contact with the OIS guide ball 820 at two points. The number of contact points between the OIS carrier 300 and the OIS guide ball 820 may vary due to the movement of the OIS guide ball 820. The groove 310 may be formed on an upper surface of the OIS carrier 300. The groove 310 may be open upward.

The OIS carrier 300 may comprise a lateral stopper. The lateral stopper may limit the stroke of the OIS carrier 300 in a lateral direction. That is, when the OIS carrier 300 moves to the maximum, the lateral stopper of the OIS carrier 300 may be in contact with one or more of the AF carrier 210 and the base 110. The lateral stopper may be formed on an outer side surface of the OIS carrier 300. The lateral stopper may be protruded outward from a side surface of the OIS carrier 300.

The OIS carrier 300 may comprise a protrusion 320. The protrusion 320 may be coupled with the upper elastic member 830. The protrusion 320 may be a ‘coupling protrusion’. The upper elastic member 830 may comprise a hole into which the protrusion 320 of the OIS carrier 300 is inserted. The protrusion 320 may be formed on an upper surface of the OIS carrier 300.

The OIS carrier 300 may comprise a groove 330. The groove 313 may be a ‘lens adhesive accommodating groove’. The groove 330 may be formed on an inner circumferential surface of the OIS carrier 300. The groove 330 may be concavely formed on an inner circumferential surface of the OIS carrier 300. An adhesive may be injected between the lens and the OIS carrier 300 through the groove 330. An adhesive for bonding the lens and the OIS carrier 300 may be disposed in the groove 330.

The OIS carrier 300 may comprise a groove 340. The groove 340 may be formed on a lower surface of the OIS carrier 300. The groove 340 may be opened outward.

The OIS carrier 300 may comprise a mounting part 350. The mounting part 350 may be a ‘magnet mounting part’. The magnets 510 and 620 may be disposed on the mounting part 350. The mounting part 350 may be formed as a groove, for an example.

Hereinafter, any one of the ‘groove 310’, ‘groove 330’ and ‘groove 340’ of the OIS carrier 300 is referred to as a ‘first groove’, and the other is referred to as a ‘second groove’, and yet the other may be referred to as the ‘third groove’.

The lens driving device 10 may comprise a driving part. The driving part may move the moving part against the fixed part 100. The driving part may comprise the AF driving part. The driving part may comprise an AF driving part. The driving part may comprise an OIS-x driving part. The driving part may comprise an OIS-y driving part. The driving part may comprise a coil and a magnet.

The lens driving device 10 may comprise an AF driving part. The AF driving part may move the AF moving part 200 in an optical axis direction. The AF driving part may move the AF carrier 210 in an optical axis direction. The AF driving part may move the AF carrier 210 in an optical axis direction through electromagnetic force. The AF driving part may comprise a coil and a magnet.

In a first embodiment of the present invention, the AF carrier 210 and the OIS carrier 300 can move in an optical axis direction by the interaction between the AF coil 420 and the AF magnet 410. The AF coil 420, the AF carrier 210, and the OIS carrier 300 may move integrally in an optical axis direction.

The lens driving device 10 may comprise an AF magnet 410. The AF driving part 400 may comprise an AF magnet 410. The AF magnet 410 may be an ‘AF magnet’. The AF magnet 410 may be a permanent magnet. The AF magnet 410 may be disposed in the fixed part 100. The AF magnet 410 may be disposed on the base 110. The AF magnet 410 may be disposed in the cover 120. The AF magnet 410 may be disposed in the side plate 122 of the cover 120. The AF magnet 410 may be disposed on an outer side surface of the base 110. The AF magnet 410 may be disposed on an inner side surface of the base 110. The AF magnet 410 may be fixed to the base 110. AF magnet 410 may be coupled to the base 110. The AF magnet 410 may be attached to the base 110 with an adhesive. The AF magnet 410 may be disposed inside the cover 120. The AF magnet 410 may interact with the AF coil 420. The AF magnet 410 may interact with the AF coil 420 electromagnetically. The AF magnet 410 may be disposed at a position corresponding to the AF coil 420. The AF magnet 410 and the AF coil 420 may face each other. The AF magnet 410 may face the AF coil 420. The AF magnet 410 may be overlapped with the AF coil 420 in a direction perpendicular to the optical axis.

The AF magnet 410 may be a 4-pole magnet. The AF magnet 410 may comprise a 4-pole magnetized magnet. The AF magnet 410 may comprise a first magnet part comprising an N pole and an S pole, and a second magnet part comprising an N pole and an S pole. The first magnet part and the second magnet part may be disposed in a vertical direction. The first magnet part and the second magnet part are disposed spaced apart from each other in a vertical direction, and a neutral part may be disposed between the first magnet part and the second magnet part.

The lens driving device 10 may comprise an AF coil 420. The AF driving part 400 may comprise an AF coil 420. The AF coil 420 may interact with the AF magnet 410. The AF coil 420 may face the AF magnet 410. The AF coil 420 and the AF magnet 410 may face each other. The AF coil 420 may be disposed at a position corresponding to the AF magnet 410. The AF coil 420 may be overlapped with the AF magnet 410 in a direction perpendicular to the optical axis. The AF coil 420 may be disposed on an inner substrate 720. The AF coil 420 may be disposed in the AF carrier 210. The AF coil 420 may be disposed in the AF moving part 200.

In a first embodiment of the present invention, the AF coil 420 can move in an optical axis direction. The AF coil 420 may move in an optical axis direction through interaction with the AF magnet 410. The AF coil 420 may move together with the AF moving part 200. The AF coil 420 may move in an optical axis direction together with the AF moving part 200. During the AF driving process, the AF coil 420 may move along with the AF moving part 200 in an optical axis direction. The AF coil 420 may be disposed in the AF moving part 200. The AF coil 420 may be fixed to the AF moving part 200. The AF coil 420 may be coupled to the AF moving part 200.

The lens driving device 10 may comprise an AF sensor 430. The AF driving part 400 may comprise an AF sensor 430. The AF sensor 430 may be a Hall sensor. The AF sensor 430 may be disposed in the inner substrate 720. The AF sensor 430 may detect the AF magnet 410. The AF sensor 430 may detect movement of the AF magnet 410. The movement amount or position of the AF magnet 410 detected by the AF sensor 430 may be used for feedback of auto focus driving.

The AF sensor 430 may be a driver IC. The driver IC may comprise a sensing unit. The sensing unit may comprise a Hall IC. The driver IC may be electrically connected to the AF coil 420. The driver IC may supply current to the AF coil 420.

The AF sensor 430 may be disposed inside the AF coil 420. The AF sensor 430 may be overlapped with a neutral portion of the AF magnet 410 in a direction perpendicular to the optical axis. As a modified embodiment, the AF sensor 430 may be disposed outside the AF coil 420. The AF sensor 430 may be overlapped with the AF coil 420 in an optical axis direction. The AF sensor 430 may be overlapped with the AF coil 420 in a direction perpendicular to the optical axis.

The lens driving device 10 may comprise an AF yoke 440. The AF yoke 440 may be disposed at a position corresponding to the AF magnet 410. An attractive force may act between the AF yoke 440 and the AF magnet 410. The contact between the AF guide ball 810 and the base 110 and the AF carrier 210 can be maintained as it is by the attractive force between the AF yoke 440 and the AF magnet 410. The AF yoke 440 may be disposed in the inner substrate 720. The AF yoke 440 may be disposed inside the AF coil 420.

The lens driving device 10 may comprise an OIS driving part. The OIS driving part may move the OIS moving part 300 in a direction perpendicular to the optical axis direction. The OIS driving part may move the OIS carrier 300 in a direction perpendicular to the optical axis. The OIS driving part may move the OIS carrier 300 in a direction perpendicular to the optical axis through electromagnetic force.

The lens driving device 10 may comprise an OIS-x driving part. The OIS driving part may comprise an OIS-x driving part. The OIS-x driving part may move the OIS carrier 300 in an x-axis direction perpendicular to the optical axis. The OIS-x driving part may move the OIS carrier 300 in an x-axis direction perpendicular to the optical axis through electromagnetic force. The OIS-x driving part may comprise a coil and a magnet.

In a first embodiment of the present invention, the OIS-x magnet 510 and the OIS-x coil 520 may move the OIS moving part 300 in a first direction perpendicular to the optical axis direction. At this time, the first direction may be an x-axis direction. Due to the interaction between the OIS-x coil 520 and the OIS-x magnet 510, the OIS carrier 300 can move in an x-axis direction perpendicular to the optical axis direction. The OIS-x magnet 510 and the OIS carrier 300 may integrally move in an x-axis direction.

The lens driving device 10 may comprise an OIS-x magnet 510. The OIS driving part may comprise an OIS-x magnet 510. The OIS-x magnet 510 may be ‘OIS-x magnet’. The OIS-x magnet 510 may be a permanent magnet. The OIS-x magnet 510 may be disposed in the OIS moving part. The OIS-x magnet 510 may be spaced apart from the AF magnet 410. The OIS-x magnet 510 may be disposed in the OIS carrier 300. The OIS-x magnet 510 may be disposed on an outer side surface of the OIS carrier 300. The OIS-x magnet 510 may be fixed to the OIS carrier 300. The OIS-x magnet 510 may be coupled to the OIS carrier 300. The OIS-x magnet 510 may be attached to the OIS carrier 300 with an adhesive. The OIS-x magnet 510 may be disposed inside the cover 120. The OIS-x magnet 510 may interact with the OIS-x coil 520. The OIS-x magnet 510 may interact electromagnetically with the OIS-x coil 520. The OIS-x magnet 510 may be disposed at a position corresponding to the OIS-x coil 520. The OIS-x magnet 510 and the OIS-x coil 520 may face each other. The OIS-x magnet 510 may face the OIS-x coil 520. The OIS-x magnet 510 may be overlapped with the OIS-x coil 520 in a direction perpendicular to the optical axis. The OIS-x magnet 510 may be overlapped with the OIS-x coil 520 in an x-axis direction. The OIS-x magnet 510 can move in an x-axis direction perpendicular to the optical axis.

The second magnet 610 may be a two-pole magnet. The OIS-x magnet 510 may comprise a two-pole magnetized magnet. The OIS-x magnet 510 may comprise an N pole and an S pole.

The lens driving device 10 may comprise an OIS-x coil 520. The OIS driving part may comprise an OIS-x coil 520. The OIS-x coil 520 may interact with the OIS-x magnet 510. The OIS-x coil 520 may move the OIS-x magnet 510 in an x-axis direction perpendicular to the optical axis. The OIS-x coil 520 may move the OIS-x magnet 510 in an x-axis direction through interaction with the OIS-x magnet 510. The OIS-x coil 520 may face the OIS-x magnet 510. The OIS-x coil 520 and the OIS-x magnet 510 may face each other. The OIS-x coil 520 may be disposed at a position corresponding to the OIS-x magnet 510. The OIS-x coil 520 may be overlapped with the OIS-x magnet 510 in a direction perpendicular to the optical axis. The OIS-x coil 520 may be disposed in the inner substrate 720. The OIS-x coil 520 may be disposed in the AF carrier 210.

In a first embodiment of the present invention, the OIS-x coil 520 may move together with the AF moving part 200. The OIS-x coil 520 may move in an optical axis direction together with the AF moving part 200. During the AF driving process, the OIS-x coil 520 may move along with the AF moving part 200 in an optical axis direction. The OIS-x coil 520 may be disposed in the AF moving part 200. The OIS-x coil 520 may be fixed to the AF moving part 200. The OIS-x coil 520 may be coupled to the AF moving part 200.

The lens driving device 10 may comprise an OIS-x sensor 530. The OIS driving part may comprise an OIS-x sensor 530. The OIS-x sensor 530 may be disposed in the inner substrate 720. The OIS-x sensor 530 may comprise a Hall sensor. The OIS-x sensor 530 may detect the OIS-x magnet 510. The OIS-x sensor 530 may detect the magnetic force of the OIS-x magnet 510. The OIS-x sensor 530 may be disposed above the OIS-x magnet 520. The OIS-x sensor 530 may be overlapped with the OIS-x magnet 520 in an optical axis direction. In a modified embodiment, the OIS-x sensor 530 may be disposed inside the OIS-x coil 520. The OIS-x sensor 530 may be overlapped with the OIS-x coil 520 in an optical axis direction. The OIS-x sensor 530 may be overlapped with the OIS-x coil 520 in a direction perpendicular to the optical axis. The OIS-x sensor 530 may face the OIS-x magnet 510. The OIS-x sensor 530 may be disposed at a position corresponding to the OIS-x magnet 510. The OIS-x sensor 530 may detect the movement of the OIS-x magnet 510. The movement amount or position of the OIS-x magnet 510 detected by the OIS-x sensor 530 may be used for feedback of hand shake correction driving in an x-axis direction.

The lens driving device 10 may comprise an OIS-x yoke 540. The OIS-x yoke 540 may be disposed in the OIS-x magnet 510. The OIS-x yoke 540 may be disposed between the OIS-x magnet 510 and the OIS carrier 300. The OIS-x yoke 540 may enhance the interaction force with the OIS-x coil 520 by preventing magnetic flux leakage of the OIS-x magnet 510.

The lens driving device 10 may comprise an OIS-y driving part. The OIS driving part may comprise an OIS-y driving part. The OIS-y driving part may move the OIS carrier 300 in a y-axis direction perpendicular to both the optical axis and the x-axis direction. The OIS-y driving part may move the OIS carrier 300 in a y-axis direction perpendicular to both the optical axis and the X-axis direction through electromagnetic force. The OIS-y driving part may comprise a coil and a magnet.

In a first embodiment of the present invention, the OIS-y magnet 610 and the OIS-y coil 620 may move the OIS moving part in a second direction perpendicular to the optical axis direction and the first direction. At this time, the second direction may be a y-axis direction. Due to the interaction between the OIS-y coil 620 and the OIS-y magnet 610, the OIS carrier 300 can move in a y-axis direction perpendicular to both the optical-axis direction and the x-axis direction. The OIS-y magnet 610 and the OIS carrier 300 may move integrally in a y-axis direction. The OIS-y magnet 610 may be overlapped with the AF magnet 410 in a second direction. The OIS-y magnet 610 may be overlapped with the AF magnet 410 in a y-axis direction.

The lens driving device 10 may comprise an OIS-y magnet 610. The OIS-y driving part may comprise an OIS-y magnet 610. The OIS-y magnet 610 may be ‘OIS-y magnet’. The OIS-y magnet 610 may be a permanent magnet. The OIS-y magnet 520 may be disposed in the OIS moving part. The OIS-y magnet 610 may be spaced apart from the OIS-x magnet 510. The OIS-y magnet 610 may be spaced apart from the AF magnet 410. The OIS-y magnet 610 may be disposed in the OIS carrier 300. The OIS-y magnet 610 may be disposed on an outer side surface of the OIS carrier 300. The OIS-y magnet 610 may be fixed to the OIS carrier 300. The OIS-y magnet 610 may be coupled to the OIS carrier 300. The OIS-y magnet 610 may be attached to the OIS carrier 300 with an adhesive. The OIS-y magnet 610 may be disposed inside the cover 120. The OIS-y magnet 610 may interact with the OIS-y coil 620. The OIS-y magnet 610 may interact electromagnetically with the OIS-y coil 620. The OIS-y magnet 610 may be disposed at a position corresponding to the OIS-y coil 620. The OIS-y magnet 610 and the OIS-y coil 620 may face each other. The OIS-y magnet 610 may face the OIS-y coil 620. The OIS-y magnet 610 may be overlapped with the OIS-y coil 620 in a direction perpendicular to the optical axis. The OIS-y magnet 610 may be overlapped with the OIS-y coil 620 in a y-axis direction. The OIS-y magnet 610 may move in a y-axis direction.

The OIS-y magnet 610 may be a two-pole magnet. The OIS-y magnet 610 may comprise a two-pole magnetized magnet. The OIS-y magnet 610 may comprise an N pole and an S pole.

The lens driving device 10 may comprise an OIS-y coil 620. The OIS-y driving part may comprise an OIS-y coil 620. The OIS-y coil 620 may interact with the OIS-y magnet 610. The OIS-y coil 620 may be disposed at an opposite side of the AF coil 420 with respect to the optical axis. The OIS-y coil 620 may move the OIS-y magnet 610 in a y-axis direction perpendicular to both the optical axis and the x-axis. The OIS-y coil 620 may move the OIS-y magnet 610 in a y-axis direction through interaction with the OIS-y magnet 610. The OIS-y coil 620 may face the OIS-y magnet 610. The OIS-y coil 620 and the OIS-y magnet 610 may face each other. The OIS-y coil 620 may be disposed at a position corresponding to the OIS-y magnet 610. The OIS-y coil 620 may be overlapped with the OIS-y magnet 610 in a direction perpendicular to the optical axis. The OIS-y coil 620 may be disposed in the inner substrate 720. The OIS-y coil 620 may be disposed in the AF carrier 200.

In a first embodiment of the present invention, the OIS-y coil 620 may move together with the AF moving part 200. The OIS-y coil 620 may move in an optical axis direction together with the AF moving part 200. During the AF driving process, the OIS-y coil 620 may move along with the AF moving part 200 in an optical axis direction. The OIS-y coil 620 may be disposed in the AF moving part 200. The OIS-y coil 620 may be fixed to the AF moving part 200. The OIS-y coil 620 may be coupled to the AF moving part 200.

The lens driving device 10 may comprise an OIS-y sensor 630. The OIS-y driving part may comprise an OIS-y sensor 630. The OIS-y sensor 630 may be disposed in the inner substrate 720. The OIS-y sensor 630 may comprise a Hall sensor. The OIS-y sensor 630 may detect the OIS-y magnet 610. The OIS-y sensor 630 may detect the magnetic force of the OIS-y magnet 610. The OIS-y sensor 630 may be disposed above the OIS-y magnet 620. The OIS-y sensor 630 may be overlapped with the OIS-y magnet 620 in an optical axis direction. The OIS-y sensor 630 may be overlapped with the OIS-y magnet 620 in a direction perpendicular to the optical axis. In a modified embodiment, the OIS-y sensor 630 may be disposed inside the OIS-y coil 620. The OIS-y sensor 630 may be overlapped with the OIS-y coil 620 in an optical axis direction. The OIS-y sensor 630 may face the OIS-y magnet 610. The OIS-y sensor 630 may be disposed at a position corresponding to the OIS-y magnet 610. The OIS-y sensor 630 may detect the movement of the OIS-y magnet 610. The movement amount or position of the OIS-y magnet 610 detected by the OIS-y sensor 630 may be used for feedback of hand shake correction driving in a y-axis direction. The lens driving device 10 may comprise an OIS-y yoke 640. The OIS-y yoke 640 may be disposed in the OIS-y magnet 610. The OIS-y yoke 640 may be disposed between the OIS-y magnet 610 and the OIS carrier 300. The OIS-y yoke 640 may prevent magnetic flux leakage of the OIS-y magnet 610 to enhance interaction force with the OIS-y coil 620.

When viewed from above, the AF magnet 410, the AF coil 420, the OIS-y magnet 610, and the OIS-y coil 620 may be sequentially disposed on an imaginary straight line. When viewed from an upper surface, the AF magnet 410, the AF coil 420, the OIS-y magnet 610, and the OIS-y coil 620 may be sequentially disposed on an imaginary straight line. When viewed from above, the AF magnet 410, the AF coil 420, the OIS-y magnet 610, and the OIS-y coil 620 may be disposed in order. When viewed from above, the AF magnet 410, the AF coil 420, the OIS-y magnet 610, and the OIS-y coil 620 may be sequentially disposed in a y-axis direction. When viewed from above, the AF magnet 410, the AF coil 420, the OIS-y magnet 610, and the OIS-y coil 620 may be overlapped in a y-axis direction.

The lens driving device 10 may comprise substrates 710 and 720. The substrates 710 and 720 may comprise a flexible printed circuit board (FPCB). The substrates 710 and 720 may be electrically connected to the coils 420, 520, and 620. The substrates 710 and 720 may be electrically connected to the sensors 430, 530, and 630.

The lens driving device 10 may comprise an outer substrate 710. An outer substrate 710 may be disposed on the base 110. The outer substrate 710 may be electrically connected to the coils 420, 520, and 620. The outer substrate 710 may be electrically connected to the sensors 430, 530, and 630. The outer substrate 710 may connect the AF carrier 210 and the base 110. The outer substrate 710 may elastically connect the AF carrier 210 and the base 110. The outer substrate 710 may connect the fixed part 100 and the inner substrate 720. The outer substrate 710 may movably support the AF carrier 210 against the base 110. The outer substrate 710 may guide the AF carrier 210 to move in an optical axis direction against the base 110. The outer substrate 710 may comprise a flexible substrate. The outer substrate 710 may comprise a flexible printed circuit board (FPCB). The outer substrate 710 may comprise an elastic portion. The outer substrate 710 may comprise an elastic member. The outer substrate 710 may comprise an outer side portion 711 being disposed in the fixed part 100 and a connecting portion 712 being extended from the outer side portion 711 and coupled to the inner substrate 720.

The outer substrate 710 may comprise an outer side portion 711. The outer side portion 711 may be disposed on the base 110. The outer side portion 711 may be formed to surround the side surface of the base 110. The outer side portion 711 may be disposed on three side surfaces of the base 110. The outer side portion 711 may comprise two terminal units. The two terminal units may be disposed opposite to each other with respect to the optical axis. The terminal unit may comprise a terminal 712-1.

The outer substrate 710 may comprise a terminal 711-1. The outer side portion 711 of the outer substrate 710 may comprise a terminal 711-1. The terminal 711-1 may be electrically connected to the terminal 712-1. The terminal 711-1 may be disposed in a lower end portion of the base 110. The terminal 711-1 may be coupled to the printed circuit board 50. The terminal 711-1 may be coupled to a terminal of the printed circuit board 50 through soldering. The terminal 711-1 may be coupled to a terminal of the printed circuit board 50 through a conductive member. The terminal 711-1 may be connected to a terminal of the printed circuit board 50. The terminal 711-1 may be electrically connected to a terminal of the printed circuit board 50.

The outer substrate 710 may comprise a connecting portion 712. The connecting portion 712 may be an ‘extension part’. The connecting portion 712 may be a ‘leg part’. The connecting portion 712 may be extended from the outer side portion 711. At least a portion of the connecting portion 712 may move along with the AF carrier 210. The extension part may be extended from the outer side portion 711. At least a portion of the extension part may move together with the AF carrier 210. At least a portion of the connecting portion 712 may be disposed perpendicular to the optical axis direction. The connecting portion 712 of the outer substrate 710 may be coupled with the inner substrate 720 so that the inner substrate 720 can move in an optical axis direction. At least a portion of the connecting portion 712 may be disposed parallel to an optical axis direction.

The connecting portion 712 may comprise a plurality of connecting portions. The connecting portion 712 may comprise a first connecting portion and a second connecting portion. The second connecting portion may be disposed below the first connecting portion.

The outer substrate 710 may comprise a terminal 712-1. The connecting portion 712 of the outer substrate 710 may comprise a terminal 712-1. The terminal 712-1 may be coupled with the terminal 721-1 of the inner substrate 720. The terminal 712-1 of the outer substrate 710 may be coupled to the terminal 721-1 of the inner substrate 720 through soldering. The terminal 712-1 of the outer substrate 710 may be coupled to the terminal 721-1 of the inner substrate 720 through a conductive member. The terminal 712-1 of the outer substrate 710 may be connected to the terminal 721-1 of the inner substrate 720. The terminal 712-1 of the outer substrate 710 may be electrically connected to the terminal 721-1 of the inner substrate 720.

Hereinafter, any one of the ‘terminal 711-1’ and the ‘terminal 712-1’ of the outer substrate 710 may be referred to as a ‘first terminal’, and the other may be referred to as a ‘second terminal’.

The lens driving device 10 may comprise an inner substrate 720. The inner substrate 720 may be electrically connected to the coils 420, 520, and 620. The inner substrate 720 may be electrically connected to the sensors 430, 530, and 630. The inner substrate 720 may be disposed in the AF moving part 200. The inner substrate 720 may be disposed in the AF carrier 210. The inner substrate 720 may be fixed to the AF carrier 210. The inner substrate 720 may be coupled to the AF carrier 210. The inner substrate 720 may be attached to the AF carrier 210 with an adhesive. The inner substrate 720 may comprise a flexible substrate. The inner substrate 720 may comprise a flexible printed circuit board (FPCB). The inner substrate 720 may comprise an elastic portion. The inner substrate 720 may comprise an elastic member.

The inner substrate 720 may comprise a side plate portion 721. The side plate portion 721 may be disposed on a side surface of the AF carrier 210. The side plate portion 721 may be disposed on an outer side surface of the AF carrier 210. In another embodiment, the side plate portion 721 may be disposed on an inner surface of the AF carrier 210. The side plate portion 721 of the inner substrate 720 may comprise a plurality of portions. The side plate portion 721 may comprise first to fourth portions.

The inner substrate 720 may comprise a first portion. The first portion may be disposed in the AF carrier 210. The AF coil 420 may be disposed in a first portion of the inner substrate 720. The AF sensor 430 may be disposed in a first portion of the inner substrate 720. The AF yoke 440 may be disposed on a first portion of the inner substrate 720.

The inner substrate 720 may comprise a second portion. The second portion can be placed at an opposite side of the first portion. The second portion may be disposed in the AF carrier 200. The second portion may be disposed on a second side surface of the AF carrier 200. The OIS-y coil 620 may be disposed in a second portion of the inner substrate 720. The OIS-y sensor 630 may be disposed in a second portion of the inner substrate 720. More specifically, the OIS-y sensor 630 may be disposed in the upper plate portion 722 which is bent and disposed above a second portion of the inner substrate 720. The OIS-y sensor 630 may be disposed on a lower surface of the upper plate portion 722.

The inner substrate 720 may comprise a third portion. A third portion may be disposed in the AF carrier 200. The third portion may be disposed on a third side surface of the AF carrier 200. The OIS-x coil 520 may be disposed in a third portion of the inner substrate 720. The OIS-x sensor 530 may be disposed in a third portion of the inner substrate 720. In more detail, the OIS-x sensor 530 may be disposed in the upper plate portion 722 bent from an upper side of the third portion of the inner substrate 720. The OIS-x sensor 530 may be disposed on a lower surface of the upper plate portion 722.

The inner substrate 720 may comprise a fourth portion. The fourth portion may be disposed at an opposite side of the third portion. The fourth portion may be disposed in the AF carrier 200. The fourth portion may be disposed on a fourth side surface of the AF carrier 200.

The inner substrate 720 may comprise a terminal 721-1. The terminal 721-1 may be disposed in the fourth portion of the inner substrate 720. The terminal 721-1 may be electrically connected to the coils 420, 520, and 620. The terminal 721-1 may be electrically connected to the sensors 430, 530, and 630.

The lens driving device 10 may comprise a guide member. The guide member may comprise a ball. The guide member may comprise a pin. The guide member may comprise a cylindrical member. The guide member may guide the movement of the moving part against the fixed part 100 in a specific direction.

The lens driving device 10 may comprise an AF guide ball 810. The AF guide ball 810 may guide the movement of the AF moving part 200 against the fixed part 100 in an optical axis direction. The AF guide ball 810 may guide the movement of the AF carrier 210 against the base 110 in an optical axis direction. The AF guide ball 810 may be disposed between the fixed part 100 and the AF moving part 200. The AF guide ball 810 may be disposed between the base 110 and the AF carrier 210. The AF guide ball 810 may be disposed between the side surface of the AF carrier 210 and the base 110. The AF guide ball 810 may be disposed between the pillars of the cover 120 and the base 110. The AF guide ball 810 may be disposed between the base 110 and the AF carrier 210 in a y-axis direction. The AF guide ball 810 may be disposed in the groove 113 of the base 110. The AF guide ball 810 may be disposed in the groove 224 of the AF carrier 210. The AF guide ball 810 may comprise a first ball in contact with the base 110 and the AF carrier 210 at four points, and a second ball in contact with the base 110 and the AF carrier 210 at three points. The AF guide ball 810 may have a spherical shape. The AF guide ball 810 may be formed of metal. Grease may be applied to the surface of the AF guide ball 810.

The AF guide ball 810 may comprise a plurality of balls. The AF guide ball 810 may comprise eight balls. The four AF guide balls 810 is disposed at one side of the AF magnet 410 and the remaining four AF guide balls 810 may be disposed at the other side of the AF magnet 410.

The lens driving device 10 may comprise an OIS guide ball 820. The OIS guide ball 820 may guide the movement of the OIS carrier 300 against the AF carrier 210 in a direction perpendicular to the optical axis. The OIS guide ball 820 may be disposed between the AF moving part 200 and the OIS moving part. The OIS guide ball 820 may be disposed between the AF carrier 210 and the OIS carrier 300. The OIS guide ball 820 may be disposed between the AF carrier 210 and the OIS carrier 300 in an optical axis direction.

The OIS guide ball 820 may be disposed between the pre-pressurizing member 230 of the AF carrier 210 and the OIS carrier 300. The OIS guide ball 820 may be pressurized between the AF carrier 210 and the OIS carrier 300 by the pressurizing force of the elastic members 830, 840, and 850. The pre-pressurizing member 230 may pressurize the OIS guide ball 820 downward while being coupled to the holder member 220. The pre-pressurizing member 230 may pressurize the OIS guide ball 820 in a direction of the OIS carrier 300 while being coupled to the holder member 220. At this time, the OIS carrier 300 may pressurize the OIS guide ball 820 in a direction of the pre-pressurizing member 230 by the restoring force of the elastic members 830, 840, and 850. Accordingly, the OIS guide ball 820 may be pressurized between the pre-pressurizing member 230 and the OIS carrier 300.

The OIS guide ball 820 may guide the movement of the OIS moving part 300 in an x-axis direction and a y-axis direction. The OIS guide ball 820 may guide the OIS carrier 300 to move in an x-axis direction and a y-axis direction perpendicular to an optical axis direction against the AF carrier 210. That is, the OIS guide ball 820 may guide the OIS carrier 300 to move in an x-axis direction and a y-axis direction. In other words, the OIS guide ball 820 may guide the movement in both the x-axis direction and the y-axis direction. For reference, compared to the comparative example in which the ball for guiding the x-axis direction and the ball for guiding the y-axis direction are separately provided, the size of the lens driving device 10 can be minimized in a first embodiment of the present invention in which a structure for guiding the x-axis direction and a structure for guiding the y-axis direction are integrally provided. In particular, the height of the lens driving device 10 in an optical axis direction can be reduced. Through this, the height being protruded from the smartphone, that is, the shoulder height can be minimized. The OIS guide ball 820 may comprise a plurality of guide members. The OIS guide ball 820 may comprise four guide members.

As a modified embodiment, the OIS guide ball 820 may separately comprise a guide ball for guiding the driving in an x-axis direction and a guide ball for guiding the driving in a y-axis direction.

The lens driving device 10 may comprise an elastic member. The elastic member may be formed to pressurize the OIS guide ball 820. The elastic member may be formed to guide both an OIS-x-axis driving and an OIS-y-axis driving only with the OIS guide ball 820. The elastic member may comprise a leaf spring. The elastic member may comprise a wire. The elastic member may have elasticity. The elastic member may be formed of metal.

The first support member may be disposed between the fixed part 100 and the AF moving part 200. The first support member may guide the AF moving part 200 to move in an optical axis direction. The second support member may be disposed between the AF moving part 200 and the OIS moving part 300. The second support member may guide the OIS moving part 300 to move in a direction perpendicular to the optical axis direction. One side of the third support member may be coupled to the AF moving part 200 and the other side may be coupled to the OIS moving part 300.

The AF moving part 200 may comprise a first elastic member. The OIS moving part 300 may comprise a second elastic member. The third support member may couple the first elastic member and the second elastic member. The third support member may comprise a wire 850.

The lens driving device 10 may comprise an upper elastic member 830. The upper elastic member 830 may be an ‘upper spring’. The upper elastic member 830 may be a leaf spring. The upper elastic member 830 may have elasticity. The upper elastic member 830 may be disposed in the OIS moving part. The upper elastic member 830 may be disposed on an upper surface of the OIS moving part. The upper elastic member 830 may be disposed on an upper surface of the OIS carrier 300. The upper elastic member 830 may be disposed in the OIS carrier 300. The upper elastic member 830 may be disposed above the OIS carrier 300. The upper elastic member 830 may be disposed in the OIS carrier 300. The upper elastic member 830 may be disposed perpendicular to the optical axis.

The upper elastic member 830 may comprise an inner side portion 831. The inner side portion 831 may be coupled with the OIS moving part.

The upper elastic member 830 may comprise an outer side portion 832. The outer side portion 832 may be coupled with the wire 850.

The upper elastic member 830 may comprise a connecting portion 833. The connecting portion 833 may connect the inner side portion 831 and the outer side portion 832. The connecting portion 833 may elastically connect the inner side portion 831 and the outer side portion 832. The connecting portion 833 may comprise elasticity. The connecting portion 833 may be an elastic part.

The inner side portion 831 of the upper elastic member 830 may be disposed lower than an outer side portion 832. As illustrated in FIG. 29, the inner side portion 831 of the upper elastic member 830 may be disposed lower than the outer side portion 832 by a first distance (see a in FIG. 29). The reason why the inner side portion 831 of the upper elastic member 830 is lower than the outer side portion 832 may be due to the pressurizing force of the pre-pressurizing member 230. Through this structure, the OIS guide ball 820 can be maintained as it is in contact with the pre-pressurizing member 230 of the AF carrier 210 and the OIS carrier 300.

The lens driving device 10 may comprise a lower elastic member 840. The lower elastic member 840 may be a ‘housing lower surface terminal’ or a ‘housing lower surface plate’. The lower elastic member 840 may be a leaf spring. The lower elastic member 840 may have elasticity. The lower elastic member 840 may be disposed in the AF moving part 200. The lower elastic member 840 may be disposed on a lower surface of the AF moving part 200. The lower elastic member 840 may be disposed on a lower surface of the AF carrier 210. The lower elastic member 840 may be disposed on the AF carrier 210. The lower elastic member 840 may be disposed below the AF carrier 210. The lower elastic member 840 may be disposed below the AF carrier 210. The lower elastic member 840 may be disposed perpendicular to the optical axis.

The lower elastic member 840 may comprise an outer side portion 841. The outer side portion 841 may be coupled with the AF moving part 200.

The lower elastic member 840 may comprise an inner side portion 842. The inner side portion 842 may be coupled to the wire 850.

The lower elastic member 840 may comprise a connecting portion 843. The connecting portion 843 may connect the outer side portion 841 and the inner side portion 842. The connecting portion 843 may elastically connect the outer side portion 841 and the inner side portion 842. The connecting portion 843 may comprise elasticity. The connecting portion 843 may be an elastic part.

The lens driving device 10 may comprise a wire 850. The wire 850 may be a ‘side elastic member’. The wire 850 may be a wire. The wire 850 may be a wire spring. The wire 850 may be a suspension wire. The wire 850 may have elasticity. The wire 850 may connect the upper elastic member 830 and the lower elastic member 840. The wire 850 may elastically connect the upper elastic member 830 and the lower elastic member 840. The wire 850 may be disposed parallel to an optical axis. The wire 850 may be disposed in a direction of the optical axis.

Hereinafter, auto focus (AF) driving of the lens driving device according to a first embodiment of the present invention will be described with reference to the drawings.

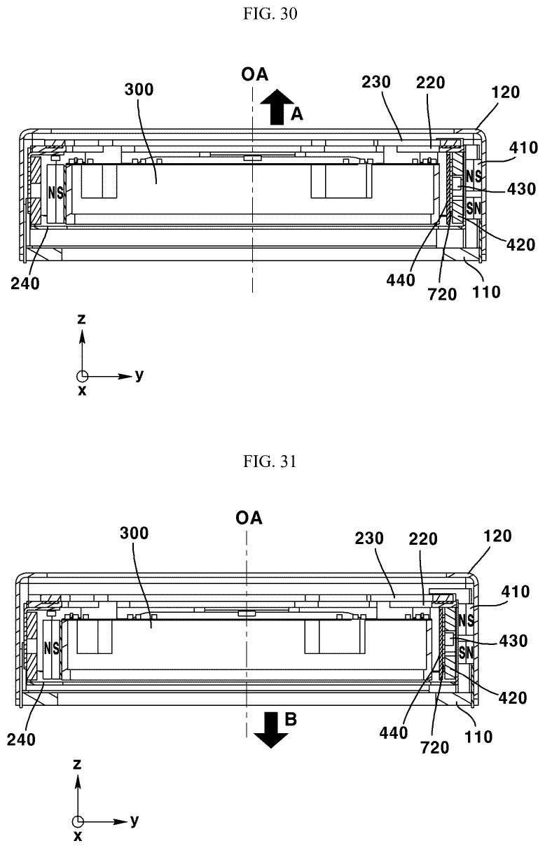

FIGS. 29 to 31 are views for explaining autofocus driving of a lens driving device according to a first embodiment of the present invention. FIG. 29 is a cross-sectional view of a moving part in an initial state in which no current is applied to an AF coil. FIG. 30 is a cross-sectional view illustrating a state in which a moving part moves upward in an optical axis direction when a forward current is applied to an AF coil. FIG. 31 is a cross-sectional view illustrating a moving part moving downward in an optical axis direction when a reverse current is applied to an AF coil.

As illustrated in FIG. 29, the moving part may be disposed at a position spaced apart from both the upper plate 121 and the base 110 of the cover 120 at an initial position where no current is applied to the AF coil 420. At this time, the moving part may be the AF moving part 200. In addition, the moving part may comprise the AF moving part 200 and the OIS moving part.

When a forward current is applied to the AF coil 420, the AF coil 420 may move upward in an optical axis direction due to electromagnetic interaction between the AF coil 420 and the AF magnet 410 (see A in FIG. 30). At this time, the AF carrier 210 together with the AF coil 420 may move upward in an optical axis direction. Furthermore, the OIS carrier 310 and the lens together with the AF carrier 210 may move upward in an optical axis direction. Accordingly, the distance between the lens and the image sensor is changed so that the focus of an image formed on the image sensor through the lens can be adjusted.

When a reverse current is applied to the AF coil 420, the AF coil 420 may move downward in an optical axis direction due to electromagnetic interaction between the AF coil 420 and the AF magnet 410 (see B in FIG. 31). At this time, the AF carrier 210 together with the AF coil 420 may move downward in an optical axis direction. Furthermore, the OIS carrier 310 and the lens together with the AF carrier 210 may move downward in an optical axis direction. Accordingly, the distance between the lens and the image sensor is changed so that the focus of an image formed on the image sensor through the lens can be adjusted.

Meanwhile, during the movement of the AF coil 420, the AF sensor 430 moves together with the AF coil 420 and detects the strength of the magnetic field of the AF magnet 410 to detect the amount or position of the lens in an optical axis direction. The movement amount or position of the lens in an optical axis direction detected by the AF sensor 430 may be used for autofocus feedback control.

Hereinafter, optical image stabilization (OIS) operation of the lens driving device according to a first embodiment of the present invention will be described with reference to drawings.

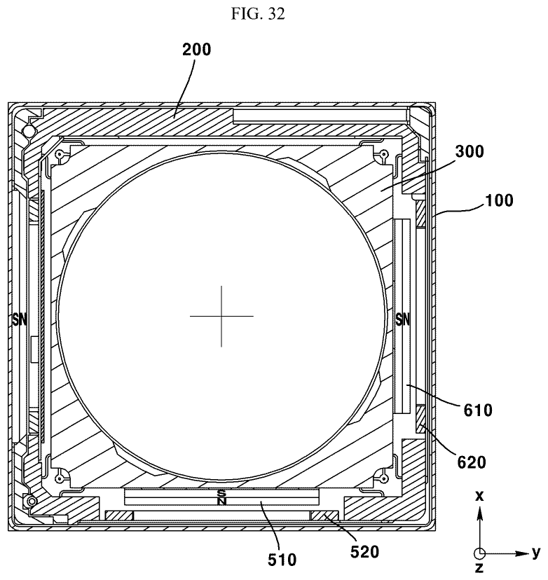

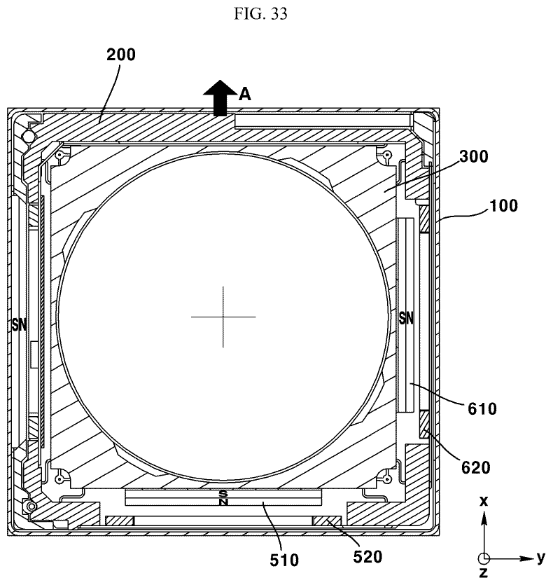

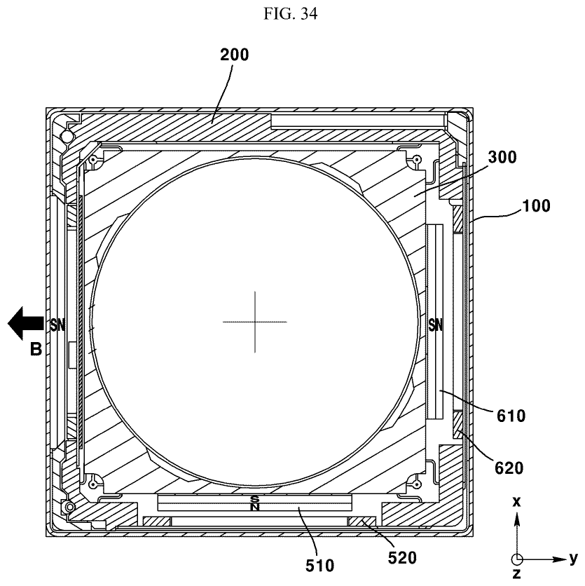

FIGS. 32 to 34 are views for explaining hand shake compensation driving of a lens driving device according to a first embodiment of the present invention. FIG. 32 is a cross-sectional view illustrating the appearance of an OIS moving part in an initial state in which no current is applied to an OIS-x coil and an OIS-y coil. FIG. 33 is a cross-sectional view illustrating a state in which an OIS moving part moves in an x-axis direction perpendicular to an optical axis as current is applied to an OIS-x coil. FIG. 34 is a cross-sectional view illustrating a state in which a current is applied to an OIS-y coil so that an OIS moving part moves in a y-axis direction perpendicular to both the optical axis and the x-axis.

As illustrated in FIG. 32, the moving part may be disposed at an initial position in a state in which no current is applied to the OIS-x coil 520 and the OIS-y coil 620. At this time, the moving part may be the OIS moving part.

When a current is applied to the OIS-x coil 520, the OIS-x magnet 510 may move in an x-axis direction perpendicular to the optical axis due to electromagnetic interaction between the OIS-x coil 520 and the OIS-x magnet 510 (see A in FIG. 33). At this time, the OIS carrier 300 together with the OIS-x magnet 510 may move in an x-axis direction. Furthermore, the lens may move in an x-axis direction together with the OIS carrier 300. More specifically, when a forward current is applied to the OIS-x coil 520, the OIS-x magnet 510, the OIS carrier 300, and the lens may move in one direction on the x-axis. In addition, when a reverse current is applied to the OIS-x coil 520, the OIS-x magnet 510, the OIS carrier 300, and the lens may move in another direction on the x-axis.

When current is applied to the OIS-y coil 620, due to the electromagnetic interaction between the OIS-y coil 620 and the OIS-y magnet 610, the OIS-y magnet 610 can move in a y-axis direction perpendicular to the optical axis (see B in FIG. 34). At this time, the OIS carrier 300 together with the OIS-y magnet 610 may move in a y-axis direction. Furthermore, the lens may move in a y-axis direction together with the OIS carrier 300. More specifically, when a forward current is applied to the OIS-y coil 620, the OIS-y magnet 610, the OIS carrier 300, and the lens may move in one direction on the y-axis. In addition, when a reverse current is applied to the OIS-y coil 620, the OIS-y magnet 610, the OIS carrier 300, and the lens may move in another direction on the y-axis.

Meanwhile, the OIS-x sensor 530 may detect the amount or position of the OIS-x magnet 510 by detecting the strength of the magnetic field of the OIS-x magnet 510. The movement amount or position detected by the OIS-x sensor 530 may be used for feedback control for hand shake compensation in an x-axis direction. The OIS-y sensor 630 may detect the movement amount or position of the OIS-y magnet 610 by detecting the strength of the magnetic field of the OIS-y magnet 610. The movement amount or position detected by the OIS-y sensor 630 may be used for hand shake compensation feedback control in a y-axis direction.

Hereinafter, a camera device according to a first embodiment of the present invention will be described with reference to the drawings.

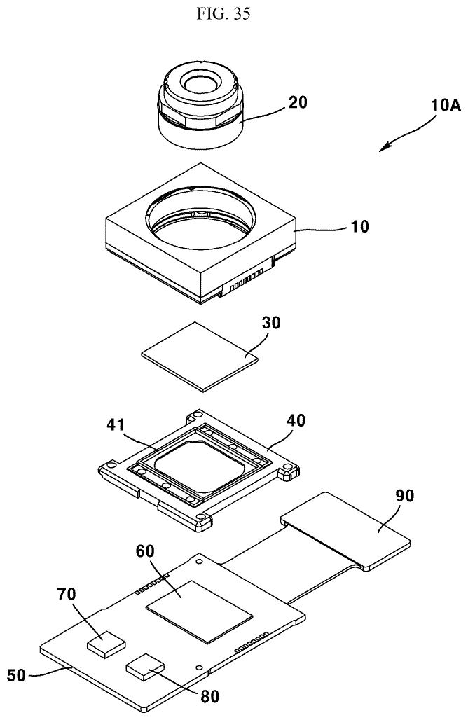

FIG. 35 is an exploded perspective view of a camera device according to a first embodiment of the present invention.

The camera device 10A may comprise a camera module.

The camera device 10A may comprise a lens module 20. The lens module 20 may comprise at least one lens. The lens may be disposed at a position corresponding to the image sensor 60. The lens module 20 may comprise a lens and a barrel. The lens module 20 may be coupled to the OIS carrier 310 of the lens driving device 10. The lens module 20 may be coupled to the OIS carrier 310 by screw-coupling and/or adhesive. The lens module 20 may move integrally with the OIS carrier 310.

The camera device 10A may comprise a filter 30. The filter 30 may serve to block light of a specific frequency band from entering the image sensor 60 from light passing through the lens module 20. The filter 30 may be disposed parallel to an x-y plane. The filter 30 may be disposed between the lens module 20 and the image sensor 60. The filter 30 may be disposed in the sensor base 40. In a modified embodiment, the filter 30 may be disposed in base 110. The filter 30 may comprise an infrared filter. The infrared filter may block light of an infrared region from being incident on the image sensor 60.

The camera device 10A may comprise a sensor base 40. The sensor base 40 may be disposed between the lens driving device 10 and the printed circuit board 50. The sensor base 40 may comprise a protruded part 41 in which the filter 30 is disposed. An opening may be formed in a portion of the sensor base 40 where the filter 30 is disposed so that light passing through the filter 30 may be incident to the image sensor 60. The adhesive member may couple or attach the base 110 of the lens driving device 10 to the sensor base 40. The adhesive member may additionally serve to prevent foreign substances from entering the lens driving device 10. The adhesive member may comprise any one or more of an epoxy, a thermosetting adhesive, and an ultraviolet curable adhesive.

The camera device 10A may comprise a printed circuit board (PCB) 50. The printed circuit board 50 may be a substrate or a circuit board. The lens driving device 10 may be disposed on the printed circuit board 50. A sensor base 40 may be disposed between the printed circuit board 50 and the lens driving device 10. The printed circuit board 50 may be electrically connected to the lens driving device 10. An image sensor 60 may be disposed on the printed circuit board 50. The printed circuit board 50 may comprise various circuits, elements, and control units to convert an image formed by the image sensor 60 into an electrical signal and transmit the converted electrical signal to an external device.

The camera device 10A may comprise an image sensor 60. The image sensor 60 may be a component in which the light passing through the lens and the filter 30 is incident to form an image. The image sensor 60 may be mounted on the printed circuit board 50. The image sensor 60 may be electrically connected to the printed circuit board 50. For an example, the image sensor 60 may be coupled to the printed circuit board 50 by a surface mounting technology (SMT). As another example, the image sensor 60 may be coupled to the printed circuit board 50 using a flip chip technology. The image sensor 60 may be disposed such that an optical axis coincides with a lens. That is, the optical axis of the image sensor 60 and the optical axis of the lens may be aligned. The image sensor 60 may convert light being irradiated onto an effective image region of the image sensor 60 into an electrical signal. The image sensor 60 may be any one among a charge coupled device (CCD), a metal oxide semi-conductor (MOS), a CPD, and a CID.

The camera device 10A may comprise a motion sensor 70. The motion sensor 70 may be mounted on a printed circuit board 50. The motion sensor 70 may be electrically connected to a control unit 80 through a circuit pattern provided on the printed circuit board 50. The motion sensor 70 may output rotational angular velocity information due to the movement of the camera module.

The motion sensor 70 may comprise a 2-axis or 3-axis gyro sensor or an angular velocity sensor. The camera device 10A may comprise a control unit 80. The control unit 80 may be disposed in the printed circuit board 50. The control unit 80 may be electrically connected to the coil 130 of the lens driving device 10. The control unit 80 may individually control the direction, intensity, and amplitude of current supplied to the coil 130. The control unit 80 may perform an auto focus function by controlling the lens driving device 10. The control unit 80 may be electrically connected to the Hall sensor 140. The control unit 80 may detect the position of the mover 200 through the Hall sensor 140 and perform autofocus feedback control for the lens driving device 10.

The camera device 10A may comprise a connector 90. The connector 90 may be electrically connected to the printed circuit board 50. The connector 90 may comprise a port for electrical connection with an external device.

Hereinafter, an optical apparatus according to a first embodiment of the present invention will be described with reference to drawings.

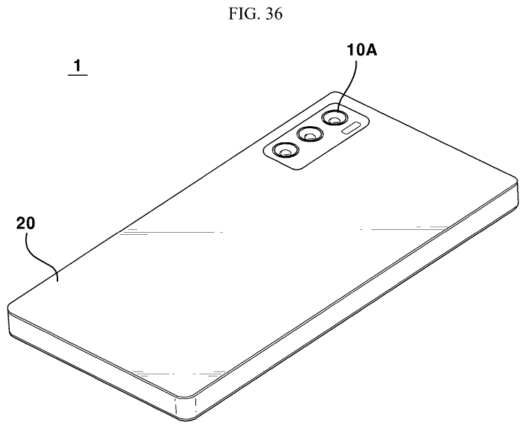

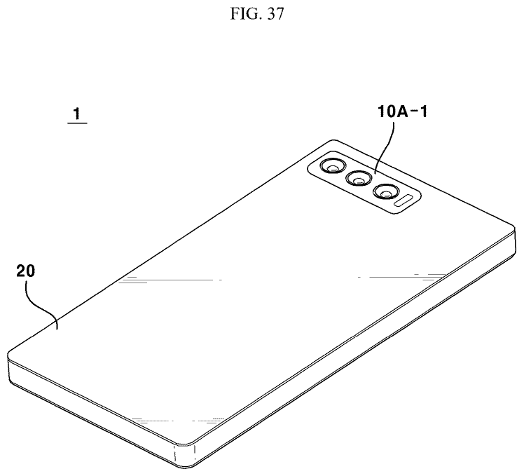

FIG. 36 is a perspective view of an optical apparatus according to a first embodiment of the present invention; and FIG. 37 is a perspective view of an optical apparatus according to a modified embodiment.

The optical apparatus 1 is a mobile phone, mobile phone, portable terminal, mobile terminal, smart phone, smart pad, portable smart device, digital camera, laptop computer, digital broadcasting terminal, personal digital assistants (PDAs), portable multimedia player (PMP), and navigation. The optical apparatus 1 may comprise any device for photographing images or photos. The optical apparatus 1 may comprise a main body 20. The optical apparatus 1 may comprise a camera device 10A. The camera device 10A may be disposed on the main body 20. The camera device 10A may photograph a subject. The optical apparatus 1 may comprise a display. The display may be disposed on the main body 20. The display may output at least one of a video and an image photographed by the camera device 10A. The display may be disposed on a first surface of the main body 20. The camera device 10A may be disposed on at least one of a first surface of the main body 20 and a second surface opposite to the first surface. As illustrated in FIG. 36, in the camera device 10A, triple cameras may be disposed in a vertical direction. As illustrated in FIG. 37, in the camera device 10A-1, triple cameras may be disposed in a horizontal direction.

Hereinafter, the component of a lens driving device according to a second embodiment of the present invention will be described with reference to the drawings.

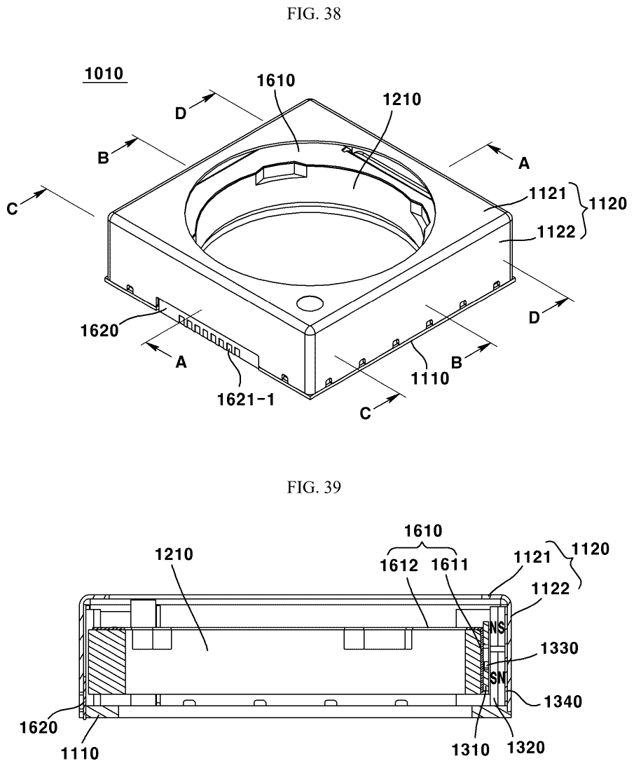

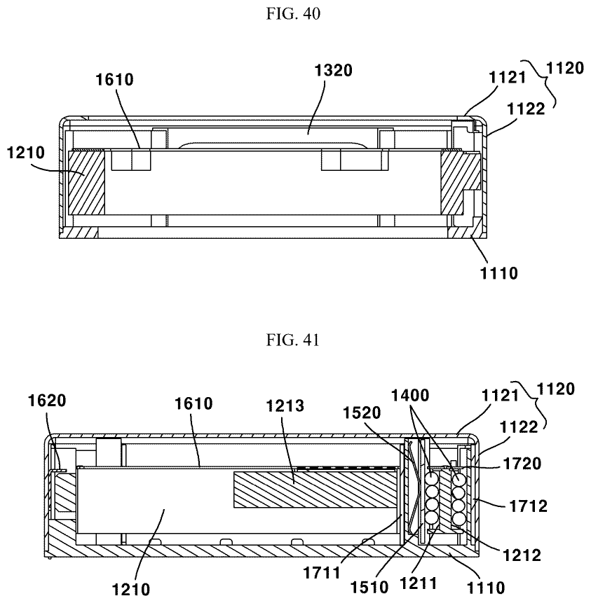

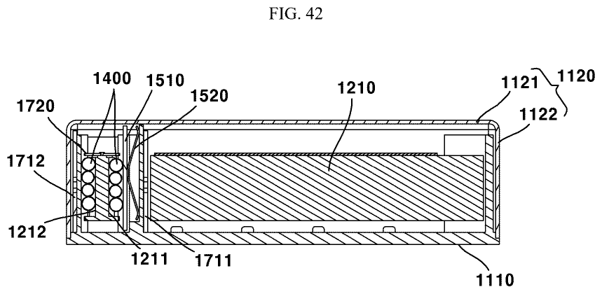

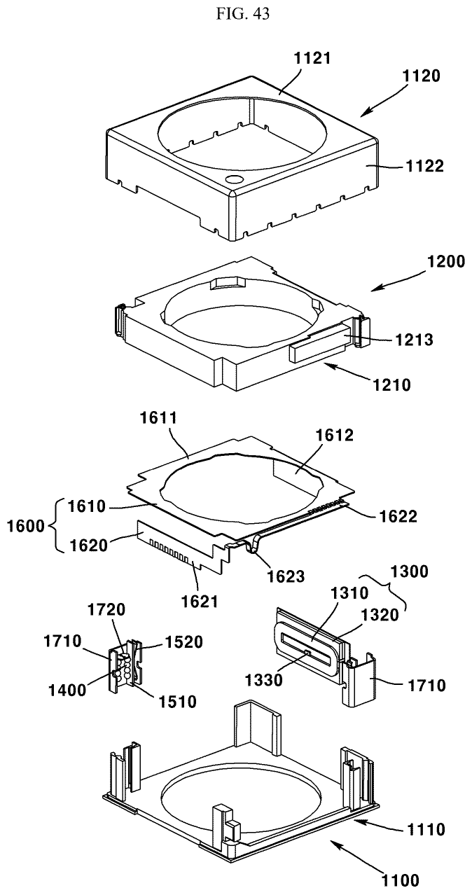

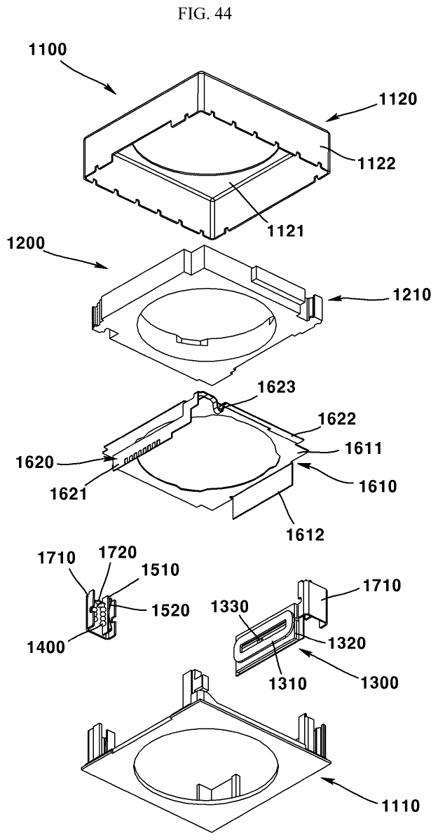

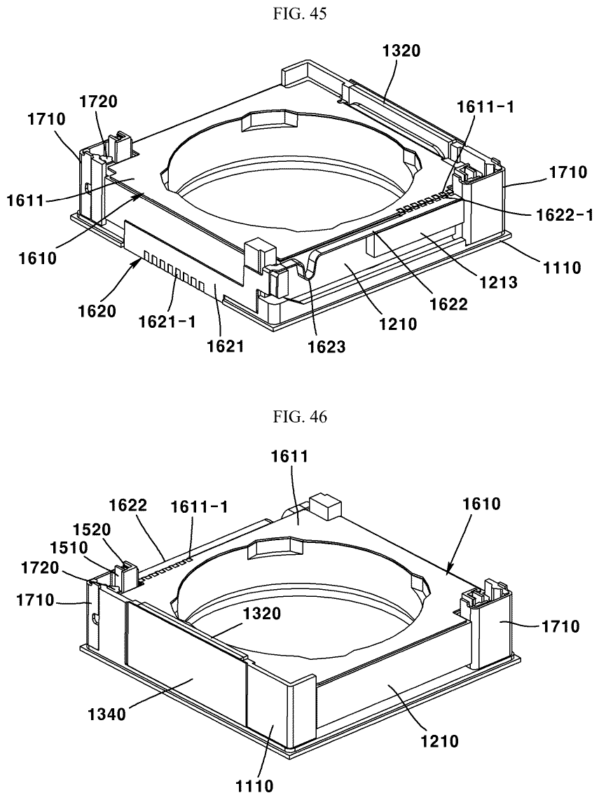

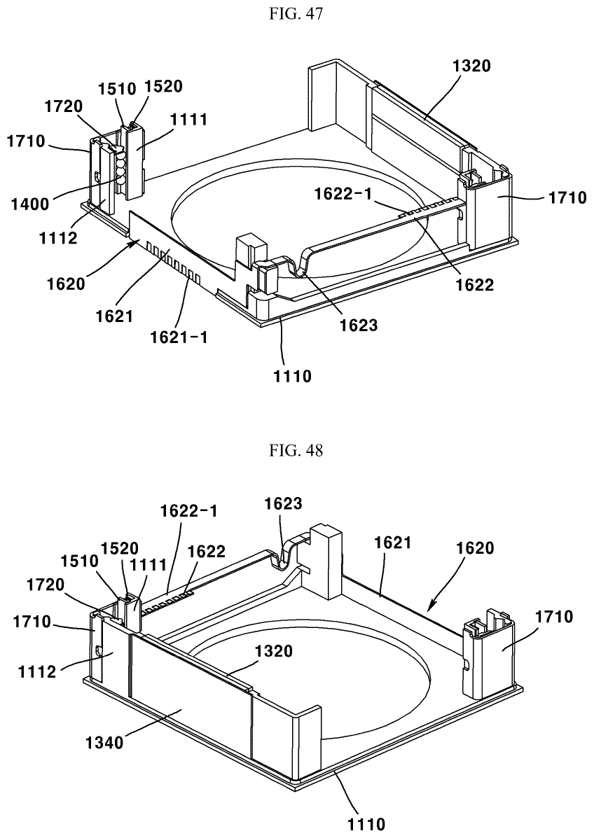

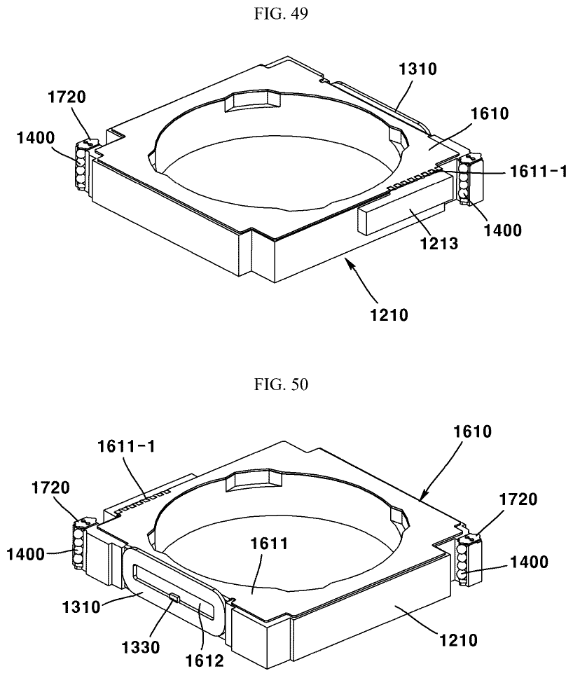

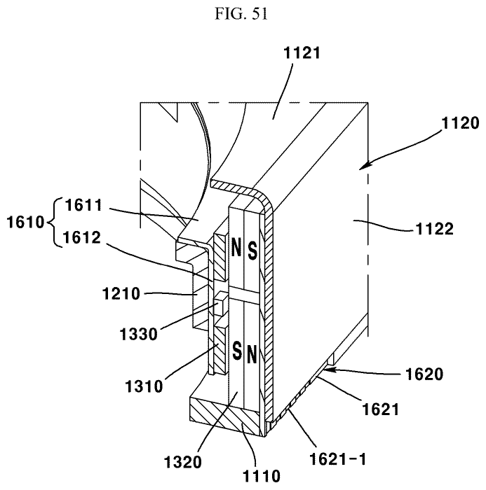

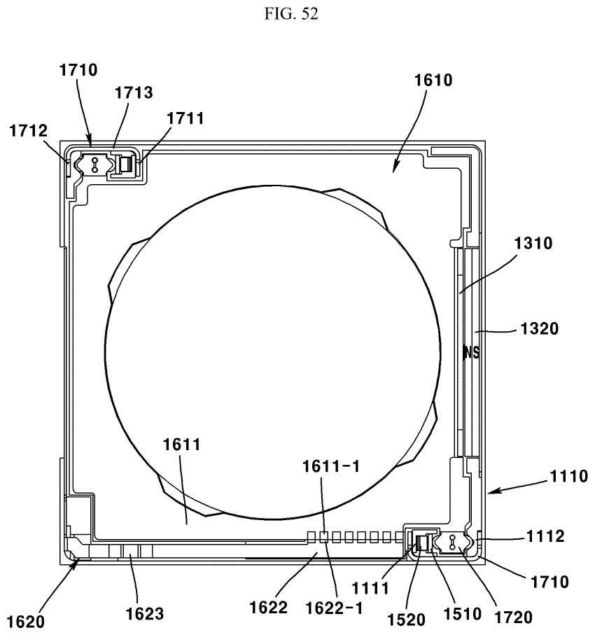

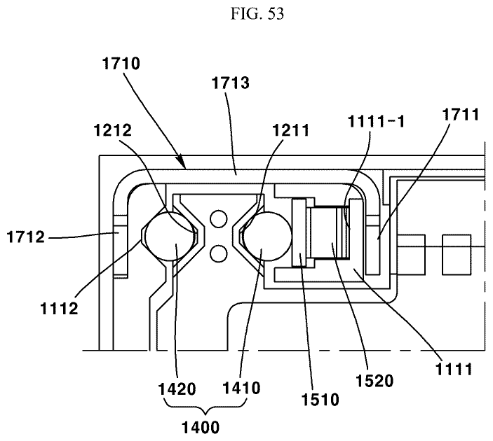

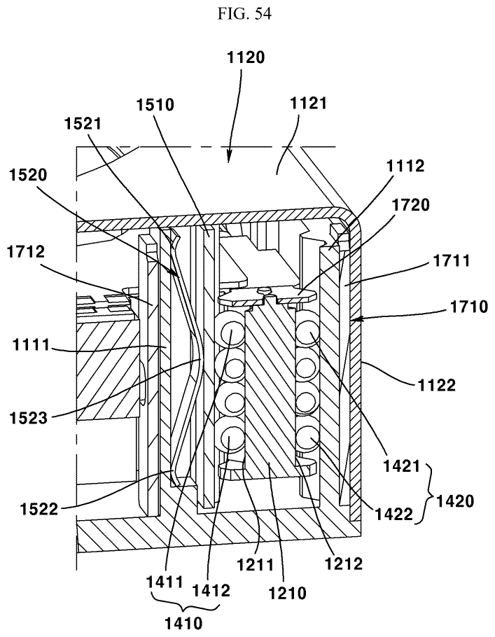

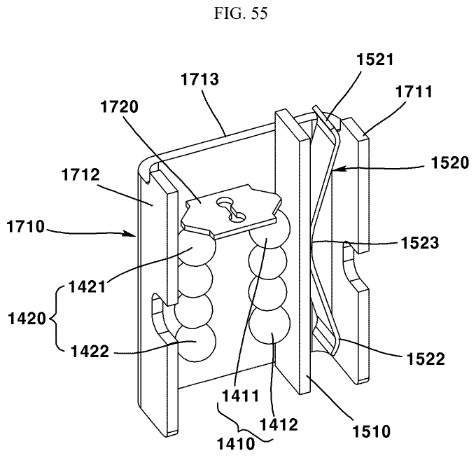

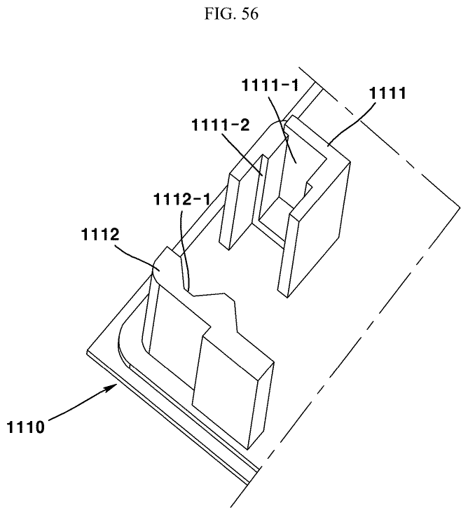

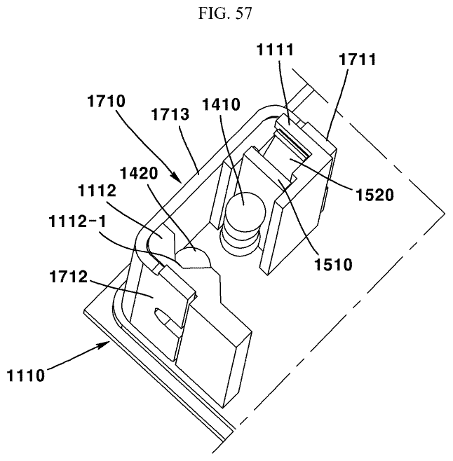

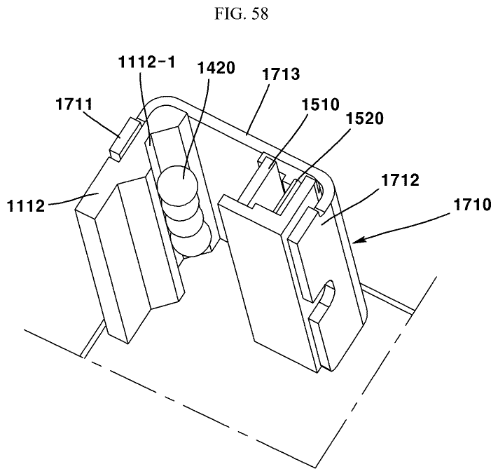

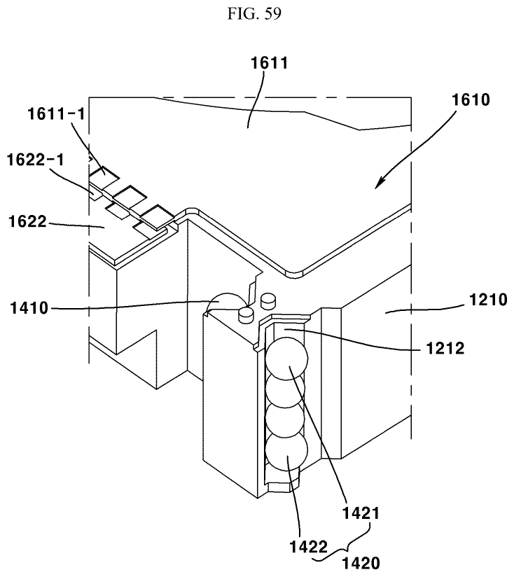

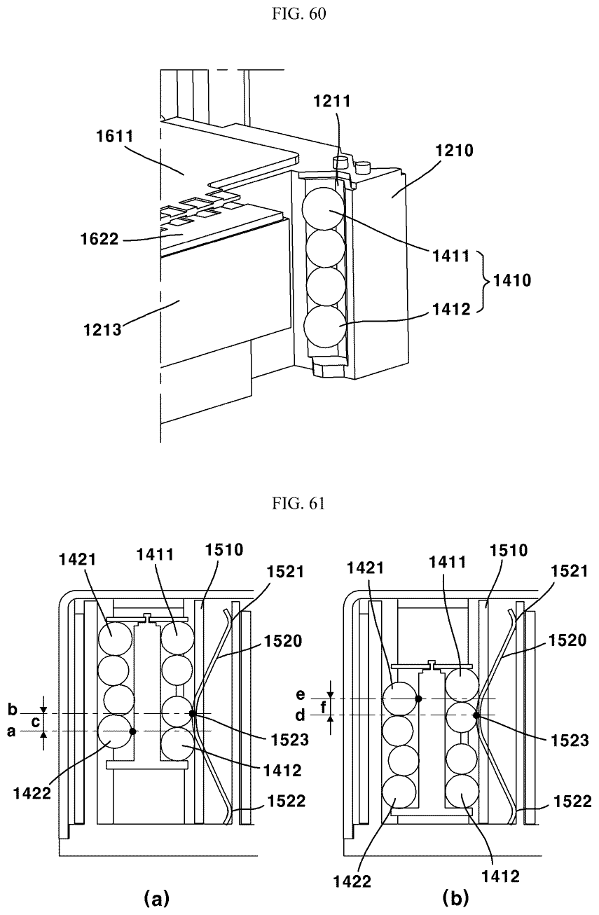

FIG. 38 is a perspective view of a lens driving device according to a second embodiment of the present invention; FIG. 39 is a sectional view seen from A-A in FIG. 38; FIG. 40 is a sectional view seen from B-B in FIG. 38; FIG. 41 is a sectional view seen from C-C in FIG. 38; FIG. 42 is a cross-sectional view seen from D-D in FIG. 38; FIG. 43 is an exploded perspective view of a lens driving device according to a second embodiment of the present invention; FIG. 44 is an exploded perspective view of FIG. 43 viewed from another direction; FIG. 45 is a perspective view of a state in which a cover is omitted from a lens driving device according to a second embodiment of the present invention; FIG. 46 is a perspective view of FIG. 45 viewed from another direction; FIG. 47 is a perspective view illustrating a fixed part and related components of a lens driving device according to a second embodiment of the present invention; FIG. 48 is a perspective view of FIG. 47 viewed from another direction; FIG. 49 is a perspective view illustrating a moving part and related components of a lens driving device according to a second embodiment of the present invention; FIG. 50 is a perspective view of FIG. 49 viewed from another direction; FIG. 51 is a cross-sectional perspective view illustrating a driving part and related components of a lens driving device according to a second embodiment of the present invention; FIG. 52 is a plan view of a state in which a cover is omitted from a lens driving device according to a second embodiment of the present invention; FIG. 53 is an enlarged plan view of a part of FIG. 52 in a state where the cover is omitted; FIG. 54 is a cross-sectional perspective view illustrating a ball and related components of a lens driving device according to a second embodiment of the present invention; FIG. 55 is a perspective view illustrating a ball and related components of a lens driving device according to a second embodiment of the present invention; FIG. 56 is a perspective view illustrating a ball accommodating structure of a base of a lens driving device according to a second embodiment of the present invention; FIG. 57 is a perspective view illustrating a state in which the ball, plate member, elastic member, and reinforcing member are disposed in FIG. 56; FIG. 58 is a perspective view of FIG. 57 viewed from another direction; FIG. 59 is a perspective view illustrating a moving part and a ball of a lens driving device according to a second embodiment of the present invention; FIG. 60 is a perspective view of FIG. 59 viewed from another direction; and FIG. 61(a) is a view comparing the heights of the ball and the pressurizing point in a state in which the moving part moves upward, and FIG. 61(b) is a diagram comparing the heights of the ball and the pressurizing point in a state in which the moving part moves downward.

The lens driving device 1010 may be a voice coil motor (VCM). The lens driving device 1010 may be a lens driving motor. The lens driving device 1010 may be a lens driving actuator. The lens driving device 1010 may comprise an AF module. The lens driving device 1010 may comprise an AF actuator.

The lens driving device 1010 may comprise a fixed part 1100. The fixed part 1100 may be a relatively fixed part when the moving part 1200 moves. The moving part 1200 may move against the fixed part 1100.

The lens driving device 1010 may comprise a base 1110. The fixed part 1100 may comprise a base 1110. The base 1110 may be disposed below the holder 1210. The base 1110 may be coupled with cover 1120. The holder 1210 may be disposed on the base 1110. The holder 1210 may be disposed on a lower plate portion of the base 1110. The AF carrier 1210 may be disposed inside the base 1110. The holder 1210 may be disposed inside the side wall part 1112 of the base 1110.

The base 1110 may comprise a lower plate portion. The lower plate portion of the base 1110 may support a lower surface of the moving part 1200. The lower plate portion of the base 1110 may support a lower surface of the holder 1210.

The base 1110 may comprise a pillar part 1111. The pillar part 1111 may be extended from an upper surface of the lower plate portion.

The base 1110 may comprise an inner groove 1111-1. The pillar part 1111 may comprise an inner groove 1111-1. The inner groove 1111-1 may be formed in the pillar part 1111. The inner groove 1111-1 may be a ‘ball accommodating groove’. An inner ball 1410 may be disposed in the inner groove 1111-1. The inner groove 1111-1 may be directly in contact with the inner ball 1410. The inner groove 1111-1 may comprise a plurality of grooves. The inner groove 1111-1 may comprise two grooves. The two grooves may be disposed parallel to each other. The two grooves may be disposed in a diagonal direction from each other with respect to an optical axis.

The base 1110 may comprise an outer wall portion 1112. The outer wall portion 1112 may be a ‘side portion’. The outer wall portion 1112 may be a ‘side plate’. The outer wall portion 1112 may be a ‘side wall’. The outer wall portion 1112 of the base 1110 may be extended from an upper surface of the lower plate portion.

The base 1110 may comprise an outer groove 1112-1. The outer wall portion 1112 may comprise an outer groove 1112-1. The outer groove 1112-1 may be formed to face the inner groove 1111-1. The outer groove 1112-1 may face the inner groove 1111-1. The outer groove 1112-1 may be a ‘ball accommodating groove’. A ball 1400 may be disposed in the outer groove 1112-1. An outer ball 1420 may be disposed in the outer groove 1112-1. The outer groove 1112-1 may directly in contact with the ball 1400. The outer groove 1112-1 may be disposed in an optical axis direction. The outer groove 1112-1 may comprise a plurality of grooves. The outer groove 1112-1 may comprise two grooves. The two grooves may be disposed parallel to each other. The two grooves may be disposed in a diagonal direction from each other with respect to an optical axis. The outer groove 1112-1 may be disposed at an opposite side of the inner groove 1111-1. The outer groove 1112-1 may have a shape corresponding to the inner groove 1111-1. The outer groove 1112-1 and the inner groove 1111-1 may be formed to have the same length in an optical axis direction.

The base 1110 may comprise a protruded part. The protruded part may be protruded outward. A connecting portion 1623 of the outer substrate 1620 may be disposed above the protruded part. A groove may be formed in the protruded part so as not to interfere even when the connecting portion 1623 of the outer substrate 1620 moves.

The base 1110 may comprise a step. The step may be formed on a lower end portion of an outer side surface of the base 1110. The step may be protruded from an outer side surface of the base 1110. The side plate 1122 of the cover 1120 may be disposed in a step of the base 1110.

The lens driving device 1010 may comprise a cover 1120. The fixed part 1100 may comprise a cover 1120. The cover 1120 may be disposed on the base 1110. The cover 1120 may be disposed on the base 1110. The cover 1120 may be coupled to the base 1110. The cover 1120 may be fixed to the base 1110. The cover 1120 may accommodate the holder 1210 therein. The cover 1120 may be a shield member. The cover 1120 may be a shield can.

The cover 1120 may comprise an upper plate 1121. The upper plate 1121 may be disposed on a moving part 1200. The upward movement of the moving part 1200 may be limited by contacting of the moving part 1200 with the upper plate 1121. The upper plate 1121 may comprise a hole through which light passes.

The cover 1120 may comprise a side plate 1122. The side plate 1122 may be extended from the upper plate 1121. The side plate 1122 may be disposed on the base 1110. The side plate 1122 may be disposed on a step portion being protruded from a lower end portion of an outer side surface of the base 1110. The side plate 1122 may comprise a plurality of side plates. The side plate 1122 may comprise four side plates. The side plate 1122 may comprise a first side plate and a second side plate being disposed opposite to each other, and a third side plate and a fourth side plate being disposed opposite to each other.

The lens driving device 1010 may comprise a moving part 1200. The moving part 1200 may be disposed in the fixed part 1100. The moving part 1200 may be disposed inside the fixed part 1100. The moving part 1200 may be disposed on the fixed part 1100. The moving part 1200 may be movably disposed in the fixed part 1100. The moving part 1200 may move based on the fixed part 1100 by the driving part 1300. The moving part 1200 may move in an optical axis direction against the fixed part 1100 by the driving part 1300. The moving part 1200 can move in an optical direction. The moving part 1200 can move during AF driving. A lens may be coupled to the moving part 1200.

The lens driving device 1010 may comprise a holder 1210. The moving part 1200 may comprise a holder 1210. The holder 1210 may be an ‘AF holder’. The holder 1210 may be a ‘bobbin’. The holder 1210 may be disposed inside the base 1110. The holder 1210 may be disposed on the base 1110. The holder 1210 may be disposed inside the cover 1120. The holder 1210 may be movably disposed. The holder 1210 may be movably disposed in an optical axis direction.

The holder 1210 may comprise an inner groove 1211. The inner groove 1211 may be a ‘ball accommodating groove’. A ball 1400 may be disposed in the inner groove 1211. An inner ball 1410 may be disposed in the inner groove 1211. The inner groove 1211 may be directly in contact with the ball 1400. The inner groove 1211 may be disposed in an optical axis direction. The inner groove 1211 may guide the ball 1400 to move in an optical axis direction. The inner groove 1211 may comprise a plurality of grooves. The inner groove 1211 may comprise two grooves. The two grooves may be disposed parallel to each other. The two grooves may be disposed in a diagonal direction from each other with respect to an optical axis.

The holder 1210 may comprise an outer groove 1212. The outer groove 1212 may be a ‘ball accommodating groove’. A ball 1400 may be disposed in the outer groove 1212. An outer ball 1420 may be disposed in the outer groove 1212. The outer groove 1212 may be directly in contact with the ball 1400. The outer groove 1212 may be disposed in an optical axis direction. The outer groove 1212 may guide the ball 1400 to move in an optical axis direction. The outer groove 1212 may comprise a plurality of grooves. The outer groove 1212 may comprise two grooves. The two grooves may be disposed parallel to each other. The two grooves may be disposed in a diagonal direction with respect to an optical axis. The outer groove 1212 may be disposed at an opposite side of the inner groove 1211. The outer groove 1212 may have a shape corresponding to the inner groove 1211. The outer groove 1212 and the inner groove 1211 may be formed to have the same length in an optical axis direction.

The holder 1210 may comprise a protruded part 1213. The protruded part 1213 may be formed on an outer side surface of the holder 1210. The protruded part 1213 may be protruded outward from the holder 1210. At least a portion of the connecting portion 1623 of the outer substrate 1620 may be disposed on an upper surface of the protruded part 1213. At least a portion of the coupling portion 1622 of the outer substrate 1620 may be disposed on an upper surface of the protruded part 1213.

The lens driving device 1010 may comprise a driving part 1300. The driving part 1300 may move the moving part 1200 in an optical axis direction. The driving part 1300 may move the holder 1210 in an optical axis direction. The driving part 1300 may move the holder 1210 in an optical axis direction through electromagnetic force. The driving part 1300 may comprise a coil 1310 and a magnet 1320. The coil 1310 and the magnet 1320 may move the moving part 1200 in an optical axis direction.

The lens driving device 1010 may comprise a coil 1310. The driving part 1300 may comprise a coil 1310. The coil 1310 may interact with magnet 1320. The coil 1310 may face the magnet 1320. The coil 1310 and the magnet 1320 may face each other. The coil 1310 may be disposed at a position corresponding to the magnet 1320. The coil 1310 may be overlapped with the magnet 1320 in a direction perpendicular to the optical axis. The coil 1310 may be disposed in the inner substrate 1610. The coil 1310 may be disposed in the side plate portion 1612 of the inner substrate 1610. The coil 1310 may be disposed in holder 1210. The coil 1310 may be disposed in the holder 1210 through the inner substrate 1610. The coil 1310 may move together with the holder 1210.

In a second embodiment of the present invention, the coil 1310 can move in an optical axis direction. The coil 1310 may move in an optical axis direction through interaction with the magnet 1320. The coil 1310 may move together with the moving part 1200. The coil 1310 may move in an optical axis direction together with the moving part 1200. During the AF driving process, the coil 1310 may move together with the moving part 1200 in an optical axis direction. The coil 1310 may be disposed in the moving part 1200. The coil 1310 may be fixed to the moving part 1200. The coil 1310 may be coupled to the moving part 1200.

The lens driving device 1010 may comprise a magnet 1320. The driving part 1400 may comprise a magnet 1320. The magnet 1320 may be a ‘magnet’. The magnet 1320 may be a permanent magnet. The magnet 1320 may be disposed in the fixed part 1100. The magnet 1320 may be disposed on the base 1110. The magnet 1320 may be disposed in the cover 1120. The magnet 1320 may be disposed in the side plate 1122 of the cover 1120. The magnet 1320 may be disposed on an outer side surface of the base 1110. The magnet 1320 may be disposed on an inner side surface of the base 1110. The magnet 1320 may be fixed to the base 1110. The magnet 1320 may be coupled to the base 1110. The magnet 1320 may be attached to the base 1110 with an adhesive. The magnet 1320 may be disposed inside the cover 1120. The magnet 1320 may interact with the coil 1310. The magnet 1320 may interact with the coil 1310 electromagnetically. The magnet 1320 may be disposed at a position corresponding to the coil 1310. The magnet 1320 and the coil 1310 may face each other. The magnet 1320 may face the coil 1310. The magnet 1320 may be overlapped with the coil 1310 in a direction perpendicular to the optical axis.

The magnet 1320 may be a 4-pole magnet. The magnet 1320 may comprise a 4-pole magnetized magnet. The magnet 1320 may comprise a first magnet part comprising an N pole and an S pole, and a second magnet part comprising an N pole and an S pole. The first magnet part and the second magnet part may be disposed in a vertical direction. The first magnet part and the second magnet part are disposed spaced apart from each other in a vertical direction, and a neutral part may be disposed between the first magnet part and the second magnet part.

The lens driving device 1010 may comprise a sensor 1330. The driving part 1300 may comprise a sensor 1330. The sensor 1330 may be a Hall sensor. The sensor 1330 may be disposed in the inner substrate 1610. The sensor 1330 may detect the magnet 1320. The sensor 1330 may detect movement of the magnet 1320. The movement amount or position of the magnet 1320 detected by the sensor 1330 may be used for feedback of auto focus driving. The sensor 1330 may be disposed in the moving part 1200. The sensor 1330 may be disposed in a holder 1210. The sensor 1330 may be disposed in the holder 1210 through the inner substrate 1610. The sensor 1330 may move together with the moving part 1200.

The sensor 1330 may be a driver IC. The driver IC may comprise a sensing unit. The sensing unit may comprise a Hall IC. The driver IC may be electrically connected to the coil 1310. The driver IC may supply current to the coil 1310.

The sensor 1330 may be disposed inside the coil 1310. The sensor 1330 may be overlapped with a neutral portion of the magnet 1320 in a direction perpendicular to the optical axis. As a modified embodiment, the sensor 1330 may be disposed outside the coil 1310.

The lens driving device 1010 may comprise a yoke 1340. The yoke 1340 may be disposed at a position corresponding to the magnet 1320. The yoke 1340 may be disposed in the magnet 1320. The yoke 1340 may be disposed between the magnet 1320 and the side plate 1122 of the cover 1120. The yoke 1340 may be disposed on an outer surface of the magnet 1320. The inner surface of the magnet 1320 may face the coil 1310. Through this, the yoke 1340 may increase electromagnetic interaction force between the magnet 1320 and the coil 1310 by minimizing leakage flux of the magnet 1320.

The lens driving device 1010 may comprise a guide member. The guide member may comprise a ball 1400. The guide member may comprise a shaft. The guide member may comprise a cylindrical member. The guide member may guide the movement of the moving part 1200 against the fixed part 1100 in a specific direction. In a modified embodiment, the ball 1400 of the second embodiment of the present invention can be replaced with a shaft. In this case, a tilt phenomenon of the moving part 1200 can be prevented.

The lens driving device 1010 may comprise a ball 1400. The ball 1400 may guide the movement of the moving part 1200 against the fixed part 1100 in an optical axis direction. The ball 1400 may guide the movement of the holder 1210 against the base 1110 in an optical axis direction. The ball 1400 may be disposed between the fixed part 1100 and the moving part 1200. The ball 1400 may be disposed between the base 1110 and the holder 1210. The ball 1400 may be disposed between the base 1110 and the holder 1210 in an x direction. Or, the ball 1400 may be disposed between the base 1110 and the holder 1210 in a y direction. The ball 1400 may be disposed in a groove of the base 1110. The ball 1400 may be disposed in a groove of the holder 1210. The ball 1400 may have a spherical shape. The ball 1400 may be formed of metal. Grease may be applied to the surface of the ball 1400.

The ball 1400 may be disposed at a first corner of the base 1110. The ball 1400 may be disposed at a second corner in a diagonal direction of the first corner of the base 1110. The ball 1400 may be disposed at each of the first corner and the second corner of the base 1110. The first corner region and the second corner region of the fixed part 1100 may be disposed in diagonal directions with respect to an optical axis. The ball 1400 may be disposed in the first corner region and the second corner region of the fixed part 1100. Two sets of balls 1400 may be disposed at each of the first corner and the second corner of the base 1110. At this time, one set may comprise 4 balls. The two sets may be disposed at an opposite side of the pillar part of the holder 1210 from each other.

The ball 1400 may comprise an inner ball 1410. The inner ball 1410 may be disposed in the pillar part 1111 of the base 1110. The inner ball 1410 may be disposed in the inner groove 1111-1 of the base 1110. The inner ball 1410 may be disposed in the inner groove 1211 of the holder 1210. The inner ball 1410 may be disposed in the inner groove 1211 of the moving part 1200. The inner ball 1410 may be disposed in the inner groove 1111-1 of the base 1110 and the inner groove 1211 of the holder 1210. The inner ball 1410 may be disposed between the inner groove 1111-1 of the base 1110 and the inner groove 1211 of the holder 1210. The inner ball 1410 may be disposed between the moving part 1200 and the pillar part 1111 of the fixed part 1100.

The ball 1400 may comprise an outer ball 1420. The outer ball 1420 may be disposed In the outer wall portion 1112 of the base 1110. The outer ball 1420 may be disposed in the outer groove 1112-1 of the base 1110. The outer ball 1420 may be disposed in the outer groove 1212 of the holder 1210. The outer ball 1420 may be disposed in the outer groove 1112-1 of the base 1110 and the outer groove 1212 of the holder 1210. The outer ball 1420 may be disposed between the outer groove 1112-1 of the base 1110 and the outer groove 1212 of the holder 1210. The outer ball 1420 may be disposed between the outer groove 1112-1 of the fixed part 1100 and the outer groove 1212 of the moving part 1200. The outer ball 1420 may be disposed between the outer wall portion 1112 of the moving part 1200 and the fixed part 1100.

The inner ball 1410 may comprise a plurality of inner balls 1410. The plurality of inner balls 1410 may be disposed in an optical axis direction. The inner ball 1410 may comprise four inner balls 1410. The inner ball 1410 may comprise first to fourth inner balls. Two of the four inner balls 1410 may have a large diameter and the other two may have a small diameter. The two balls with a large diameter can be disposed at the uppermost and the lowermost places. That is, the two balls with a small diameter may be disposed between the two balls with a large diameter.

The inner ball 1410 may comprise the uppermost inner ball 1411. The uppermost inner ball 1411 may be disposed at the highest place among the inner balls 1410. The uppermost inner ball 1411 may be disposed to be closest to the upper plate 1121 of the cover 1120 among the inner balls 1410. The inner ball 1410 may comprise the lowermost inner ball 1412. The lowermost inner ball 1412 may be disposed at the lowest place among the inner balls 1410. The lowermost inner ball 1412 may be disposed to be closest to the lower part of the base 1110 among the inner balls 1410. The plurality of inner balls 1410 may comprise balls having a smaller diameter than each of the uppermost inner ball 1411 and the lowermost inner ball 1412. The plurality of inner balls 1410 may comprise balls being disposed between the uppermost inner ball 1411 and the lowermost inner ball 1412.

The outer ball 1420 may comprise a plurality of outer balls 1420. The plurality of outer balls 1420 may be disposed in an optical axis direction. The outer ball 1420 may comprise four outer balls 1420. The outer ball 1420 may comprise first to fourth outer balls. Two of the four outer balls 1420 may have a large diameter and the other two may have a small diameter. The two balls with a large diameter can be disposed at the highest and the lowest places. That is, the two balls with a small diameter may be disposed between the two balls with a large diameter.

The outer ball 1420 may comprise an uppermost outer ball 1421. The uppermost outer ball 1421 may be placed at the highest place among the outer balls 1420. The uppermost outer ball 1421 may be disposed to be closest to the upper plate 1121 of the cover 1120 among the outer balls 1420. The outer ball 1420 may comprise a lowermost outer ball 1422. The lowermost outer ball 1422 may be disposed at the lowest place among the outer balls 1420. The lowermost outer ball 1422 may be disposed to be closest to the lower plate of the base 1110 among the outer balls 1420. The plurality of outer balls 1420 may comprise balls having a smaller diameter than each of the uppermost outer ball 1421 and the lowermost outer ball 1422. The plurality of outer balls 1420 may comprise balls being disposed between the uppermost outer ball 1421 and the lowermost outer ball 1422.

The height of the point where the elastic member 1520 pressurizes the plate member 1510 is lower than the height of the ball being disposed lower among the uppermost inner ball 1411 and the uppermost outer ball 1421, and may be higher than the height of the ball being disposed higher among the lowermost inner ball 1412 and the lowermost outer ball 1422. More specifically, as shown in FIG. 61(a), when the moving part 1200 moves upward, the height b of the point where the elastic member 1520 pressurizes the plate member 1510 may be higher than the height a of the ball being disposed higher among the lowermost inner ball 1422 and the lowermost outer ball 1412. A gap c may exist at a height between the two points. In addition, as shown in FIG. 61(b), when the moving part 1200 moves downward, the height e of the point where the elastic member 1520 pressurizes the plate member 1510 may be lower than the height d of the ball being disposed lower among the uppermost inner ball 1421 and uppermost outer ball 1411. A gap f may exist at a height between the two points. Through this, generation of a moment being generated when the elastic member 1520 pressurizes the plate member 1510 may be prevented or minimized. That is, a phenomenon in which the plate member 1510 is tilted or separated may be prevented.

The lens driving device 1010 may comprise a pressurizing member. The pressurizing member may be a ‘ball pressurizing member’. The pressurizing member may pressurize the ball 1400. The pressurizing member may be formed to pressurize the ball. The ball 1400 pressurized by the pressurizing member may be held between the fixed part 1100 and the moving part 1200. The ball 1400 pressurized by the pressurizing member may be held between the base 1110 and the holder 1210. The pressurizing member may keep the ball 1400 to be in contact with the fixed part 1100 and the moving part 1200. The pressurizing member may keep the ball 1400 in a state being in contact with the base 1110 and the holder 1210.

The lens driving device 1010 may comprise a plate member 1510. The pressurizing member may comprise the plate member 1510. The plate member 1510 may be disposed on the ball 1400. The plate member 1510 may be disposed in the elastic member 1520. The plate member 1510 may be disposed on the base 1110. The plate member 1510 may be disposed between the elastic member 1520 and the ball 1400. The plate member 1510 may pressurize the ball 1400 toward the holder 1210 by the elastic member 1520. The plate member 1510 may be disposed between the ball 1400 and the fixed part 1100. The plate member 1510 may be disposed between the inner ball 1410 and the pillar part 1111 of the fixed part 1100.

The lens driving device 1010 may comprise an elastic member 1520. The pressurizing member may comprise an elastic member 1520. The elastic member 1520 may be a spring. The elastic member 1520 may be a tapered spring. The elastic member 1520 may be disposed in the fixed part 1100. The elastic member 1520 may pressurize the ball 1400 toward the moving part 1200. The elastic member 1520 may pressurize the plate member 1510 toward the ball 1400. The elastic member 1520 may be disposed between the plate member 1510 and the fixed part 1100. The elastic member 1520 may push the plate member 1510 against the fixed part 1100. The elastic member 1520 may pressurize the plate member 1510 in a direction opposite to the fixed part 1100. The elastic member 1520 may be disposed between the plate member 1510 and the pillar part 1111 of the fixed part 1100. The elastic member 1520 may be disposed in the inner groove 1111-1 of the fixed part 1100.

As a modified embodiment, the elastic member 1520 may be disposed in the moving part 1200. At this time, the elastic member 1520 may pressurize the ball 1400 toward the fixed part 1100. The elastic member 1520 may be disposed on one of the fixed part 1100 and the moving part 1200 to pressurize the ball 1400 toward the other one of the fixed part 1100 and the moving part 1200. The elastic member 1520 may pressurize the plate member 1510. The elastic member 1520 may be disposed between the plate member 1510 and the base 1110. The elastic member 1520 may be disposed between the ball 1400 and the base 1110. The elastic member 1520 may be disposed on the base 1110. The elastic member 1520 may be disposed in the inner groove 1111-1 of the base 1110. The elastic member 1520 may pressurize the ball 1400 toward the holder 1210. Through this, the contact state of the ball 1400 between the plate member 1510 and the holder 1210 may be maintained.

The elastic member 1520 may comprise a bent part. The bent part may comprise a bent shape. The bent part may comprise a plurality of bent parts. The bent part may comprise three bent parts. The elastic member 1520 may be bent at least three times. The elastic member 1520 may comprise an upper bent part 1521. The elastic member 1520 may comprise a lower bent part 1522. The elastic member 1520 may comprise a connection bent part 1523. The connection bent part 1523 may be disposed between the upper bent part 1521 and the lower bent part 1522. The upper bent part 1521 may form an obtuse angle. The lower bent part 1522 may form an obtuse angle. The connection bent part 1523 may form an obtuse angle. The upper bent part 1521 may be disposed in the fixed part 1100. The lower bent part 1522 may be disposed in the fixed part 1100. The connection bent part 1523 may be disposed in the plate member 1510. Through this structure, the elastic member 1520 may push the plate member 1510 against the fixed part 1100. The connection bent part 1523 may be in contact with the plate member 1510 to pressurize the plate member 1510 toward the ball 1400.

The lens driving device 1010 may comprise a substrate 1600. The substrate 1600 may comprise a flexible printed circuit board (FPCB). The substrate 1600 may be electrically connected to the coil 1310. The substrate 1600 may be electrically connected to the sensor 1330.

The lens driving device 1010 may comprise an inner substrate 1610. The inner substrate 1610 may be electrically connected to the coil 1310. The inner substrate 1610 may be electrically connected to the sensor 1330. The inner substrate 1610 may be disposed on the moving part 1200. The inner substrate 1610 may be disposed on the holder 1210. The inner substrate 1610 may be fixed to the holder 1210. The inner substrate 1610 may be coupled to the holder 1210. The inner substrate 1610 may be attached to the holder 1210 with an adhesive. The inner substrate 1610 may comprise a flexible substrate. The inner substrate 1610 may comprise a flexible printed circuit board (FPCB). The inner substrate 1610 may comprise an elastic portion. The inner substrate 1610 may comprise an elastic member.

The inner substrate 1610 may comprise an upper plate portion 1611. The upper plate portion 1611 may be disposed on the moving part 1200. The upper plate portion 1611 may be disposed on an upper surface of the moving part 1200. The upper plate portion 1611 may be disposed on the holder 1210. The upper plate portion 1611 may be disposed on an upper surface of the holder 1210. The upper plate portion 1611 may be disposed between the holder 1210 and the upper plate 1121 of the cover 1120.

The inner substrate 1610 may comprise a terminal 1611-1. The terminal 1611-1 may be disposed on the upper plate portion 1611 of the inner substrate 1610. The terminal 1611-1 may be electrically connected to the coil 1310. The terminal 1611-1 may be electrically connected to the sensor 1330. The terminal 1611-1 of the inner substrate 1610 may be electrically connected to a terminal 1622-1 of the outer substrate 1620. The terminal 1611-1 of the inner substrate 1610 may be connected to the terminal 1622-1 of the outer substrate 1620 through a conductive member. The terminal 1611-1 of the inner substrate 1610 may be coupled to the terminal 1622-1 of the outer substrate 1620 through soldering.

The inner substrate 1610 may comprise a side plate portion 1612. The side plate portion 1612 may be disposed on a side surface of the holder 1210. The side plate portion 1612 may be disposed on the side surface of the moving part 1200. The side plate portion 1612 may be disposed on an outer side surface of the holder 1210. The side plate portion 1612 may be disposed on an outer side surface of the moving part 1200. The side plate portion 1612 may be extended from the upper plate portion 1611. The side plate portion 1612 may be extended downward from the upper plate portion 1611. The side plate portion 1612 may be bent from the upper plate portion 1611. A coil 1310 may be disposed on the side plate portion 1612. A sensor 1330 may be disposed on the side plate portion 1612. The side plate portion 1612 may be disposed between the coil 1310 and the holder 1210.

Although the inner substrate 1610 has been described as a separate component from the moving part 1200, the inner substrate 1610 may be comprised in the moving part 1200.

The lens driving device 1010 may comprise an outer substrate 1620. The outer substrate 1620 may be disposed on the base 1110. The outer substrate 1620 may be electrically connected to the coil 1310. The outer substrate 1620 may be electrically connected to the sensor 1330. The outer substrate 1620 may connect the holder 1210 and the base 1110. The outer substrate 1620 may elastically connect the holder 1210 and the base 1110. The outer substrate 1620 may movably support the holder 1210 relative to the base 1110. The outer substrate 1620 may guide the holder 1210 to move in an optical axis direction with respect to the base 1110. The outer substrate 1620 may comprise a flexible substrate. The outer substrate 1620 may comprise a flexible printed circuit board (FPCB). The outer substrate 1620 may comprise an elastic portion. The outer substrate 1620 may comprise an elastic member. The outer substrate 1620 may be disposed on the fixed part 1100. The outer substrate 1620 may comprise an outer side portion 1621. The outer side portion 1621 may be disposed on the base 1110. The outer side portion 1621 may be disposed on a side surface of the base 1110. The outer side portion 1621 may be disposed on an outer side surface of the base 1110.

The outer substrate 1620 may comprise a terminal 1621-1. The outer side portion 1621 of the outer substrate 1620 may comprise a terminal 1621-1. The terminal 1621-1 may be electrically connected to the terminal 1622-1. The terminal 1621-1 may be disposed at a lower end of the base 1110. The terminal 1621-1 may be coupled to the printed circuit board 1050. The terminal 1621-1 may be coupled to a terminal of the printed circuit board 1050 through soldering. The terminal 1621-1 may be coupled to a terminal of the printed circuit board 1050 through a conductive member. The terminal 1621-1 may be connected to a terminal of the printed circuit board 1050. The terminal 1621-1 may be electrically connected to a terminal of the printed circuit board 1050.

The outer substrate 1620 may comprise a coupling portion 1622. The coupling portion 1622 may be coupled to the inner substrate 1610. The coupling portion 1622 may move together with the inner substrate 1610. The coupling portion 1622 may move together with the holder 1210.

The outer substrate 1620 may comprise a terminal 1622-1. The coupling portion 1622 of the outer substrate 1620 may comprise a terminal 1622-1. The terminal 1622-1 may be coupled with the terminal 1611-1 of the inner substrate 1610. The terminal 1622-1 of the outer substrate 1620 may be coupled to the terminal 1611-1 of the inner substrate 1610 through soldering. The terminal 1622-1 of the outer substrate 1620 may be coupled to the terminal 1611-1 of the inner substrate 1610 through a conductive member. The terminal 1622-1 of the outer substrate 1620 may be connected to the terminal 1611-1 of the inner substrate 1610. The terminal 1622-1 of the outer substrate 1620 may be electrically connected to the terminal 1611-1 of the inner substrate 1610.

The outer substrate 1620 may comprise a connecting portion 1623. The connecting portion 1623 may be an ‘extended portion’. The connecting portion 1623 may be a ‘leg portion’. The connecting portion 1623 may be extended from the outer side portion 1621. The connecting portion 1623 may be extended from the coupling portion 1622. The connecting portion 1623 may connect the outer side portion 1621 and the coupling portion 1622. At least a portion of the connecting portion 1623 may move together with the holder 1210. At least a portion of the connecting portion 1623 may move together with the inner substrate 1610. At least a portion of the connecting portion 1623 may be disposed perpendicular to the optical axis direction. The connecting portion 1623 of the outer substrate 1620 may be coupled to the inner substrate 1610 so that the inner substrate 1610 can move in an optical axis direction. The connecting portion 1623 may comprise a bent shape. The connecting portion 1623 may comprise a bent portion. The connecting portion 1623 may comprise a U-shaped portion.

The lens driving device 1010 may comprise a reinforcing member 1710. The reinforcing member 1710 may be disposed on the base 1110. The reinforcing member 1710 may be disposed to reinforce the strength of the base 1110. The reinforcing member 1710 may prevent damage to the base 1110. The reinforcing member 1710 can prevent the pillar part 1111 of the base 1110 from damages. The reinforcing member 1710 may prevent the outer wall portion 1112 of the base 1110 from damages. The reinforcing member 1710 may have elasticity. The reinforcing member 1710 may be formed of metal. The reinforcing member 1710 may comprise a shape bent at least twice. The reinforcing member 1710 may be formed in the shape of a symbol ‘⊂’ when viewed from above. The reinforcing member 1710 may be opened inward.

The reinforcing member 1710 may comprise an inner side portion 1711. The inner side portion 1711 may be disposed on an opposite side of the inner groove 1111-1 of the pillar part 1111 of the fixed part 1100. The reinforcing member 1710 may comprise an outer side portion 1712. The outer side portion 1712 may be disposed on an opposite side of the outer groove 1112-1 of the outer wall portion 1112 of the fixed part 1100. The reinforcing member 1710 may comprise a connecting portion 1713. The connecting portion 1713 may connect the inner side portion 1711 and the outer side portion 1712.

The lens driving device 1010 may comprise a cover 1720. The cover 1720 may be disposed above the ball 1400. The cover 1720 may be overlap with the ball 1400 in an optical axis direction. The cover 1720 may be overlapped with the inner ball 1410 in an optical axis direction. The cover 1720 may be overlapped with the outer ball 1420 in an optical axis direction. The cover 1720 may be disposed on the inner groove 1211 and the outer groove 1212 of the holder 1210 to prevent the ball 1400 from being separated upward.

Hereinafter, a configuration of a lens driving device according to a modified embodiment will be described with reference to drawings.

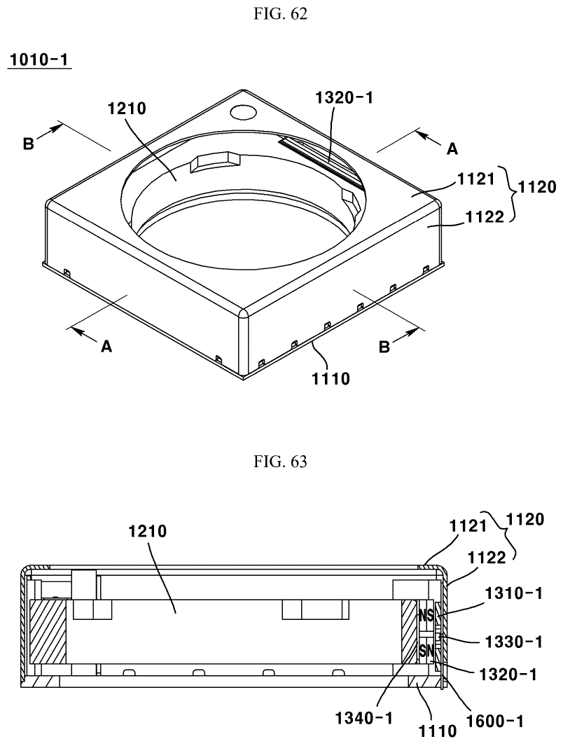

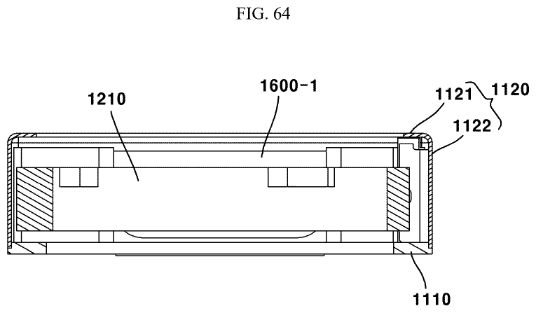

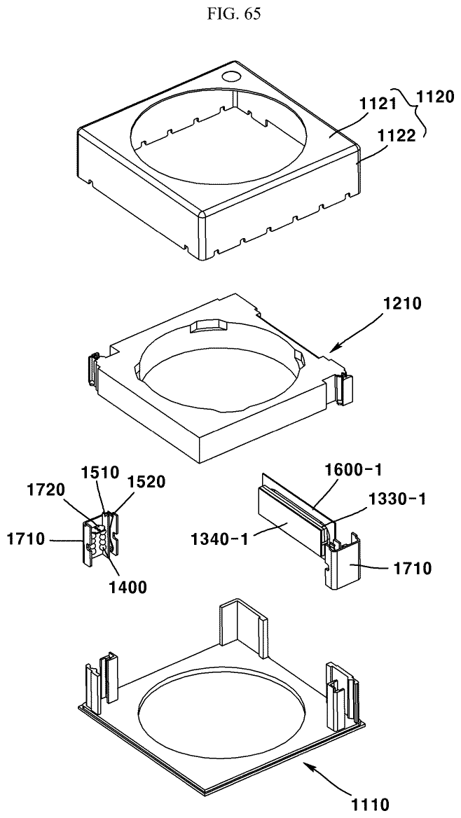

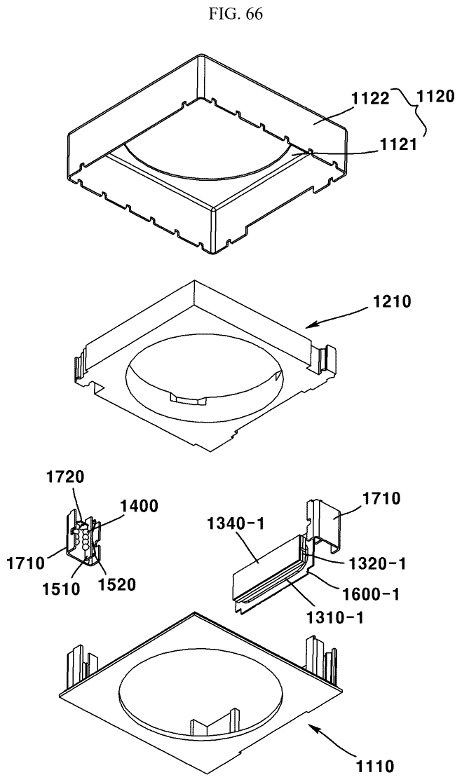

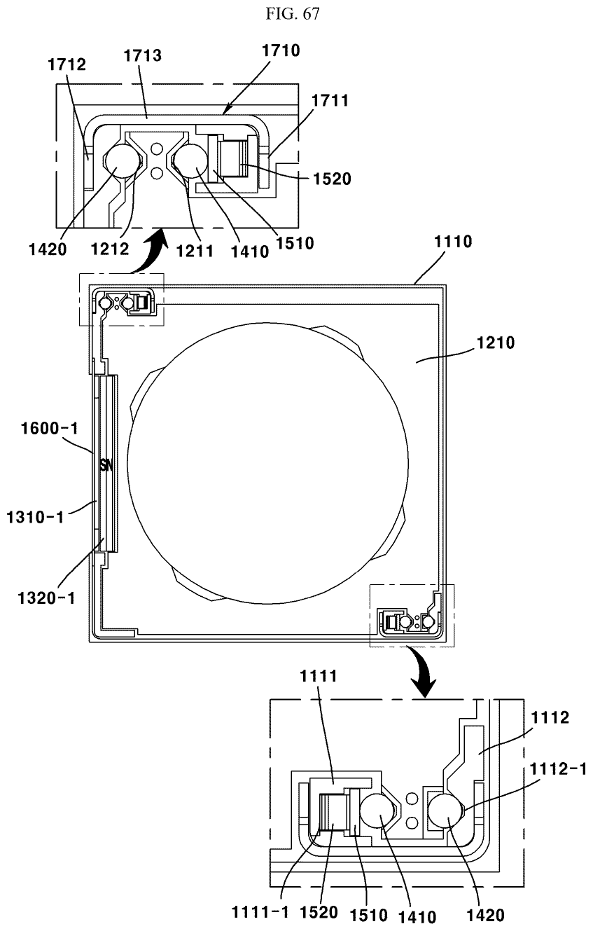

FIG. 62 is a perspective view of a lens driving device according to a modified embodiment; FIG. 63 is a sectional view seen from A-A in FIG. 62; FIG. 64 is a sectional view seen from B-B in FIG. 62; FIG. 65 is an exploded perspective view of a lens driving device according to a modified embodiment; FIG. 66 is an exploded perspective view of FIG. 65 viewed from another direction; and FIG. 67 is a plan view and a partially enlarged view of a state in which a cover is omitted from a lens driving device according to a modified embodiment.

The lens driving device 110-1 according to a modified embodiment may comprise a fixed part 1100. The description of the fixed part 1100 in a second embodiment of the present invention can be analogously applied to the description of the fixed part 1100.

The lens driving device 110-1 according to the modified embodiment may comprise a moving part 1200. The description for the moving part 1200 in a second embodiment of the present invention can be analogously applied to the description for the moving part 1200.

The lens driving device 110-1 according to a modified embodiment may comprise a driving part. In a modified embodiment, compared to a second embodiment of the present invention, the positions of the coil and the magnet may be reversed. That is, in a modified embodiment, the coil 1310-1 may be disposed on the fixed part 1100 and the magnet 1320-1 may be disposed on the moving part 1200.

The lens driving device 110-1 may comprise a coil 1310-1. The driving part may comprise a coil 1310-1. The coil 1310-1 may be disposed on the substrate 1600-1. The coil 1310-1 may be disposed on the fixed part 1100. The coil 1310-1 may be disposed on the base 1110. The coil 1310-1 may be disposed on the cover 1120. The coil 1310-1 may be disposed on the outer side of the magnet 1320-1. The coil 1310-1 may be disposed between the side plate 1122 of the cover 1120 and the magnet 1320-1. The coil 1310-1 may be fixed. The fixed state of the coil 1310-1 can be maintained even during AF driving.

The lens driving device 110-1 may comprise a magnet 1320-1. The driving part may comprise a magnet 1320-1. The magnet 1320-1 may be disposed on the moving part 1200. The magnet 1320-1 may be disposed on the holder 1210. The magnet 1320-1 may be disposed between the coil 1310-1 and the holder 1210. The magnet 1320-1 may be disposed inside the coil 1310-1. The magnet 1320-1 may be overlapped with the coil 1310-1 in a direction perpendicular to the optical axis. The magnet 1320-1 may face the coil 1310-1. The magnet 1320-1 and the coil 1310-1 may face each other. The magnet 1320-1 may be disposed at a position corresponding to the coil 1310-1. The magnet 1320-1 may interact with the coil 1310-1. The magnet 1320-1 may interact electromagnetically with the coil 1310-1. The magnet 1320-1 may move. The magnet 1320-1 may be movably disposed. The magnet 1320-1 may move during AF driving. The magnet 1320-1 may move together with the holder 1210. The magnet 1320-1 may move in an optical axis direction.

The lens driving device 110-1 may comprise a sensor 1330-1. The driving part may comprise the sensor 1330-1. The sensor 1330-1 may detect the magnet 1320-1. The sensor 1330-1 may be disposed on the substrate 1600-1. The sensor 1330-1 may be disposed inside the coil 1310-1. The sensor 1330-1 may be a Hall sensor. The movement amount or position of the magnet 1320-1 detected by the sensor 1330-1 may be used for feedback of autofocus driving.

The lens driving device 110-1 may comprise a yoke 1340-1. The driving part may comprise a yoke 1340-1. The yoke 1340-1 may be disposed at a position corresponding to the magnet 1320-1. The yoke 1340-1 may be disposed on the magnet 1320-1. The yoke 1340-1 may be disposed between the magnet 1320 and the holder 1210. The yoke 1340-1 may be disposed on an inner surface of the magnet 1320-1. The outer surface of the magnet 1320-1 may face the coil 1310-1. Through this, the yoke 1340-1 can increase the electromagnetic interaction force between the magnet 1320-1 and the coil 1310-1 by minimizing leakage flux of the magnet 1320-1.

The lens driving device 110-1 may comprise a substrate 1600-1. The substrate 1600-1 may be disposed on the fixed part 1100. The substrate 1600-1 may be disposed on the base 1110. The substrate 1600-1 may be disposed on the cover 1120. The substrate 1600-1 may be disposed on the side plate 1122 of the cover 1120. The substrate 1600-1 may be disposed on an inner surface of the side plate 1122 of the cover 1120. The substrate 1600-1 may be disposed on an outer surface of the side plate 1122 of the cover 1120. The substrate 1600-1 may be disposed parallel to an optical axis. A coil 1310-1 and a sensor 1330-1 may be disposed on the substrate 1600-1. The substrate 1600-1 may comprise a printed circuit board. The substrate 1600-1 may comprise a flexible printed circuit board (FPCB).

The lens driving device 110-1 according to a modified embodiment may comprise a ball 1400. The description of the ball 1400 in a second embodiment of the present invention can be analogously applied to the description of the ball 1400.

The second embodiment and the modified embodiment of the present invention have advantages in that there is no centering force of the yoke in the optical axis direction by using tapered springs when compared to the comparative example pressurizing the ball through the attractive force between the yoke and the magnet. In addition, by disposing the balls 1400 diagonally, it is possible to prevent the moving part 1200 from being rotated or tilted and to secure necessary adhesion. However, as a modified embodiment, both sets of balls 1400 may be disposed on one side of the fixed part 1100, not in a diagonal direction. As another modified embodiment, the ball 1400 may be used as a shaft structure to minimize the tilt of the module, that is, the moving part 1200.

Hereinafter, auto focus (AF) driving of a lens driving device according to a second embodiment of the present invention will be described with reference to drawings.

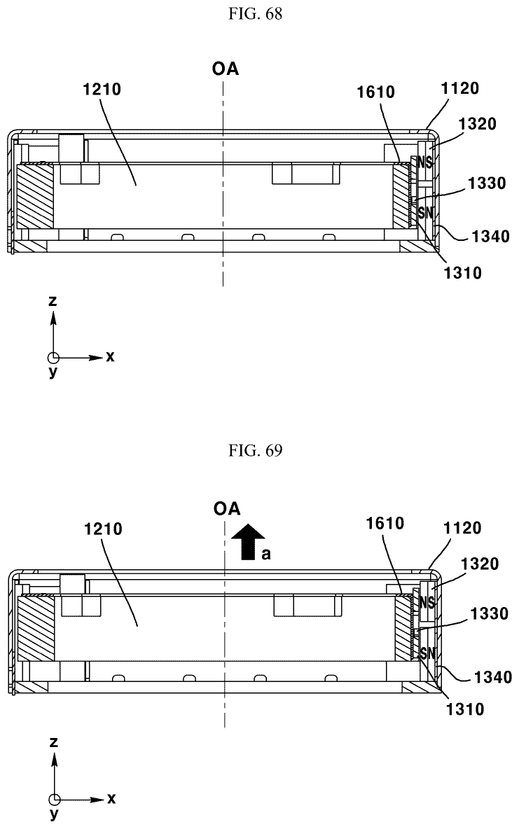

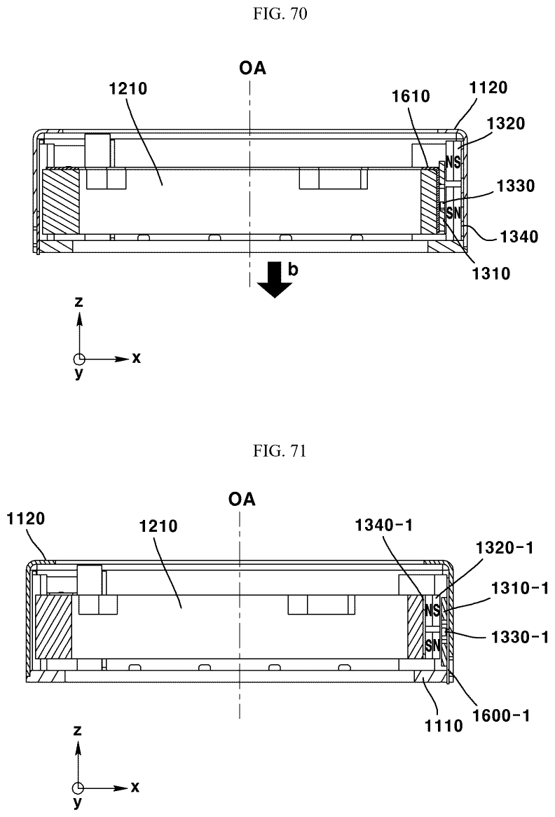

FIGS. 68 to 70 are views for explaining autofocus driving of a lens driving device according to a second embodiment of the present invention. FIG. 68 is a cross-sectional view of a moving part in an initial state in which no current is applied to the AF coil. FIG. 69 is a cross-sectional view illustrating a state in which a moving part moves upward in an optical axis direction when a forward current is applied to an AF coil. FIG. 70 is a cross-sectional view illustrating a moving part moving downward in an optical axis direction when a reverse current is applied to the AF coil.

As illustrated in FIG. 68, the moving part 1200 may be disposed at a position spaced apart from both the upper plate 1121 and the base 1110 of the cover 1120 in an initial position where no current is applied to the coil 1310.

When a forward current is applied to the coil 1310, the coil 1310 may move upward in an optical axis direction due to electromagnetic interaction between the coil 1310 and the magnet 1320 (see a in FIG. 69). At this time, the holder 1210 together with the coil 1310 may move upward in an optical axis direction. Furthermore, the lens may move upward together with the holder 1210 in an optical axis direction. Accordingly, the distance between the lens and the image sensor is changed so that the focus of an image being formed on the image sensor through the lens can be adjusted.

When a reverse current is applied to the coil 1310, the coil 1310 may move downward in an optical axis direction due to electromagnetic interaction between the coil 1310 and the magnet 1320 (see b in FIG. 70). At this time, the holder 1210 together with the coil 1310 may move downward in an optical axis direction. Furthermore, the lens together with the holder 1210 may move downward in an optical axis direction. Accordingly, the distance between the lens and the image sensor is changed so that the focus of an image being formed on the image sensor through the lens can be adjusted.

Meanwhile, in the process of moving the coil 1310, the sensor 1330 moves together with the coil 1310 and detects the intensity of the magnetic field of the magnet 1320 to detect the amount or position of the lens moving in an optical axis direction. The movement amount or position of the lens in an optical axis direction detected by the sensor 1330 may be used for autofocus feedback control.

Hereinafter, auto focus (AF) driving of a lens driving device according to a modified embodiment will be described with reference to drawings.

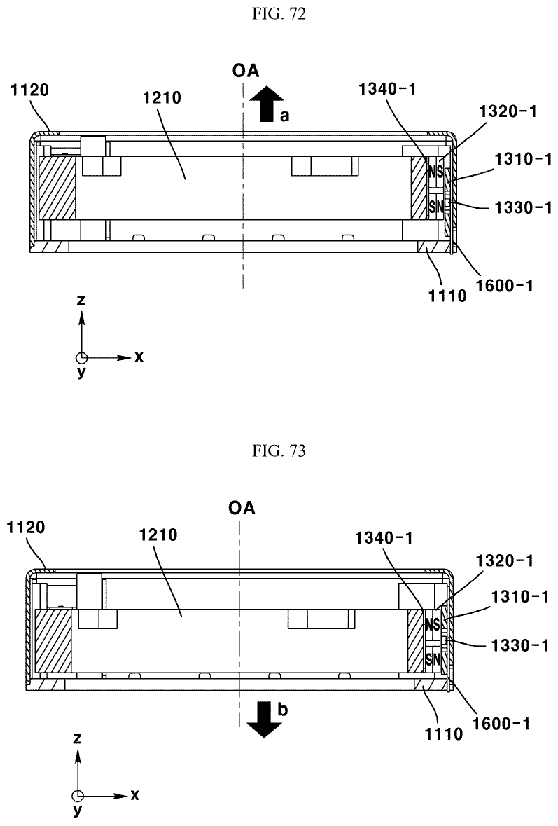

FIGS. 71 to 73 are diagrams for explaining autofocus driving of a lens driving device according to a second embodiment of the present invention. FIG. 71 is a cross-sectional view illustrating the state of the moving part in an initial state in which no current is applied to the AF coil. FIG. 72 is a cross-sectional view illustrating a state in which a moving part moves upward in an optical axis direction when a forward current is applied to an AF coil. FIG. 73 is a cross-sectional view illustrating a moving part being moved downward in an optical axis direction when a reverse current is applied to the AF coil.

As illustrated in FIG. 71, the moving part 1200 may be disposed at a position spaced apart from both the upper plate 1121 and the base 1110 of the cover 1120 in an initial position where no current is applied to the coil 1310-1.

When a forward current is applied to the coil 1310-1, the magnet 1320-1 may move upward in an optical axis direction due to electromagnetic interaction between the coil 1310-1 and the magnet 1320-1 (see a in FIG. 72). At this time, the holder 1210 together with the magnet 1320-1 may move upward in an optical axis direction. Furthermore, the lens may move upward together with the holder 1210 in an optical axis direction. Accordingly, the distance between the lens and the image sensor is changed so that the focus of an image being formed on the image sensor through the lens can be adjusted.

When a reverse current is applied to the coil 1310-1, the magnet 1320-1 can move downward in an optical axis direction due to electromagnetic interaction between the coil 1310-1 and the magnet 1320-1 (see b in FIG. 73). At this time, the holder 1210 together with the magnet 1320-1 may move downward in an optical axis direction. Furthermore, the lens together with the holder 1210 may move downward in an optical axis direction. Accordingly, the distance between the lens and the image sensor is changed so that the focus of an image being formed on the image sensor through the lens can be adjusted.

Meanwhile, during the movement process of the magnet 1320-1, the sensor 1330-1 may detect the amount or position of the lens moving in the optical axis direction by detecting the strength of the magnetic field of the magnet 1320-1. The movement amount or position of the lens in the optical axis direction detected by the sensor 1330-1 may be used for autofocus feedback control.

Hereinafter, a camera device according to a second embodiment of the present invention will be described with reference to the drawings.

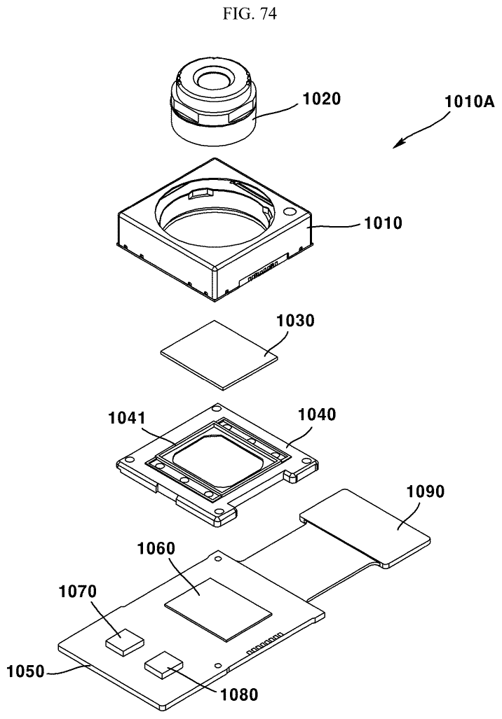

FIG. 74 is an exploded perspective view of a camera device according to a second embodiment of the present invention.

The camera device 1010A may comprise a camera module.

The camera device 1010A may comprise a lens module 1020. The lens module 1020 may comprise at least one lens. The lens may be disposed at a position corresponding to the image sensor 1060. The lens module 1020 may comprise a lens and a barrel. The lens module 1020 may be coupled to the holder 1210 of the lens driving device 1010. The lens module 1020 may be coupled to the holder 1210 by screw-coupling and/or an adhesive. The lens module 1020 may move integrally with the holder 1210.

The camera device 1010A may comprise a filter 1030. The filter 1030 may serve to block light of a specific frequency band from entering the image sensor 1060 from light passing through the lens module 1020. The filter 1030 may be disposed parallel to an x-y plane. The filter 30 may be disposed between the lens module 1020 and the image sensor 1060. The filter 1030 may be disposed in the sensor base 1040. In a modified embodiment, the filter 1030 may be disposed in base 1110. The filter 1030 may comprise an infrared filter. The infrared filter may block light of an infrared region from being incident on the image sensor 1060.

The camera device 1010A may comprise a sensor base 1040. The sensor base 1040 may be disposed between the lens driving device 1010 and the printed circuit board 1050. The sensor base 1040 may comprise a protruded part 1041 in which the filter 1030 is disposed. An opening may be formed in a portion of the sensor base 1040 where the filter 1030 is disposed so that light passing through the filter 1030 may be incident to the image sensor 1060. The adhesive member may couple or attach the base 1110 of the lens driving device 1010 to the sensor base 1040. The adhesive member may additionally serve to prevent foreign substances from entering the lens driving device 1010. The adhesive member may comprise any one or more of an epoxy, a thermosetting adhesive, and an ultraviolet curable adhesive.

The camera device 1010A may comprise a printed circuit board (PCB) 1050. The printed circuit board 1050 may be a substrate or a circuit board. The lens driving device 1010 may be disposed on the printed circuit board 1050. A sensor base 1040 may be disposed between the printed circuit board 1050 and the lens driving device 1010. The printed circuit board 1050 may be electrically connected to the lens driving device 1010. An image sensor 1060 may be disposed on the printed circuit board 1050. The printed circuit board 1050 may comprise various circuits, elements, and control units to convert an image formed by the image sensor 1060 into an electrical signal and transmit the converted electrical signal to an external device.

The camera device 1010A may comprise an image sensor 1060. The image sensor 1060 may be a component in which the light passing through the lens and the filter 1030 is incident to form an image. The image sensor 1060 may be mounted on the printed circuit board 1050. The image sensor 1060 may be electrically connected to the printed circuit board 1050. For an example, the image sensor 1060 may be coupled to the printed circuit board 1050 by a surface mounting technology (SMT). As another example, the image sensor 1060 may be coupled to the printed circuit board 1050 using a flip chip technology. The image sensor 1060 may be disposed such that an optical axis coincides with a lens. That is, the optical axis of the image sensor 1060 and the optical axis of the lens may be aligned. The image sensor 1060 may convert light being irradiated onto an effective image region of the image sensor 1060 into an electrical signal. The image sensor 1060 may be any one among a charge coupled device (CCD), a metal oxide semi-conductor (MOS), a CPD, and a CID.

The camera device 1010A may comprise a motion sensor 1070. The motion sensor 1070 may be mounted on a printed circuit board 1050. The motion sensor 1070 may be electrically connected to a control unit 1080 through a circuit pattern provided on the printed circuit board 1050. The motion sensor 1070 may output rotational angular velocity information due to the movement of the camera module. The motion sensor 1070 may comprise a 2-axis or 3-axis gyro sensor or an angular velocity sensor.

The camera device 1010A may comprise a control unit 1080. The control unit 1080 may be disposed in the printed circuit board 1050. The control unit 1080 may be electrically connected to the coil 1310 of the lens driving device 1010. The control unit 1080 may individually control the direction, intensity, and amplitude of current supplied to the coil 1310. The control unit 1080 may perform an auto focus function and/or hand shake correction function by controlling the lens driving device 1010. Furthermore, the control unit 1080 may perform autofocus feedback control and/or hand shake correction feedback control for the lens driving device 1010.

The camera device 1010A may comprise a connector 1090. The connector 1090 may be electrically connected to the printed circuit board 1050. The connector 1090 may comprise a port for electrically connecting to an external device.

Hereinafter, an optical apparatus according to a second embodiment of the present invention will be described with reference to the drawings.

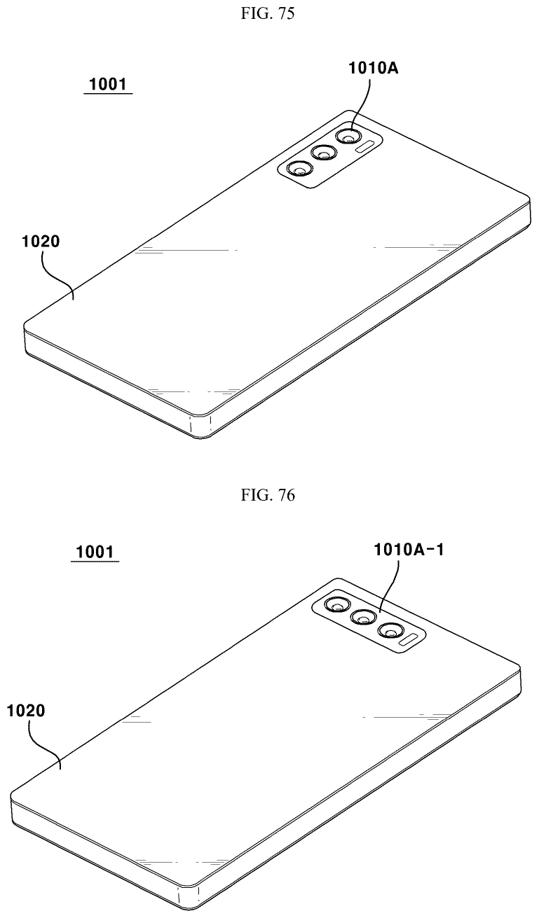

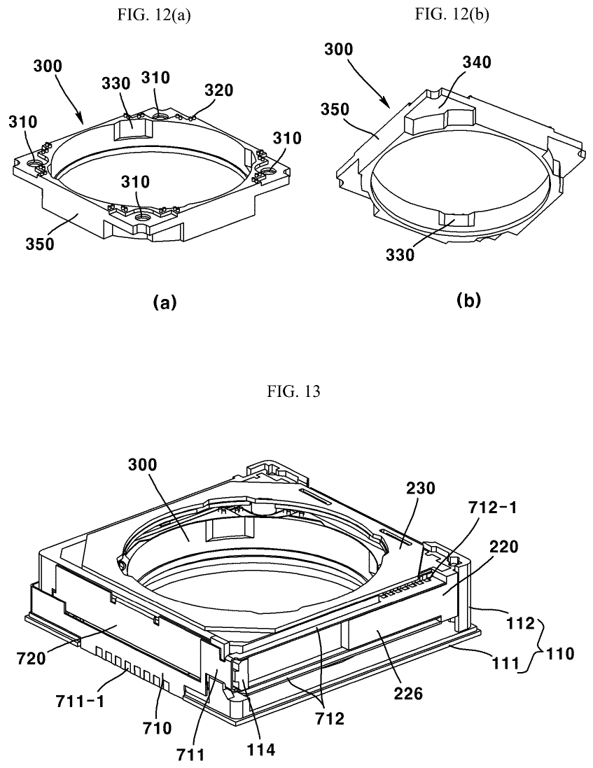

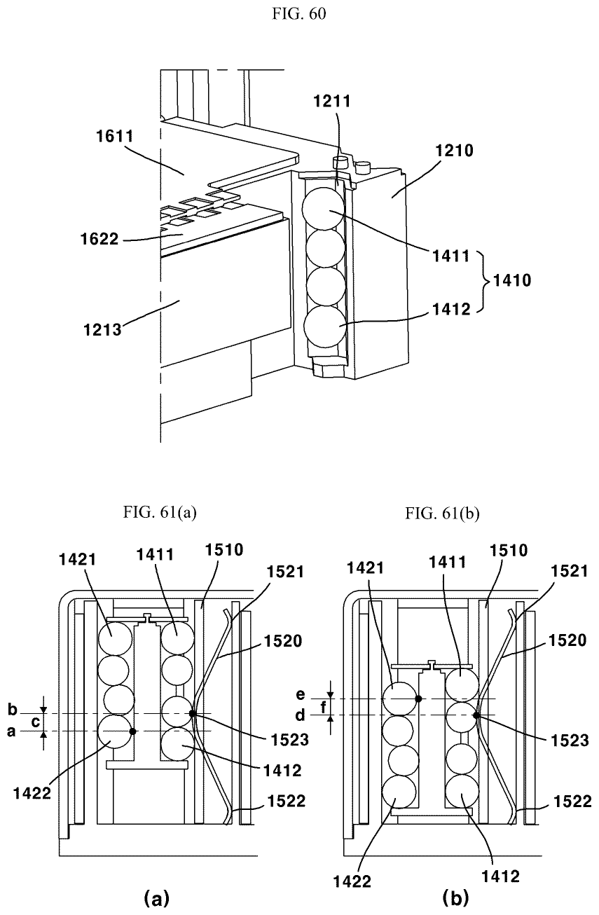

FIG. 75 is a perspective view of an optical apparatus according to a second embodiment of the present invention; and FIG. 76 is a perspective view of an optical apparatus according to a modified embodiment.

The optical apparatus 1001 is a mobile phone, mobile phone, portable terminal, mobile terminal, smart phone, smart pad, portable smart device, digital camera, laptop computer, digital broadcasting terminal, personal digital assistants (PDAs), portable multimedia player (PMP), and navigation. The optical apparatus 001 may comprise any device for photographing images or photos.

The optical apparatus 1001 may comprise a main body 1020. The optical apparatus 1001 may comprise a camera device 1010A. The camera device 1010A may be disposed on the main body 1020. The camera device 1010A may photograph a subject. The optical apparatus 1001 may comprise a display. The display may be disposed on the main body 1020. The display may output at least one of a video and an image photographed by the camera device 1010A. The display may be disposed on a first surface of the main body 1020. The camera device 1010A may be disposed on at least one of a first surface of the main body 1020 and a second surface opposite to the first surface. As illustrated in FIG. 74, in the camera device 1010A, triple cameras may be disposed in a vertical direction. As illustrated in FIG. 76, in the camera device 1010A-1, triple cameras may be disposed in a horizontal direction.

Although the first embodiment and the second embodiment have been separately described above, some configurations of the first embodiment and some configurations of the second embodiment may be used interchangeably. That is, some configurations of the first embodiment may be replaced with corresponding configurations of the second embodiment. In addition, some configurations of the second embodiment may be replaced with corresponding configurations of the first embodiment. In addition, the third embodiment of the present invention may comprise some configurations of the first embodiment and some configurations of the second embodiment together.

Although the embodiment of the present invention has been described above with reference to the accompanying drawings, those of ordinary skill in the art to which the present invention belongs will understand that the present invention may be embodied in other specific forms without changing the technical spirit or essential features thereof. Therefore, it should be understood that the embodiments described above are illustrative in all respects and not restrictive.

1. A lens driving device comprising:
a base;
a housing disposed on the base;
a bobbin disposed in the housing;
a first ball disposed between a side surface of the housing and the base;
a second ball disposed between the housing and an upper side of the bobbin;
a first elastic member coupled with a portion of the upper side of the bobbin;
a second elastic member coupled with a lower side of the housing; and
a wire connecting the first elastic member and the second elastic member.

2. The lens driving device of claim 1, wherein the base comprises a first guide configured to guide the first ball to move.

3. The lens driving device of claim 2, wherein the side surface of the housing comprises a second guide configured to guide the first ball to move.

4. The lens driving device of claim 3, wherein the first guide and the second guide comprise a groove.

5. The lens driving device of claim 1, wherein the housing comprises a first housing comprising an upper plate having a metal member and a second housing disposed on the first housing and having a protrusion configured to guide the second ball.

6. A lens driving device comprising:
a fixed part;
a first moving part disposed in the fixed part;
a second moving part disposed in the first moving part;
a first driving part configured to move the first moving part in an optical axis direction; and
a second driving part configured to move the second moving part in a direction perpendicular to the optical axis direction,
wherein the first driving part comprises a first driving unit disposed on the first moving part and a second driving unit disposed on the fixed part, and
wherein the second driving part comprises a third driving unit disposed on the second moving part and a fourth driving unit disposed on the first moving part.

7. The lens driving device of claim 6, wherein the fourth driving unit comprises a coil

8. The lens driving device of claim 7, wherein the coil is configured to move together with the first moving part.

9. The lens driving device of claim 7, wherein the first driving unit comprises a first coil, and
wherein the second driving unit comprises a first magnet.

10. The lens driving device of claim 7, wherein the second driving part comprises a fifth driving unit disposed on the second moving part and spaced apart from the third driving unit, and a sixth driving unit disposed on the first moving part and spaced apart from the fourth driving unit.

11. The lens driving device of claim 10, wherein, when viewed from above, the first driving unit, the second driving unit, the fifth driving unit, and the sixth driving unit are overlapped with one another in one direction.

12. The lens driving device of claim 10, wherein the third driving unit and the fourth driving unit are configured to move the second moving part in a first direction perpendicular to the optical axis direction, and
wherein the fifth driving unit and the sixth driving unit are configured to move the second moving part in a second direction perpendicular to each of the optical axis direction and the first direction.

13. The lens driving device of claim 8, comprising:
a first substrate disposed on the fixed part; and
a second substrate disposed on the first moving part,
wherein the coil is disposed on the second substrate, and
wherein the first substrate comprises an outer portion disposed on the fixed part and a connecting portion extending from the outer portion and coupled with the second substrate.

14. A lens driving device comprising:
a fixed part;
a first moving part disposed in the fixed part;
a second moving part disposed in the first moving part;
a first support member disposed between the fixed part and the first moving part and configured to guide the first moving part to move in an optical axis direction;
a second support member disposed between the first moving part and the second moving part and configured to guide the second moving part to move in a direction perpendicular to the optical axis direction; and
a third support member comprising one part coupled with the first moving part and an other part coupled with the second moving part.

15. The lens driving device of claim 14, wherein the first moving part comprises a first elastic member,
wherein the second moving part comprises a second elastic member, and
wherein the third support member is coupled with the first elastic member and the second elastic member.

16. The lens driving device of claim 14, wherein the third support member comprises a wire.

17. The lens driving device of claim 14, comprising:
a first driving part configured to move the first moving part; and
a second driving part configured to move the second moving part,
wherein the first driving part comprises a first coil and a first magnet,
wherein the second driving part comprises a second coil and a second magnet, and
wherein the first coil and the second coil are disposed on the first moving part.

18. The lens driving device of claim 17, wherein the first magnet is disposed on the fixed part, and the second magnet is disposed on the second moving part.

19. A camera device comprising:
a printed circuit board;
an image sensor disposed on the printed circuit board;
the lens driving device of claim 1 disposed on the printed circuit board; and
a lens coupled with the lens driving device.

20. An optical apparatus comprising:
a main body;
the camera device of claim 19 disposed on the main body; and
a display disposed on the main body and configured to output at least one of a video and an image captured by the camera device.
